(19) United States
(12) Patent Application Publication
(10) Pub. No.: US 2021/0057809 A1
(43) Pub. Date: Feb. 25, 2021

(54) ANTENNA, COMMUNICATION MODULE, AND STREET LAMP

(71) Applicant: KYOCERA Corporation, Kyoto-shi, Kyoto (JP)

(72) Inventors: Hiromichi YOSHIKAWA, Yokohama-shi, Kanagawa (JP); Hiroshi UCHIMURA, Kagoshima-shi, Kagoshima (JP); Shinji ISOYAMA, Yokohama-shi, Kanagawa (JP); Nobuki HIRAMATSU, Yokohama-shi, Kanagawa (JP)

(21) Appl. No.: 16/963,823

(22) PCT Filed: Jan. 7, 2019
(86) PCT No.: PCT/JP2019/000087

§ 371 Date: Jul. 21, 2020

(30) Foreign Application Priority Data
Jan. 22, 2018 (JP) 2018-008406
Jan. 22, 2018 (JP) 2018-008408

(51) Int. Cl. H01Q 1/36; H01Q 1/24; H01Q 13/08; H01Q 15/14

(52) U.S. Cl. CPC H01Q 1/36; H01Q 15/14; H01Q 13/08; H01Q 1/24

(57) ABSTRACT

An antenna is mounted to a pole. The antenna includes a first conductor, a second conductor, a third conductor, a fourth conductor, and a feeding line. The second conductor faces the first conductor in a first direction. The third conductor is located between the first conductor and the second conductor, separated from the first conductor and the second conductor, and extends in the first direction. The fourth conductor is connected to the first conductor and the second conductor and extends in the first direction. The feeding line is electromagnetically connected to the third conductor. The antenna is mounted to the pole such that the first direction is substantially parallel to a direction in which the pole extends.

### CROSS-REFERENCE TO RELATED APPLICATIONS

This application is a National Stage of PCT international application Ser. No. PCT/JP2019/000087 filed on Jan. 7, 2019 which designates the United States, incorporated herein by reference, and which is based upon and claims the benefit of priority from Japanese Patent Application Nos. 2018-008406 and 2018-008408 filed on Jan. 22, 2018, the entire contents of which are incorporated herein by reference.

### TECHNICAL FIELD

The present disclosure relates to an antenna, a communication module, and a street lamp.

### DESCRIPTION OF THE RELATED ART

An electromagnetic wave emitted from an antenna is reflected by a metal conductor. The electromagnetic wave reflected by the metal conductor has a phase shift of 180°. The reflected electromagnetic wave is combined with an electromagnetic wave radiated from the antenna. The electromagnetic wave radiated from the antenna may have small amplitude due to the combination thereof with an electromagnetic wave having a phase shift. As a result, the amplitude of the electromagnetic wave radiated from the antenna is reduced. Setting the distance between the antenna and the metal conductor to be ¼ of a wavelength λ of an electromagnetic wave to be radiated reduces the influence of the reflected wave.

Meanwhile, there has been proposed a technology for reducing the influence of a reflected wave by using an artificial magnetic wall. This technology is described, for example, in Non Patent Literature 1 and Non Patent Literature 2. The technologies described in Non Patent Literature 1 and Non Patent Literature 2 require arrangement of a large number of resonator structures.

### NON PATENT LITERATURE

Non Patent Literature 1: Murakami et al. “Low-Profile Design and Bandwidth Characteristics of AMC with Dielectric Substrate”, The transactions of the Institute of Electronics, Information and Communication Engineers. B, Vol. J98-B No. 2, pp. 172-179

Non Patent Literature 2: Murakami et al. “Optimum Configuration of Reflector for Dipole Antenna with AMC Reflector”, The transactions of the Institute of Electronics, Information and Communication Engineers. B, Vol. J98-B No. 11, pp. 1212-1220

### SUMMARY

An antenna according to an aspect of the present disclosure is mounted to a pole. The antenna includes a first conductor, a second conductor that faces the first conductor in a first direction, a third conductor that is located between the first conductor and the second conductor, apart from the first conductor and the second conductor, and extends in the first direction, a fourth conductor that is connected to the first conductor and the second conductor and extends in the first direction, and a feeding line that is electromagnetically connected to the third conductor. The antenna is mounted to the pole such that the first direction is substantially parallel to a direction in which the pole extends.

A communication module according to another aspect of the present disclosure includes an antenna that is mounted to a pole, and an illuminance sensor that detects light emitted from a lighting device arranged near a leading end of the pole. The antenna includes a first conductor, a second conductor that faces the first conductor in a first direction, a third conductor that is located between the first conductor and the second conductor, apart from the first conductor and the second conductor, and extends in the first direction, a fourth conductor that is connected to the first conductor and the second conductor and extends in the first direction, and a feeding line that is electromagnetically connected to the third conductor. The antenna is mounted to the pole such that the first direction is substantially parallel to a direction in which the pole extends. Data based on light that is emitted from the lighting device and that is detected by the illuminance sensor is transmitted by using the antenna.

A street lamp according to another aspect of the present disclosure includes a pole, and an antenna that is mounted to the pole. The antenna includes a first conductor, a second conductor that faces the first conductor in a first direction, a third conductor that is located between the first conductor and the second conductor, apart from the first conductor and the second conductor, and extends in the first direction, a fourth conductor that is connected to the first conductor and the second conductor and extends in the first direction, and a feeding line that is electromagnetically connected to the third conductor. The antenna is mounted to the pole such that the first direction is substantially parallel to a direction in which the pole extends.

An antenna according to another aspect of the present disclosure is mounted so as to face the ground, to a pole extending in a substantially horizontal direction. the antenna includes a first conductor, a second conductor that faces the first conductor in a first direction, a third conductor that is located between the first conductor and the second conductor, apart from the first conductor and the second conductor, and extends in the first direction, a fourth conductor that is connected to the first conductor and the second conductor and extends in the first direction, and a feeding line that is electromagnetically connected to the third conductor. The antenna is mounted to the pole such that the first direction is substantially parallel to the substantially horizontal direction in which the pole extends.

A communication module according to another aspect of the present disclosure includes an antenna that is mounted so as to face the ground, to a pole extending in a substantially horizontal direction, and a detector that acquires information around the pole. The antenna includes: a first conductor, a second conductor that faces the first conductor in a first direction, a third conductor that is located between the first conductor and the second conductor, apart from the first conductor and the second conductor, and extends in the first direction, a fourth conductor that is connected to the first conductor and the second conductor and extends in the first direction, and a feeding line that is electromagnetically connected to the third conductor. The antenna is mounted to the pole such that the first direction is substantially parallel to the substantially horizontal direction in which the pole extends. Information acquired by the detector is transmitted to a moving vehicle moving under the pole by using the antenna.

### BRIEF DESCRIPTION OF THE DRAWINGS

FIG. 1 is a perspective view of a resonator according to an embodiment.

FIG. 2 is a plan view of the resonator illustrated in FIG. 1.

FIG. 3A is a cross-sectional view of the resonator illustrated in FIG. 1.

FIG. 3B is a cross-sectional view of the resonator illustrated in FIG. 1.

FIG. 4 is a cross-sectional view of the resonator illustrated in FIG. 1.

FIG. 5 is a conceptual diagram illustrating a unit structure of the resonator illustrated in FIG. 1.

FIG. 6 is a perspective view of a resonator according to an embodiment.

FIG. 7 is a plan view of the resonator illustrated in FIG. 6.

FIG. 8A is a cross-sectional view of the resonator illustrated in FIG. 6.

FIG. 8B is a cross-sectional view of the resonator illustrated in FIG. 6.

FIG. 9 is a cross-sectional view of the resonator illustrated in FIG. 6.

FIG. 10 is a perspective view of a resonator according to an embodiment.

FIG. 11 is a plan view of the resonator illustrated in FIG. 10.

FIG. 12A is a cross-sectional view of the resonator illustrated in FIG. 10.

FIG. 12B is a cross-sectional view of the resonator illustrated in FIG. 10.

FIG. 13 is a cross-sectional view of the resonator illustrated in FIG. 10.

FIG. 14 is a perspective view of a resonator according to an embodiment.

FIG. 15 is a plan view of the resonator illustrated in FIG. 14.

FIG. 16A is a cross-sectional view of the resonator illustrated in FIG. 14.

FIG. 16B is a cross-sectional view of the resonator illustrated in FIG. 14.

FIG. 17 is a cross-sectional view of the resonator illustrated in FIG. 14.

FIG. 18 is a plan view of a resonator according to an embodiment.

FIG. 19A is a cross-sectional view of the resonator illustrated in FIG. 18.

FIG. 19B is a cross-sectional view of the resonator illustrated in FIG. 18.

FIG. 20 is a cross-sectional view of a resonator according to an embodiment.

FIG. 21 is a plan view of a resonator according to an embodiment.

FIG. 22A is a cross-sectional view of a resonator according to an embodiment.

FIG. 22B is a cross-sectional view of a resonator according to an embodiment.

FIG. 22C is a cross-sectional view of a resonator according to an embodiment.

FIG. 23 is a plan view of a resonator according to an embodiment.

FIG. 24 is a plan view of a resonator according to an embodiment.

FIG. 25 is a plan view of a resonator according to an embodiment.

FIG. 26 is a plan view of a resonator according to an embodiment.

FIG. 27 is a plan view of a resonator according to an embodiment.

FIG. 28 is a plan view of a resonator according to an embodiment.

FIG. 29A is a plan view of a resonator according to an embodiment.

FIG. 29B is a plan view of a resonator according to an embodiment.

FIG. 30 is a plan view of a resonator according to an embodiment.

FIG. 31A is a schematic diagram illustrating an example of a resonator.

FIG. 31B is a schematic diagram illustrating an example of a resonator.

FIG. 31C is a schematic diagram illustrating an example of a resonator.

FIG. 31D is a schematic diagram illustrating an example of a resonator.

FIG. 32A is a plan view of a resonator according to an embodiment.

FIG. 32B is a plan view of a resonator according to an embodiment.

FIG. 32C is a plan view of a resonator according to an embodiment.

FIG. 32D is a plan view of a resonator according to an embodiment.

FIG. 33A is a plan view of a resonator according to an embodiment.

FIG. 33B is a plan view of a resonator according to an embodiment.

FIG. 33C is a plan view of a resonator according to an embodiment.

FIG. 33D is a plan view of a resonator according to an embodiment.

FIG. 34A is a plan view of a resonator according to an embodiment.

FIG. 34B is a plan view of a resonator according to an embodiment.

FIG. 34C is a plan view of a resonator according to an embodiment.

FIG. 34D is a plan view of a resonator according to an embodiment.

FIG. 35 is a plan view of a resonator according to an embodiment.

FIG. 36A is a cross-sectional view of a resonator according to an embodiment.

FIG. 36B is a cross-sectional view of a resonator according to an embodiment.

FIG. 37 is a plan view of a resonator according to an embodiment.

FIG. 38 is a plan view of a resonator according to an embodiment.

FIG. 39 is a plan view of a resonator according to an embodiment.

FIG. 40 is a plan view of a resonator according to an embodiment.

FIG. 41 is a plan view of a resonator according to an embodiment.

FIG. 42 is a plan view of a resonator according to an embodiment.

FIG. 43 is a cross-sectional view of a resonator according to an embodiment.

FIG. 44 is a plan view of a resonator according to an embodiment.

FIG. 45 is a cross-sectional view of a resonator according to an embodiment.

FIG. 46 is a plan view of a resonator according to an embodiment.

FIG. 47 is a cross-sectional view of a resonator according to an embodiment.

FIG. 48 is a plan view of a resonator according to an embodiment.

FIG. 49 is a cross-sectional view of a resonator according to an embodiment.

FIG. 50 is a plan view of a resonator according to an embodiment.

FIG. 51 is a cross-sectional view of a resonator according to an embodiment.

FIG. 52 is a plan view of a resonator according to an embodiment.

FIG. 53 is a cross-sectional view of a resonator according to an embodiment.

FIG. 54 is a cross-sectional view of a resonator according to an embodiment.

FIG. 55 is a plan view of a resonator according to an embodiment.

FIG. 56A is a cross-sectional view of a resonator according to an embodiment.

FIG. 56B is a cross-sectional view of a resonator according to an embodiment.

FIG. 57 is a plan view of a resonator according to an embodiment.

FIG. 58 is a plan view of a resonator according to an embodiment.

FIG. 59 is a plan view of a resonator according to an embodiment.

FIG. 60 is a plan view of a resonator according to an embodiment.

FIG. 61 is a plan view of a resonator according to an embodiment.

FIG. 62 is a plan view of a resonator according to an embodiment.

FIG. 63 is a plan view of an antenna according to an embodiment.

FIG. 64 is a cross-sectional view of an antenna according to an embodiment.

FIG. 65 is a plan view of an antenna according to an embodiment.

FIG. 66 is a cross-sectional view of an antenna according to an embodiment.

FIG. 67 is a plan view of an antenna according to an embodiment.

FIG. 68 is a cross-sectional view of an antenna according to an embodiment.

FIG. 69 is a cross-sectional view of an antenna according to an embodiment.

FIG. 70 is a plan view of an antenna according to an embodiment.

FIG. 71 is a cross-sectional view of an antenna according to an embodiment.

FIG. 72 is a plan view of an antenna according to an embodiment.

FIG. 73 is a cross-sectional view of an antenna according to an embodiment.

FIG. 74 is a plan view of an antenna according to an embodiment.

FIG. 75A is a cross-sectional view of an antenna according to an embodiment.

FIG. 75B is a cross-sectional view of an antenna according to an embodiment.

FIG. 76 is a plan view of an antenna according to an embodiment.

FIG. 77 is a plan view of an antenna according to an embodiment.

FIG. 78 is a cross-sectional view of the antenna illustrated in FIG. 43.

FIG. 79 is a block diagram illustrating a wireless communication module according to an embodiment.

FIG. 80 is a partial cross-sectional perspective view of a wireless communication module according to an embodiment.

FIG. 81 is a block diagram illustrating a wireless communication device according to an embodiment.

FIG. 82 is a plan view illustrating a wireless communication device according to an embodiment.

FIG. 83 is a cross-sectional view of a wireless communication device according to an embodiment.

FIG. 84 is a plan view illustrating a wireless communication device according to an embodiment.

FIG. 85 is a cross-sectional view of a wireless communication device according to an embodiment.

FIG. 86 is a cross-sectional view of an antenna according to an embodiment.

FIG. 87 is a diagram illustrating a schematic circuit of a wireless communication device.

FIG. 88 is a diagram illustrating a schematic circuit of a wireless communication device.

FIG. 89 is a diagram illustrating how a communication module according to an embodiment is mounted to a street lamp.

FIG. 90 is an enlarged view illustrating how a communication module according to an embodiment is mounted to a street lamp.

FIG. 91 is a functional block diagram of a communication module according to an embodiment.

FIG. 92 is a diagram illustrating how a communication module according to an embodiment is mounted to a pole extending in a substantially horizontal direction.

FIG. 93 is an enlarged view illustrating how a communication module according to an embodiment is mounted to a pole extending in a substantially horizontal direction.

FIG. 94 is a diagram illustrating how a communication module according to an embodiment is mounted to a street lamp.

FIG. 95 is a functional block diagram of a communication module according to an embodiment.

FIG. 96 is an enlarged view illustrating how a communication module according to a modification is mounted to a pole extending in a substantially horizontal direction.

FIG. 97 is a functional block diagram of a communication module according to a modification.

### DETAILED DESCRIPTION

The present disclosure provides a new resonance structure that is less affected by a reflected wave from a metal conductor and provides an antenna including the new resonance structure, a communication module including the antenna, and a street lamp to which the antenna is mounted.

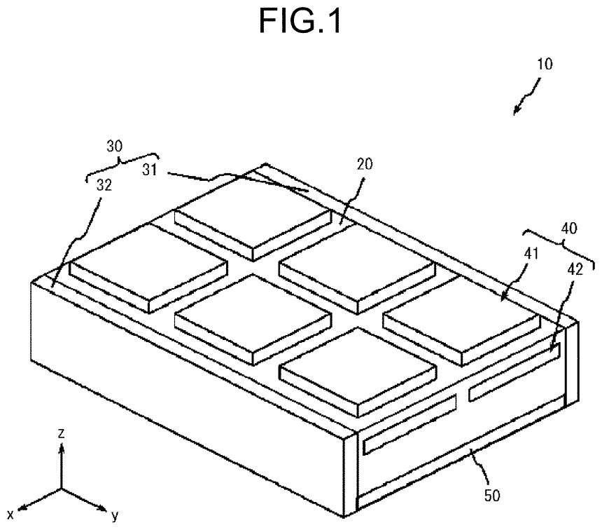

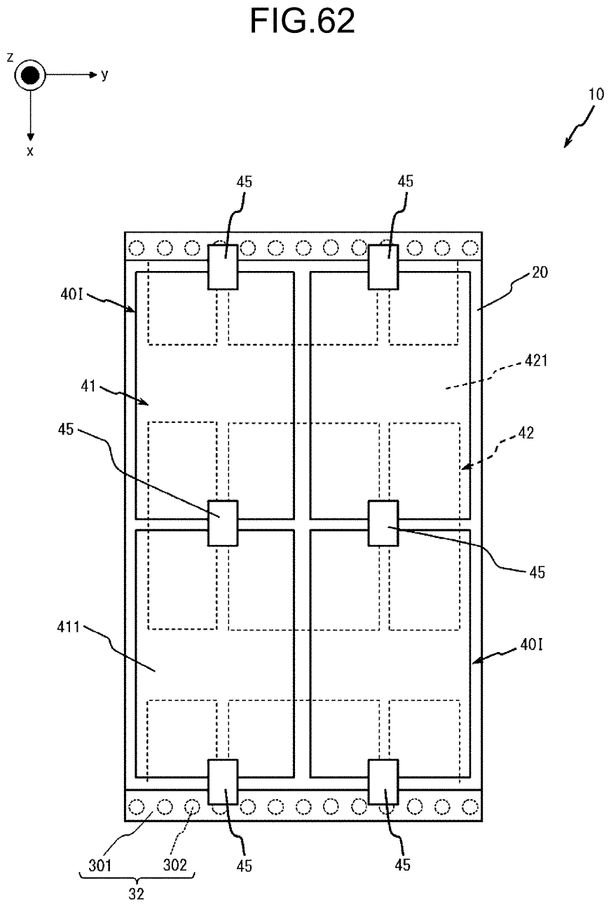

A plurality of embodiments according to the present disclosure will be described below. The resonant structure can include a resonator. The resonance structure includes the resonator and another member such that the resonator and the other member can be integrated with each other. A resonator 10 illustrated in FIGS. 1 to 62 includes a base 20, pair conductors 30, a third conductor 40, and a fourth conductor 50. The base 20 makes contact with the pair conductors 30, the third conductor 40, and the fourth conductor 50. In the resonator 10, the pair conductors 30, the third conductor 40, and the fourth conductor 50 each function as a resonator. The resonator 10 can resonate at a plurality of resonant frequencies. One resonant frequency of the resonant frequencies of the resonator 10 is defined as a first frequency f₁. The wavelength of the first frequency f₁ is λ. The resonator 10 can have at least one of the plurality of resonant frequencies as an operating frequency. The first frequency f₁ of the resonator 10 is used as the operating frequency.

The base 20 can include either a ceramic material or a resin material as a composition. The ceramic material includes a sintered aluminum oxide, sintered aluminum nitride, mullite refractory, sintered glass ceramic, crystallized glass obtained by depositing a crystal component in a glass base material, and sintered microcrystal of mica, aluminum titanate, or the like. The resin material includes a material obtained by curing an uncured material such as an epoxy resin, a polyester resin, a polyimide resin, a polyamide-imide resin, a polyetherimide resin, and a liquid crystal polymer.

Each of the air conductors 30, the third conductor 40, and the fourth conductor 50 can include, as a composition, any of a metal material, an alloy of the metal material, hardened metal paste, and a conductive polymer. All of the pair conductors 30, the third conductor 40, and the fourth conductor 50 may include the same material. All of the pair conductors 30, the third conductor 40, and the fourth conductor 50 may include different materials. Any combination of the pair conductors 30, the third conductor 40, and the fourth conductor 50 may include the same material. The metal material includes copper, silver, palladium, gold, platinum, aluminum, chromium, nickel, cadmium, lead, selenium, manganese, tin, vanadium, lithium, cobalt, titanium, and the like. The alloy includes a plurality of metal materials. The metal paste agent includes a powdered metal material that is kneaded together with an organic solvent and a binder. The binder includes an epoxy resin, a polyester resin, a polyimide resin, a polyamide-imide resin, and a polyetherimide resin. The conductive polymer includes a polythiophene polymer, a polyacethylene polymer, a polyaniline polymer, a polypyrrole polymer, and the like.

The resonator 10 includes two pair conductors 30. The pair conductors 30 include a plurality of conductive members. The pair conductors 30 include a first conductor 31 and a second conductor 32. The pair conductors 30 can include three or more conductive members. Each conductor of the pair conductors 30 is separated from the other conductor in a first direction. In the conductors of the pair conductors 30, one conductor can be paired with the other conductor. The conductors of the pair conductors 30 can appear as an electric wall, in relation to the resonator between the pair conductors. The first conductor 31 is positioned apart from the second conductor 32 in the first direction. The conductors 31 and 32 extend along a second plane intersecting the first direction.

In the present disclosure, the first direction (first axis) is represented as an x-direction. In the present disclosure, a third direction (third axis) is represented as a y-direction. In the present disclosure, a second direction (second axis) is represented as a z-direction. In the present disclosure, a first plane is represented as an xy surface. In the present disclosure, the second plane is represented as a yz surface. In the present disclosure, a third plane is represented as a zx surface. These planes are planes in a coordinate space and do not represent a specific plate or a specific surface. In the present disclosure, an area (surface integral) in an xy plane may be referred to as a first area. In the present disclosure, an area in a yz plane may be referred to as a second area. In the present disclosure, an area in a zx plane may be referred to as a third area. The area (surface integral) is measured in units of square meters or the like. In the present disclosure, a length in the x-direction may be simply referred to as a “length”. In the present disclosure, a length in the y-direction may be simply referred to as a “width”. In the present disclosure, a length in the z-direction may be simply referred to as a “height”.

In an example, the conductors 31 and 32 are located at either end of the base 20 in the x-direction. Each of the conductors 31 and 32 can partially face outside the base 20. Each of the conductors 31 and 32 can have a portion that is located inside the base 20 and another portion that is located outside the base 20. Each of the conductors 31 and 32 can be located within the base 20.

The third conductor 40 functions as a resonator. The third conductor 40 can include at least one of a line resonator, patch resonator, and slot resonator. In an example, the third conductor 40 is located on the base 20. In an example, the third conductor 40 is located at an end of the base 20 in the z-direction. In an example, the third conductor 40 can be located within the base 20. The third conductor 40 can have a portion that is located inside the base 20 and another portion that is located outside the base 20. The third conductor 40 can have a surface that partially faces outside the base 20.

The third conductor 40 includes at least one conductive member. The third conductor 40 can include a plurality of conductive members. When the third conductor 40 includes the plurality of conductive members, the third conductor 40 can be referred to as a third conductor group. The third conductor 40 includes at least one conductive layer. The third conductor 40 includes at least one conductive member in one conductive layer. The third conductor 40 can include a plurality of conductive layers. For example, the third conductor 40 can include three or more conductive layers. The third conductor 40 includes at least one conductive member in each of the plurality of conductive layers. The third conductor 40 extends in the xy plane. The xy plane includes the x-direction. Each of the conductive layers of the third conductor 40 extends along the xy plane.

In an example of the plurality of embodiments, the third conductor 40 includes a first conductive layer 41 and a second conductive layer 42. The first conductive layer 41 extends along the xy plane. The first conductive layer 41 can be located on the base 20. The second conductive layer 42 extends along the xy plane. The second conductive layer 42 can be capacitively coupled to the first conductive layer 41. The second conductive layer 42 can be electrically connected to the first conductive layer 41. The two conductive layers capacitively coupled can face each other in the y-direction. The two conductive layers capacitively coupled can face each other in the x-direction. The two conductive layers capacitively coupled can face each other in the first plane. The two conductive layers facing each other in the first plane can also be said that two conductive members are located in one conductive layer. The second conductive layer 42 can be located so as to at least partially overlap the first conductive layer 41 in the z-direction. The second conductive layer 42 can be located within the base 20.

The fourth conductor 50 is located apart from the third conductor 40. The fourth conductor 50 is electrically connected to the conductors 31 and 32 of the pair conductors 30. The fourth conductor 50 is electrically connected to the first conductor 31 and the second conductor 32. The fourth conductor 50 extends along the third conductor 40. The fourth conductor 50 extends along the first plane. The fourth conductor 50 expands from the first conductor 31 to the second conductor 32. The fourth conductor 50 is located on the base 20. The fourth conductor 50 can be located within the base 20. The fourth conductor 50 can have a portion that is located inside the base 20 and another portion that is located outside the base 20. The fourth conductor 50 can have a surface that partially faces outside the base 20.

In an example of the plurality of embodiments, the fourth conductor 50 can function as a ground conductor in the resonator 10. The potential of the fourth conductor 50 can be a reference potential of the resonator 10. The fourth conductor 50 can be connected to the ground of a device including the resonator 10.

In an example of the plurality of embodiments, the resonator 10 can include the fourth conductor 50 and a reference potential layer 51. The reference potential layer 51 is located apart from the fourth conductor 50 in the z-direction. The reference potential layer 51 is electrically insulated from the fourth conductor 50. The potential of the reference potential layer 51 can be a reference potential of the resonator 10. The reference potential layer 51 can be electrically connected to the ground of a device including the resonator 10. The fourth conductor 50 can be electrically separated from the ground of a device including the resonator 10. The reference potential layer 51 faces either the third conductor 40 or the fourth conductor 50 in the z-direction.

In an example of the plurality of embodiments, the reference potential layer 51 faces the third conductor 40 via the fourth conductor 50. The fourth conductor 50 is located between the third conductor 40 and the reference potential layer 51. The distance between the reference potential layer 51 and the fourth conductor 50 is smaller than the distance between the third conductor 40 and the fourth conductor 50.

In the resonator 10 including the reference potential layer 51, the fourth conductor 50 can include one or a plurality of conductive members. In the resonator 10 including the reference potential layer 51, the fourth conductor 50 can include one or a plurality of conductive members, and the third conductor 40 can include one conductive member that is connected to the pair conductors 30. In the resonator 10 including the reference potential layer 51, each of the third conductor 40 and the fourth conductor 50 can include at least one resonator.

In the resonator 10 including the reference potential layer 51, the fourth conductor 50 can include a plurality of conductive layers. For example, the fourth conductor 50 can include a third conductive layer 52 and a fourth conductive layer 53. The third conductive layer 52 can be capacitively coupled to the fourth conductive layer 53. The third conductive layer 52 can be electrically connected to the first conductive layer 41. The two conductive layers capacitively coupled can face each other in the y-direction. The two conductive layers capacitively coupled can face each other in the x-direction. The two conductive layers capacitively coupled can face each other in the xy plane.

The distance between the two conductive layers capacitively coupled with facing each other in the z-direction is smaller than the distance between the conductor group and the reference potential layer 51. For example, the distance between the first conductive layer 41 and the second conductive layer 42 is smaller than the distance between the third conductor 40 and the reference potential layer 51. For example, the distance between the third conductive layer 52 and the fourth conductive layer 53 is shorter than the distance between the fourth conductor 50 and the reference potential layer 51.

Each of the first conductor 31 and the second conductor 32 can include one or a plurality of conductive members. Each of the first conductor 31 and the second conductor 32 can include one conductive member. Each of the first conductor 31 and the second conductor 32 can include a plurality of conductive members. Each of the first conductor 31 and the second conductor 32 can include at least one fifth conductive layer 301 and a plurality of fifth conductors 302. The pair conductors 30 include at least one fifth conductive layer 301 and a plurality of fifth conductors 302.

The fifth conductive layer 301 extends in the y-direction. The fifth conductive layer 301 extends along the xy plane. The fifth conductive layer 301 is a layered conductive member. The fifth conductive layer 301 can be located on the base 20. The fifth conductive layer 301 can be located within the base 20. A plurality of the fifth conductive layers 301 is separated from each other in the z-direction. The plurality of the fifth conductive layers 301 is aligned in the z-direction. The plurality of the fifth conductive layers 301 partially overlaps each other in the z-direction. Each of the fifth conductive layers 301 electrically connects the plurality of fifth conductors 302. The fifth conductive layer 301 serves as a connecting conductor that connects the plurality of fifth conductors 302. The fifth conductive layer 301 can be electrically connected to any conductive layer of the third conductor 40. In an embodiment, the fifth conductive layer 301 is electrically connected to the second conductive layer 42. The fifth conductive layer 301 can be integrated with the second conductive layer 42. In an embodiment, the fifth conductive layer 301 can be electrically connected to the fourth conductor 50. The fifth conductive layer 301 can be integrated with the fourth conductor 50.

Each of the fifth conductors 302 extends in the z-direction. The plurality of fifth conductors 302 is separated from each other in the y-direction. The distance between the fifth conductors 302 is equal to or less than ½ of the wavelength λ₁. When the distance between fifth conductors 302 electrically connected is equal to or less than ½ of the wavelength λ₁, each of the first conductors 31 and second conductors 32 can reduce leakage of an electromagnetic wave in a resonant frequency band from between the fifth conductors 302. Since leakage of the electromagnetic wave in the resonant frequency band from the pair conductors 30 is small, the pair conductors 30 appear as an electric wall due to the unit structure. At least part of the plurality of fifth conductors 302 are electrically connected to the fourth conductor 50. In an embodiment, part of the plurality of fifth conductors 302 can electrically connect the fourth conductor 50 and fifth conductive layers 301. In an embodiment, the plurality of fifth conductors 302 can be electrically connected to the fourth conductor 50 via the fifth conductive layers 301. Part of the plurality of fifth conductors 302 can electrically connect one fifth conductive layer 301 to another fifth conductive layer 301. Each of the fifth conductors 302 can employ a via conductor and a through-hole conductor.

The resonator 10 includes the third conductor 40 that functions as a resonator. The third conductor 40 can function as an artificial magnetic wall (artificial magnetic conductor; AMC). The artificial magnetic conductor can also be called as a reactive impedance surface (RIS).

The resonator 10 includes the third conductor 40 that functions as a resonator, between two pair conductors 30 facing each other in the x-direction. The two pair conductors 30 appear as the electric wall (electric conductor) extending in the yz plane from the third conductor 40. The resonator 10 is electrically open at an end in the y-direction. The resonator 10 has high impedance in zx planes at both ends in the y-direction. The zx planes at both ends of the resonator 10 in the y-direction appear as a magnetic wall (magnetic conductor) from the third conductor 40. The resonator 10 is surrounded by two electric walls and two high-impedance surfaces (magnetic walls), and the resonator of the third conductor 40 has an artificial magnetic conductor character in the z-direction. The resonator of the third conductor 40 surrounded by the two electric walls and two high-impedance surfaces has a finite number of artificial magnetic conductor characters.

The “artificial magnetic conductor character” exhibits a phase difference of 0 degree between an incident wave and a reflected wave at an operating frequency. In the resonator 10, the phase difference between an incident wave and a reflected wave at the first frequency f₁ is 0 degree. In the “artificial magnetic conductor character”, the phase difference between an incident wave and a reflected wave is −90 degrees to +90 degrees in an operating frequency band. The operating frequency band is a frequency band between a second frequency f₂ and a third frequency f₃. The second frequency f₂ is a frequency at which a phase difference between an incident wave and a reflected wave is +90 degrees. The third frequency f₃ is a frequency at which a phase difference between an incident wave and a reflected wave is −90 degrees. The width of the operating frequency band determined on the basis of the second and third frequencies may be, for example, not less than 100 MHz when the operating frequency is approximately 2.5 GHz. The width of the operating frequency band may be, for example, not less than 5 MHz when the operating frequency is approximately 400 MHz.

The operating frequency of the resonator 10 can be different from a resonant frequency of a resonator of each third conductor 40. The operating frequency of the resonator 10 can be changed depending on the lengths, sizes, shapes, materials, or the like of the base 20, the pair conductors 30, the third conductor 40, and the fourth conductor 50.

In an example of the plurality of embodiments, the third conductor 40 can include at least one unit resonator 40X. The third conductor 40 can include one unit resonator 40X. The third conductor 40 can include a plurality of unit resonators 40X. The unit resonators 40X are located so as to overlap the fourth conductor 50 in the z-direction. The unit resonator 40X faces the fourth conductor 50. The unit resonator 40X can function as a frequency selective surface (FSS). The plurality of unit resonators 40X is arranged along the xy plane. The plurality of unit resonators 40X can be regularly arranged in the xy plane. The unit resonators 40X can be arranged in the form of a square grid, oblique grid, rectangular grid, or hexagonal grid.

The third conductor 40 can include a plurality of conductive layers that is arranged in the z-direction. Each of the plurality of conductive layers of the third conductor 40 includes at least one-equivalent unit resonator. For example, the third conductor 40 includes the first conductive layer 41 and the second conductive layer 42.

The first conductive layer 41 includes at least one-equivalent first unit resonator 41X. The first conductive layer 41 can include one first unit resonator 41X. The first conductive layer 41 can include a plurality of first divisional resonators 41Y that is obtained by dividing one first unit resonator 41X. The plurality of first divisional resonators 41Y can be formed into at least one-equivalent first unit resonator 41X by adjacent unit structures 10X. The plurality of first divisional resonators 41Y is located at the ends of the first conductive layer 41. The first unit resonator 41X and the first divisional resonator 41Y can be called a third conductor.

The second conductive layer 42 includes at least one-equivalent second unit resonator 42X. The second conductive layer 42 can include one second unit resonator 42X. The second conductive layer 42 can include a plurality of second divisional resonators 42Y that is obtained by dividing one second unit resonator 42X. The plurality of second divisional resonators 42Y can be formed into at least one-equivalent second unit resonator 42X by adjacent unit structures 10X. The plurality of second divisional resonators 42Y is located at the ends of the second conductive layer 42. The second unit resonator 42X and the second divisional resonator 42Y can be called a third conductor.

The second unit resonator 42X and the second divisional resonators 42Y are located so as to at least partially overlap the first unit resonator 41X and the first divisional resonators 41Y in the Z-direction. In the third conductor 40, at least part of the unit resonators and partial resonators of the respective layers overlap in the Z-direction to form one unit resonator 40X. The unit resonator 40X includes at least one-equivalent resonator in each layer.

When the first unit resonator 41X includes a line or patch resonator, the first conductive layer 41 includes at least one first unit conductor 411. The first unit conductor 411 can function as the first unit resonator 41X or the first divisional resonator 41Y. The first conductive layer 41 includes a plurality of first unit conductors 411 that is arranged in n rows and m columns in the x and y directions. In the above, n and m are each independently a natural number of 1 or more. In an example illustrated in FIGS. 1 to 9 and the like, the first conductive layer 41 includes six first unit conductors 411 that are arranged in a grid of two rows and three columns. The first unit conductors 411 can be arranged in the form of a square grid, oblique grid, rectangular grid, or hexagonal grid. A first unit conductors 411 corresponding to a first divisional resonator 41Y is located at an end of the first conductive layer 41 in the xy plane.

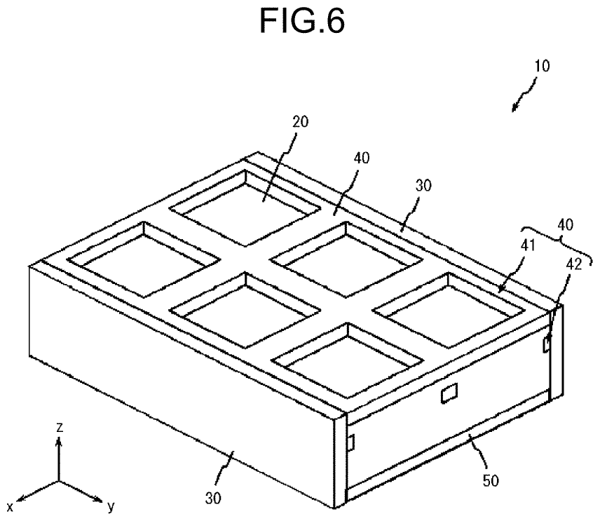

In a case where the first unit resonator 41X uses a slot resonator, the first conductive layer 41 has at least one conductive layer extending in the x and y directions. The first conductive layer 41 includes at least one first unit slot 412. The first unit slot 412 can function as the first unit resonator 41X or the first divisional resonator 41Y. The first conductive layer 41 can include a plurality of first unit slots 412 that is arranged in n rows and m columns in the x and y directions. In the above, n and m are each independently a natural number of 1 or more. In an example illustrated in FIGS. 6 to 9 and the like, the first conductive layer 41 includes six first unit slots 412 that are arranged in a grid of two rows and three columns. The first unit slots 412 can be arranged in the form of a square grid, oblique grid, rectangular grid, or hexagonal grid. A first unit slot 412 corresponding to a first divisional resonator 41Y is located at an end of the first conductive layer 41 in the xy plane.

In a case where the second unit resonator 42X uses a line or patch resonator, the second conductive layer 42 includes at least one second unit conductor 421. The second conductive layer 42 can include a plurality of second unit conductors 421 that is arranged in the x and y directions. The second unit conductors 421 can be arranged in the form of a square grid, oblique grid, rectangular grid, or hexagonal grid. The second unit conductor 421 can function as the second unit resonator 42X or the second divisional resonator 42Y. A second unit conductor 421 corresponding to a second divisional resonator 42Y is located at an end of the second conductive layer 42 in the xy plane.

The second unit conductor 421 at least partially overlaps at least one of the first unit resonator 41X and the first divisional resonator 41Y in the z-direction. The second unit conductor 421 can overlap a plurality of first unit resonators 41X. The second unit conductor 421 can overlap a plurality of first divisional resonators 41Y. The second unit conductor 421 can overlap one first unit resonator 41X and four first divisional resonators 41Y. The second unit conductor 421 can only overlap one first unit resonator 41X. The center of gravity of the second unit conductor 421 can coincide with that of one first unit conductor 411. The center of gravity of the second unit conductor 421 can be located between a plurality of first unit conductors 411 and first divisional resonators 41Y. The center of gravity of the second unit conductor 421 can be located between two first unit resonators 41X arranged in the x-direction or y-direction.

The second unit conductor 421 can at least partially overlap two first unit conductors 411. The second unit conductor 421 can overlap only one first unit conductor 411. The center of gravity of the second unit conductor 421 can be located between two first unit conductors 411. The center of gravity of the second unit conductor 421 can coincide with that of one first unit conductor 411. The second unit conductor 421 can at least partially overlap a first unit slot 412. The second unit conductor 421 can overlap only one first unit slot 412.

The center of gravity of the second unit conductor 421 can be located between two first unit slots 412 arranged in the x-direction or y-direction. The center of gravity of second unit conductors 421 can coincide with that of one first unit slot 412.

In a case where the second unit resonator 42X uses a slot resonator, the second conductive layer 42 has at least one conductive layer extending along the xy plane. The second conductive layer 42 includes at least one second unit slot 422. The second unit slot 422 can function as the second unit resonator 42X or the second divisional resonator 42Y. The second conductive layer 42 can include a plurality of second unit slots 422 that is arranged in the xy plane. The second unit slots 422 can be arranged in the form of a square grid, oblique grid, rectangular grid, or hexagonal grid. The second unit slot 422 corresponding to the second divisional resonator 42Y is located at an end of the second conductive layer 42 in the xy plane.

The second unit slot 422 at least partially overlaps at least one of the first unit resonator 41X and the first divisional resonator 41Y in the y-direction. The second unit slot 422 can overlap a plurality of first unit resonators 41X. The second unit slot 422 can overlap a plurality of first divisional resonators 41Y. The second unit slot 422 can overlap one first unit resonator 41X and four first divisional resonators 41Y. The second unit slot 422 can overlap only one first unit resonator 41X. The center of gravity of the second unit slot 422 can coincide with that of one first unit conductor 41X. The center of gravity of the second unit slot 422 can be located between a plurality of first unit conductors 41X. The center of gravity of the second unit slot 422 can be located between two first unit resonators 41X and two first divisional resonators 41Y arranged in the x-direction or y-direction.

The second unit slot 422 can at least partially overlap two first unit conductors 411. The second unit slot 422 can overlap only one first unit conductor 411. The center of gravity of the second unit slot 422 can be located between two first unit conductors 411. The center of gravity of second unit slot 422 can coincide with that of one first unit conductor 411. The second unit slot 422 can at least partially overlap a first unit slot 412. The second unit slot 422 can overlap only one first unit slot 412. The center of gravity of the second unit slot 422 can be located between two first unit slots 412 arranged in the x-direction or y-direction. The center of gravity of the second unit slot 422 can overlap one first unit slot 412.

The unit resonator 40X includes at least one-equivalent first unit resonator 41X and at least one-equivalent second unit resonator 42X. The unit resonator 40X can include one first unit resonator 41X. The unit resonator 40X can include a plurality of first unit resonators 41X. The unit resonator 40X can include one first divisional resonator 41Y. The unit resonator 40X can include a plurality of first divisional resonators 41Y. The unit resonator 40X can include a portion of a first unit resonator 41X. The unit resonator 40X can include one or a plurality of partial first unit resonators 41X. The unit resonator 40X includes a plurality of partial resonators that includes one or a plurality of partial first unit resonators 41X and one or a plurality of first divisional resonators 41Y. The plurality of partial resonators included in the unit resonator 40X is combined into at least one-equivalent first unit resonator 41X. The unit resonator 40X can include a plurality of first divisional resonators 41Y without including the first unit resonator 41X. The unit resonator 40X can include, for example, four first divisional resonators 41Y. The unit resonator 40X can include only a plurality of partial first unit resonators 41X. The unit resonator 40X can include one or a plurality of partial first unit resonators 41X and one or a plurality of first divisional resonators 41Y. The unit resonator 40X can include, for example, two partial first unit resonators 41X and two first divisional resonators 41Y. The unit resonator 40X can include, at both ends in the x-direction, first conductive layers 41 that are substantially the same in mirror image. The unit resonator 40X can include first conductive layers 41 that are substantially symmetric about a center line extending in the z-direction.

The unit resonator 40X can include one second unit resonator 42X. The unit resonator 40X can include a plurality of second unit resonators 42X. The unit resonator 40X can include one second divisional resonator 42Y. The unit resonator 40X can include a plurality of second divisional resonators 42Y. The unit resonator 40X can include a portion of a second unit resonator 42X. The unit resonator 40X can include one or a plurality of partial second unit resonators 42X. The unit resonator 40X includes a plurality of partial resonators that includes one or a plurality of partial second unit resonators 42X and one or a plurality of second divisional resonators 42Y. The plurality of partial resonators included in the unit resonator 40X is combined into at least one-equivalent second unit resonator 42X. The unit resonator 40X can include a plurality of second divisional resonators 42Y without including the second unit resonator 42X. The unit resonator 40X can include, for example, four second divisional resonators 42Y. The unit resonator 40X can include only a plurality of partial second unit resonators 42X. The unit resonator 40X can include one or a plurality of partial second unit resonators 42X and one or a plurality of second divisional resonators 42Y. The unit resonator 40X can include, for example, two partial second unit resonators 42X and two second divisional resonators 42Y. The unit resonator 40X can include, at both ends in the x-direction, second conductive layers 42 that are substantially the same in mirror image. The unit resonator 40X can include second conductive layers 42 that are substantially symmetric about a center line extending in the y-direction.

In an example of the plurality of embodiments, the unit resonator 40X includes one first unit resonator 41X and a plurality of partial second unit resonators 42X. For example, the unit resonator 40X includes one first unit resonator 41X and four halves of second unit resonators 42X. The unit resonator 40X includes one-equivalent first unit resonator 41X and two-equivalent second unit resonators 42X. The configuration of the unit resonator 40X is not limited to this example.

The resonator 10 can include at least one unit structure 10X. The resonator 10 can include a plurality of unit structures 10X. The plurality of unit structures 10X can be arranged in the xy plane. The plurality of unit structures 10X can be arranged in the form of a square grid, oblique grid, rectangular grid, or hexagonal grid. The unit structure 10X includes any of repeated units of square grid, oblique grid, rectangular grid, and hexagonal grid. The unit structures 10X arranged infinitely along the xy plane can function as an artificial magnetic conductor (AMC).

The unit structure 10X can include at least part of the base 20, at least part of the third conductor 40, and at least part of the fourth conductor 50. The portions of the base 20, third conductor 40, and fourth conductor 50 that are included in the unit structure 10X overlap in the z-direction. The unit structure 10X includes the unit resonator 40X, part of the base 20 that overlaps the unit resonator 40X in the z-direction, and the fourth conductor 50 that overlaps the unit resonator 40X in the z-direction. The resonator 10 can include, for example, six unit structures 10X that are arranged in two rows and three columns.

The resonator 10 can include at least one unit structure 10X between two pair conductors 30 facing each other in the x-direction. The two pair conductors 30 appear as electric walls extending in the yz plane from the unit structure 10X. The unit structure 10X is electrically open at an end in the y-direction. The unit structure 10X has high impedance in zx planes at both ends in the y-direction. In the unit structure 10X, the zx planes at both ends in the y-direction appear as magnetic walls. The unit structures 10X can be arranged repeatedly so as to be line-symmetric in the z-direction. The unit structure 10X surrounded by two electric walls and two high impedance surfaces (magnetic walls) has an artificial magnetic conductor character in the z-direction. The unit structure 10X surrounded by two electric walls and two high-impedance surfaces (magnetic walls) has a finite number of artificial magnetic conductor characters.

The operating frequency of the resonator 10 can be different from the operating frequency of the first unit resonator 41X. The operating frequency of the resonator 10 can be different from the operating frequency of the second unit resonator 42X. The operating frequency of the resonator 10 can be changed by the coupling of the first unit resonator 41X and the second unit resonator 42X that form the unit resonator 40X.

The third conductor 40 can include the first conductive layer 41 and the second conductive layer 42. The first conductive layer 41 includes at least one first unit conductor 411. The first unit conductor 411 includes a first connecting conductor 413 and a first floating conductor 414. The first connecting conductor 413 is connected to any of the pair conductors 30. The first floating conductor 414 is not connected to the pair conductors 30. The second conductive layer 42 includes at least one second unit conductor 421. The second unit conductor 421 includes a second connecting conductor 423 and a second floating conductor 424. The second connecting conductor 423 is connected to any of the pair conductors 30. The second floating conductor 424 is not connected to the pair conductors 30. The third conductor 40 can include a first unit conductor 411 and the second unit conductor 421.

The first connecting conductor 413 can have a larger length than the first floating conductor 414 in the x-direction. The first connecting conductor 413 can have a smaller length than the first floating conductor 414 in the x-direction. The first connecting conductor 413 can have a length that is half of that of the first floating conductor 414, in the x-direction. The second connecting conductor 423 can have a larger length than the second floating conductor 424 in the x-direction. The second connecting conductor 423 can have a smaller length than the second floating conductor 424 in the x-direction. The second connecting conductor 423 can have a length that is half of that of the second floating conductor 424, in the x-direction.

The third conductor 40 can include a current path 401 that serves as a current path between the first conductor 31 and the second conductor 32 when the resonator 10 resonates. The current path 401 can be connected to the first conductor 31 and the second conductor 32. The current path 401 has capacitance between the first conductor 31 and the second conductor 32. The capacitance of the current path 401 is electrically connected in series between the first conductor 31 and the second conductor 32. In the current path 401, conductive members are separated between the first conductor 31 and the second conductor 32. The current path 401 can include a conductive member connected to the first conductor 31 and a conductive member connected to the second conductor 32.

In the plurality of embodiments, in the current path 401, the first unit conductor 411 and the second unit conductor 421 partially face each other in the z-direction. In the current path 401, the first unit conductor 411 and the second unit conductor 421 are capacitively coupled. The first unit conductor 411 has a capacitance component at an end in the x-direction. The first unit conductor 411 can have a capacitance component at an end in the y-direction that faces the second unit conductor 421 in the z-direction. The first unit conductor 411 can have a capacitance component at an end in the x-direction and at an end in the y-direction that face the second unit conductor 421 in the z-direction. The second unit conductor 421 has a capacitance component at an end in the x-direction. The second unit conductor 421 can have a capacitance component at an end in the y-direction that faces the first unit conductor 411 in the z-direction. The second unit conductor 421 can have a capacitive component at an end in the x-direction and at an end in the y-direction that face the first unit conductor 411 in the z-direction.

The resonator 10 can reduce a resonant frequency by increasing the capacitive coupling in the current path 401. In achieving a desired operating frequency, the resonator 10 can reduce the length in the x-direction by increasing the capacitive coupling in the current path 401. In the third conductor 40, the first unit conductor 411 and the second unit conductor 421 face each other in a stacking direction of the base 20 and are capacitively coupled. The third conductor 40 can adjust the capacitance between the first unit conductor 411 and the second unit conductor 421 by the area of a portion where the first unit conductor 411 and the second unit conductor 421 face each other.

In the plurality of embodiments, the length of the first unit conductor 411 in the y-direction is different from the length of the second unit conductor 421 in the y-direction. In the resonator 10, when a relative position between the first unit conductor 411 and the second unit conductor 421 is displaced from an ideal position along the xy plane, different lengths in a third direction between the first unit conductor 411 and the second unit conductor 421 can reduce a change in magnitude of the capacitance.

In the plurality of embodiments, the current path 401 includes one conductive member that is spatially separated from the first conductor 31 and the second conductor 32 and is capacitively coupled to the first conductor 31 and the second conductor 32.

In the plurality of embodiments, the current path 401 includes the first conductive layer 41 and the second conductive layer 42. The current path 401 includes at least one first unit conductor 411 and at least one second unit conductor 421. The current path 401 includes two first connecting conductors 413 and two second connecting conductors 423 or one first connecting conductor 413 and one second connecting conductor 423. In the current path 401, the first unit conductors 411 and the second unit conductors 421 can be arranged alternately in a first direction.

In the plurality of embodiments, the current path 401 includes the first connecting conductor 413 and the second connecting conductor 423. The current path 401 includes at least one first connecting conductor 413 and at least one second connecting conductor 423. In the current path 401, the third conductor 40 has capacitance between the first connecting conductor 413 and the second connecting conductor 423. In an example of the embodiments, the first connecting conductor 413 can face the second connecting conductor 423 to have capacitance. In an example of the embodiment, the first connecting conductor 413 can be capacitively connected to the second connecting conductor 423 via another conductive member.

In the plurality of embodiments, the current path 401 includes the first connecting conductor 413 and the second floating conductor 424. The current path 401 includes two first connecting conductors 413. In the current path 401, the third conductor 40 has capacitance between the two first connecting conductors 413. In an example of the embodiments, the two first connecting conductors 413 can be capacitively connected via at least one second floating conductor 424. In an example of the embodiment, the two first connecting conductors 413 can be capacitively connected via at least one first floating conductor 414 and a plurality of second floating conductors 424.

In the plurality of embodiments, the current path 401 includes the first floating conductor 414 and the second connecting conductor 423. The current path 401 includes two second connecting conductors 423. In the current path 401, the third conductor 40 has capacitance between the two second connecting conductors 423. In an example of the embodiments, the two second connecting conductors 423 can be capacitively connected via at least one first floating conductor 414. In an example of the embodiment, the two second connecting conductors 423 can be capacitively connected via a plurality of first floating conductors 414 and at least one second floating conductor 424.

In the plurality of embodiments, each of the first connecting conductor 413 and the second connecting conductor 423 can have a length that is one quarter of a wavelength X of a resonant frequency. Each of the first connecting conductor 413 and the second connecting conductor 423 can function as a resonator that has a length one half of the wavelength X. Each of the first connecting conductor 413 and the second connecting conductor 423 can be capacitively coupled to a resonator so as to oscillate in an odd mode or an even mode. The resonator 10 can use a resonant frequency in the even mode after capacitive coupling as the operating frequency.

The current path 401 can be connected to the first conductor 31 at a plurality of points. The current path 401 can be connected to the second conductor 32 at a plurality of points. The current path 401 can include a plurality of conductive paths that independently conducts current from the first conductor 31 to the second conductor 32.

In the second floating conductor 424 capacitively coupled to the first connecting conductor 413, an end of the second floating conductor 424 that is capacitively coupled to the first connecting conductor 413 has a smaller distance from the first connecting conductor 413 compared with distances from the pair conductors 30. In the first floating conductor 414 capacitively coupled to the second connecting conductor 423, an end of the first floating conductor 414 that is capacitively coupled to the second connecting conductor 423 has a smaller distance from the second connecting conductor 423 compared with distances from the pair conductors 30.

In the resonators 10 according to the plurality of embodiments, the conductive layers of the third conductors 40 can have different lengths in y-directions. A conductive layer of the third conductor 40 is capacitively coupled to another conductive layer in the z-direction. In the resonator 10, when conductive layers have different lengths in y-directions, a change in capacitance is reduced even if the conductive layers are displaced in the y-directions. In the resonator 10, the different lengths of the conductive layers in the y-directions can increase the acceptable range of displacement of the conductive layers in the y-direction.

In the resonators 10 according to the plurality of embodiments, the third conductors 40 have capacitance due to capacitive coupling between conductive layers. A plurality of capacitive portions having the capacitance can be arranged in the y-direction. The plurality of capacitive portions arranged in the y-direction can have an electromagnetically parallel relationship. The resonator 10, a plurality of capacitive portions electrically arranged in parallel can mutually complement individual capacitive errors.

When the resonator 10 is in a resonant state, current flows through the pair conductors 30, the third conductor 40, and the fourth conductor 50 in a loop. When the resonator 10 is in the resonant state, alternating current is flowing in the resonator 10. In the resonator 10, current flowing through the third conductor 40 is defined as first current, and current flowing through the fourth conductor 50 is defined as second current. When the resonator 10 is in the resonant state, a direction in which the first current flows is different from a direction in which the second current flows, in the x-direction. For example, when the first current flows in a +x-direction, the second current flows in a −x-direction. For example, when the first current flows in the −x-direction, the second current flows in the +x-direction. That is, when the resonator 10 is in the resonant state, the loop current alternately flows in the +x-direction and the −x-direction. The resonator 10 radiates an electromagnetic wave by repeating reversal of the loop current that generates a magnetic field.

In the plurality of embodiments, the third conductor 40 includes the first conductive layer 41 and the second conductive layer 42. In the third conductor 40, since the first conductive layer 41 and the second conductive layer 42 are capacitively coupled to each other, current globally appears to flow in one direction in the resonant state. In the plurality of embodiments, current flowing through each conductor has a high density at an end in the y-direction.

In the resonator 10, the first current and the second current flow in a loop via the pair conductors 30. In the resonator 10, the first conductor 31, the second conductor 32, the third conductor 40, and the fourth conductor 50 form a resonance circuit. The resonant frequency of the resonator 10 is the resonant frequency of each unit resonator. When the resonator 10 includes one unit resonator or when the resonator 10 includes part of a unit resonator, the resonant frequency of the resonator 10 changes depending on the base 20, pair conductors 30, third conductor 40, and fourth conductor 50 as well as electromagnetic coupling between the resonator 10 and the surroundings. For example, when the third conductor 40 has poor periodicity, the resonator 10 becomes one unit resonator as a whole or becomes part of one unit resonator as a whole. For example, the resonant frequency of the resonator 10 changes depending on the lengths of the first conductor 31 and second conductor 32 in the z-direction, the lengths of the third conductor 40 and the fourth conductor 50 in the x-direction, and the capacitance of the third conductor 40 and fourth conductor 50. For example, when the resonator 10 has a large capacitance between the first unit conductor 411 and the second unit conductor 421, the lengths of the first conductor 31 and second conductor 32 in the z-direction and the lengths of the third conductor 40 and fourth conductor 50 in the x-direction are reduced, simultaneously enabling reduction of the resonant frequency.

In the plurality of embodiments, in the resonator 10, the first conductive layer 41 serves as an effective electromagnetic wave radiation surface in the z-direction. In the plurality of embodiments, in the resonator 10, a first area of the first conductive layer 41 is larger than a first area of the other conductive layers. The resonator 10 can increase the first area of the first conductive layer 41 to increase the radiation of the electromagnetic wave.

In the plurality of embodiments, the resonator 10 can include one or a plurality of impedance elements 45. Each of the impedance elements 45 has an impedance value between a plurality of terminals. The impedance element 45 changes the resonant frequency of the resonator 10. The impedance element 45 can include a resistor, a capacitor, and an inductor. The impedance element 45 can include a variable element whose impedance value can be changed. The variable element can change the impedance value with an electric signal. The variable element can change the impedance value with a physical mechanism.

The impedance element 45 can be connected to two unit conductors of the third conductor 40 arranged in the x-direction. The impedance element 45 can be connected to two first unit conductors 411 that are arranged in the x-direction. The impedance element 45 can be connected to a first connecting conductor 413 and the first floating conductor 414, that are arranged in the x-direction. The impedance element 45 can be connected to the first conductor 31 and the first floating conductor 414. The impedance element 45 is connected to a unit conductor of the third conductor 40 at the center in the y-direction. The impedance element 45 is connected to the centers of the two first unit conductors 411 in the y-direction.

The impedance element 45 is electrically connected in series between two conductive members that are arranged in the x-direction in the xy plane. The impedance element 45 can be electrically connected in series between two first unit conductors 411 that are arranged in the x-direction. The impedance element 45 can be electrically connected in series between a first connecting conductor 413 and the first floating conductor 414 that are arranged in the x-direction. The impedance element 45 can be electrically connected in series between the first conductor 31 and the first floating conductor 414.

The impedance element 45 can be electrically connected in parallel to two first unit conductors 411 and two second unit conductors 421 that overlap in the z-direction and have capacitance. The impedance element 45 can be electrically connected in parallel to the second connecting conductor 423 and the first floating conductor 414 that overlap in the z-direction and have capacitance.

The resonator 10 can reduce the resonant frequency by adding a capacitor as the impedance element 45. The resonator 10 can increase the resonant frequency by adding an inductor as the impedance element 45. The resonator 10 can include impedance elements 45 having different impedance values. The resonator 10 can include capacitors having different electric capacitances as the impedance elements 45. The resonator 10 can include inductors having different inductances as the impedance elements 45. In the resonator 10, addition of the impedance elements 45 having different impedance values increases an adjustment range of the resonant frequency. The resonator 10 can simultaneously include a capacitor and an inductor as the impedance elements 45. In the resonator 10, simultaneous addition of the capacitor and the inductor as the impedance elements 45 increases the adjustment range of the resonant frequency. Since the resonator 10 includes the impedance element 45, the resonator 10 can be one unit resonator as a whole or be part of one unit resonator as a whole.

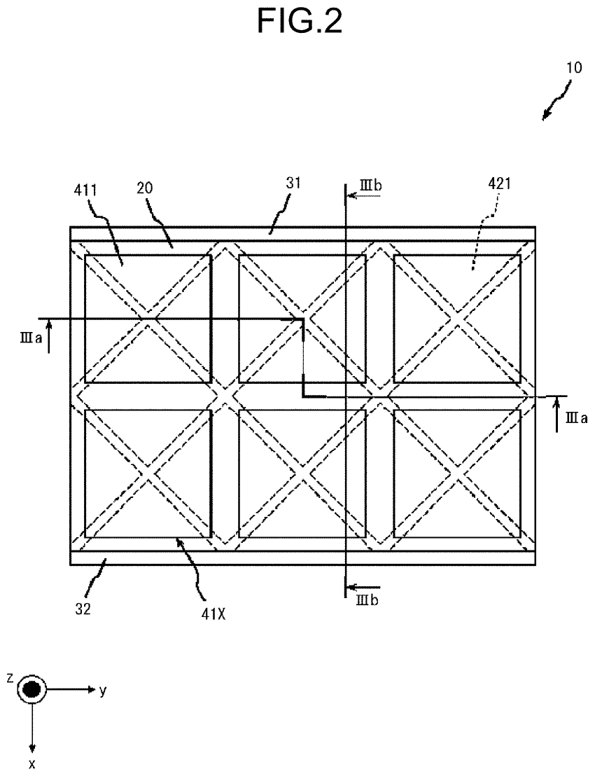

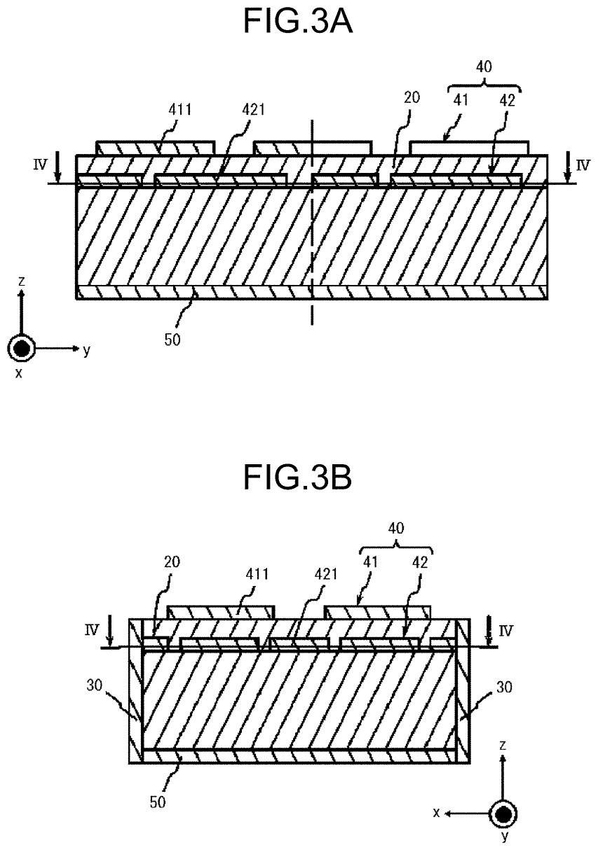

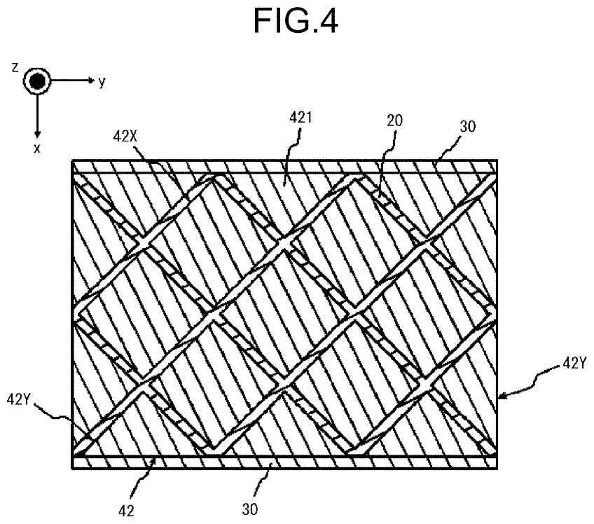

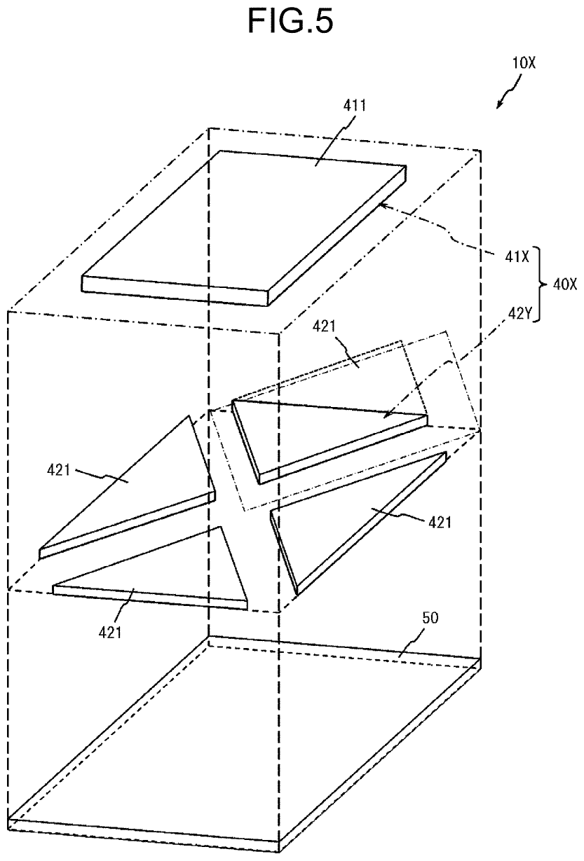

FIGS. 1 to 5 are diagrams illustrating a resonator 10, which is an example of the plurality of embodiments. FIG. 1 is a schematic diagram of the resonator 10. FIG. 2 is a plan view of the xy plane, as viewed in the z-direction. FIG. 3A is a cross-sectional view taken along line IIIa-IIIa illustrated in FIG. 2. FIG. 3B is a cross-sectional view taken along line IIIb-IIIb illustrated in FIG. 2. FIG. 4 is a cross-sectional view taken along line IV-IV illustrated in FIGS. 3A and 3B. FIG. 5 is a conceptual diagram illustrating the unit structure 10X, which is an example of the plurality of embodiments.

In the resonator 10 illustrated in FIGS. 1 to 5, the first conductive layer 41 includes a patch resonator that serves as the first unit resonator 41X. The second conductive layer 42 includes a patch resonator that serves as the second unit resonator 42X. The unit resonator 40X includes one first unit resonator 41X and four second divisional resonators 42Y. The unit structure 10X includes the unit resonator 40X, part of the base 20 that overlaps the unit resonator 40X in the z-direction, and part of the fourth conductor 50.

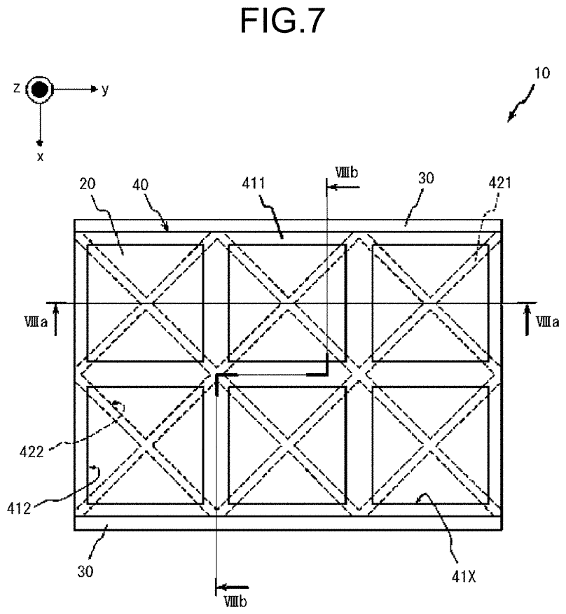

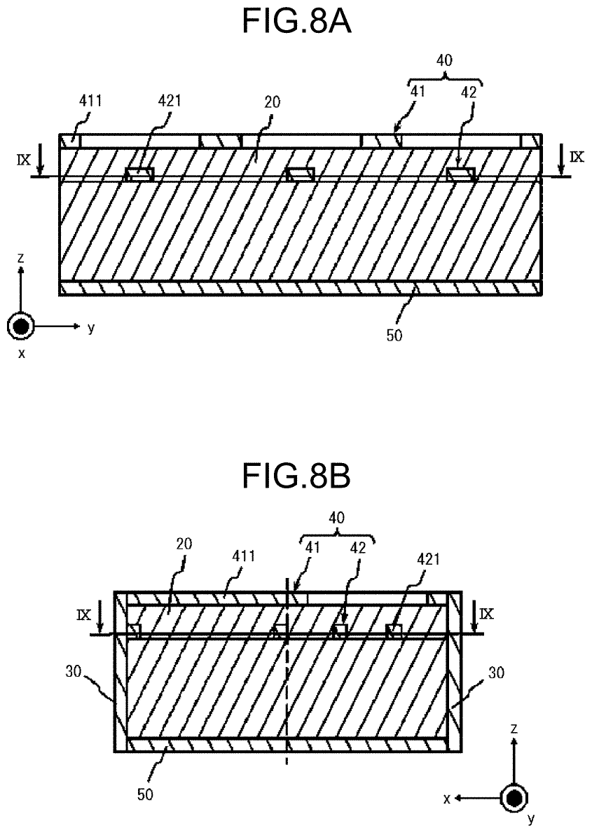

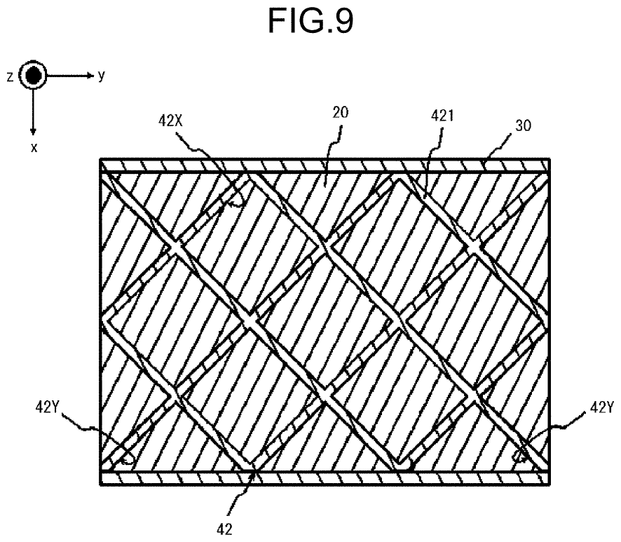

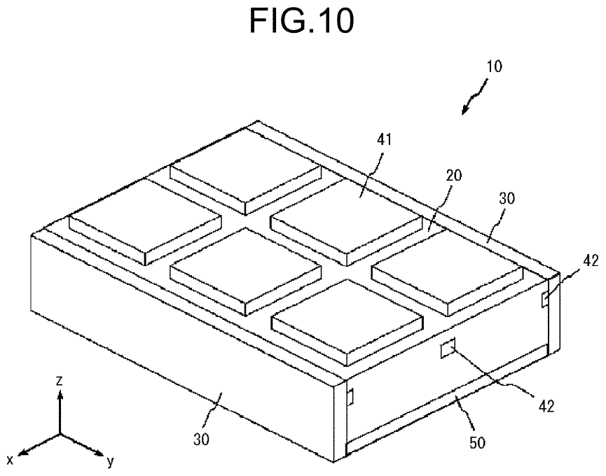

FIGS. 6 to 9 are diagrams illustrating a resonator 10, which is an example of the plurality of embodiments. FIG. 6 is a schematic diagram of the resonator 10. FIG. 7 is a plan view of the xy plane, as viewed in the z-direction. FIG. 8A is a cross-sectional view taken along line VIIIa-VIIIa illustrated in FIG. 7. FIG. 8B is a cross-sectional view taken along line VIIIb-VIIIb illustrated in FIG. 7. FIG. 9 is a cross-sectional view taken along line IX-IX illustrated in FIGS. 8A and 8B.

In the resonator 10 illustrated in FIGS. 6 to 9, the first conductive layer 41 includes a slot resonator that serves as the first unit resonator 41X. The second conductive layer 42 includes a slot resonator that serves as the second unit resonator 42X. The unit resonator 40X includes one first unit resonator 41X and four second divisional resonators 42Y. The unit structure 10X includes the unit resonator 40X, part of the base 20 that overlaps the unit resonator 40X in the z-direction, and part of the fourth conductor 50.

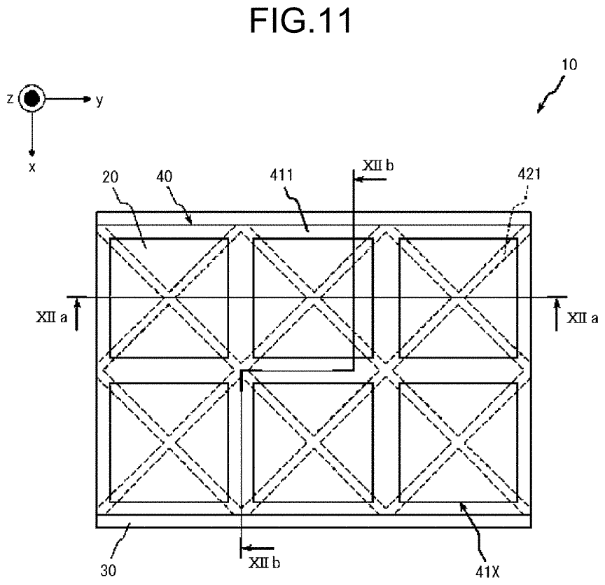

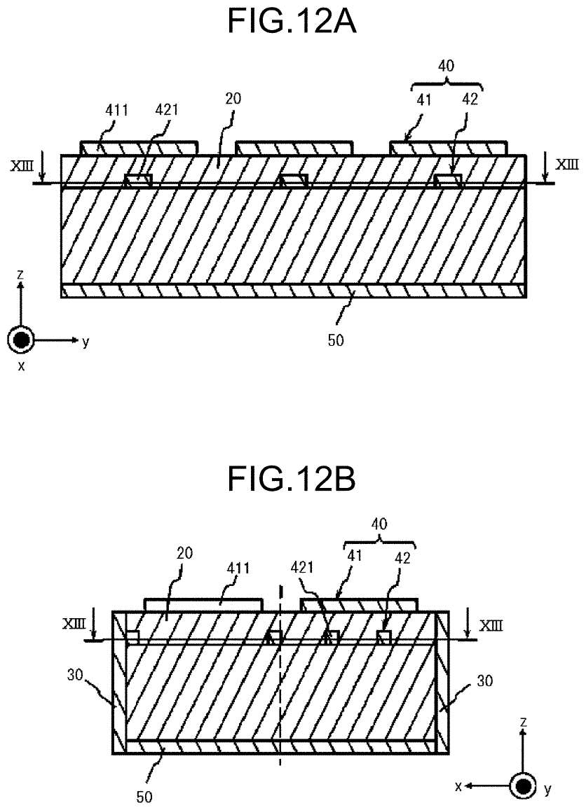

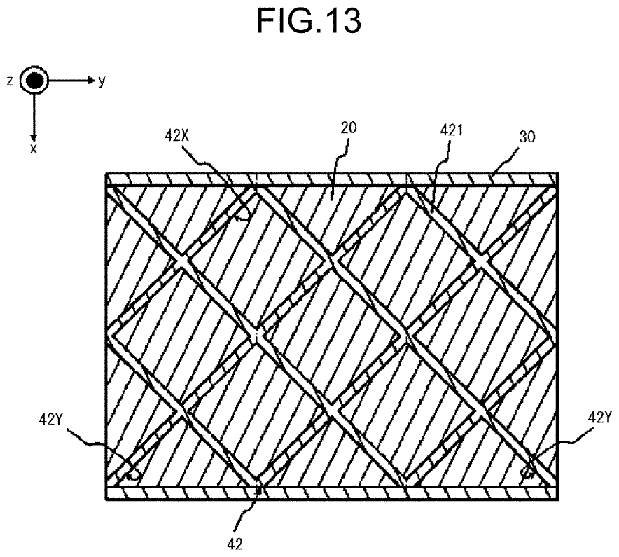

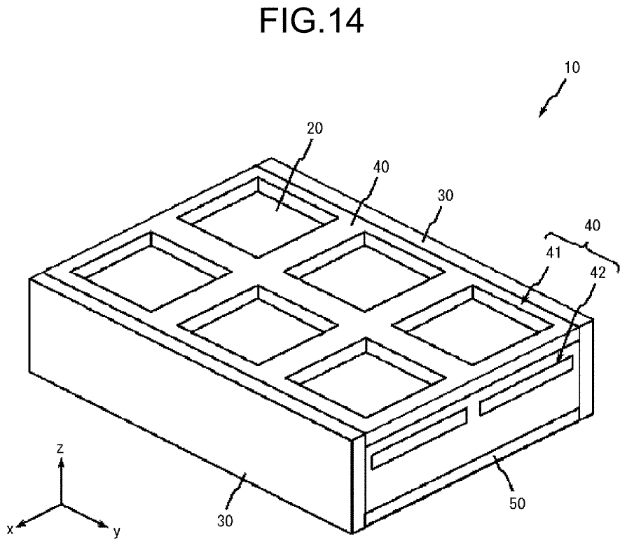

FIGS. 10 to 13 are diagrams illustrating a resonator 10, which is an example of the plurality of embodiments. FIG. 10 is a schematic diagram of the resonator 10. FIG. 11 is a plan view of the xy plane, as viewed in the z-direction. FIG. 12A is a cross-sectional view taken along line XIIa-XIIa illustrated in FIG. 11. FIG. 12B is a cross-sectional view taken along line XIIb-XIIb illustrated in FIG. 11. FIG. 13 is a cross-sectional view taken along line XIII-XIII illustrated in FIGS. 12A and 12B.

In the resonator 10 illustrated in FIGS. 10 to 13, the first conductive layer 41 includes a patch resonator that serves as the first unit resonator 41X. The second conductive layer 42 includes a slot resonator that serves as the second unit resonator 42X. The unit resonator 40X includes one first unit resonator 41X and four second divisional resonators 42Y. The unit structure 10X includes the unit resonator 40X, part of the base 20 that overlaps the unit resonator 40X in the z-direction, and part of the fourth conductor 50.

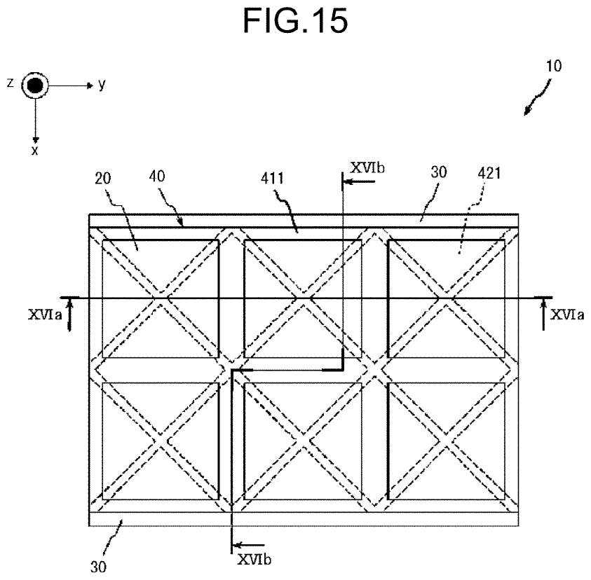

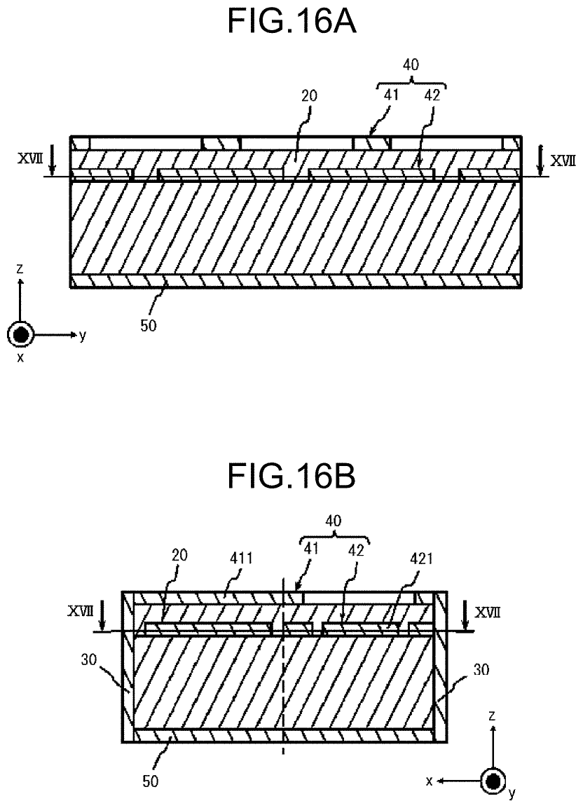

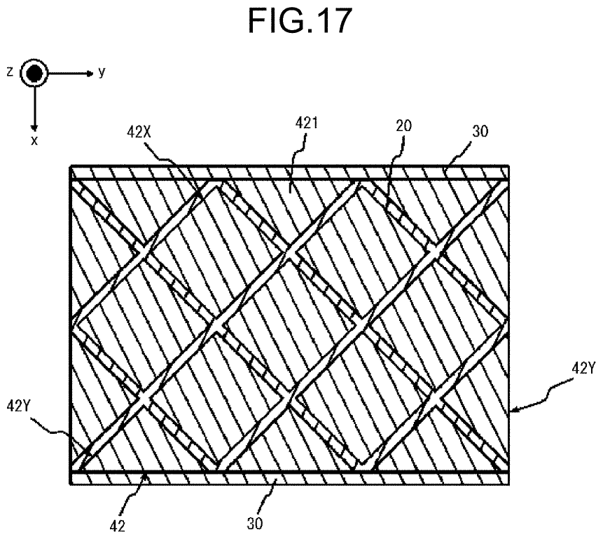

FIGS. 14 to 17 are diagrams illustrating a resonator 10, which is an example of the plurality of embodiments. FIG. 14 is a schematic diagram of the resonator 10. FIG. 15 is a plan view of the xy plane, as viewed in the z-direction. FIG. 16A is a cross-sectional view taken along line XVIa-XVIa illustrated in FIG. 15. FIG. 16B is a cross-sectional view taken along line XVIb-XVIb illustrated in FIG. 15. FIG. 17 is a cross-sectional view taken along line XVII-XVII illustrated in FIGS. 16A and 16B.

In the resonator 10 illustrated in FIGS. 14 to 17, the first conductive layer 41 includes a slot resonator that serves as the first unit resonator 41X. The second conductive layer 42 includes a patch resonator that serves as the second unit resonator 42X. The unit resonator 40X includes one first unit resonator 41X and four second divisional resonators 42Y. The unit structure 10X includes the unit resonator 40X, part of the base 20 that overlaps the unit resonator 40X in the z-direction, and part of the fourth conductor 50.

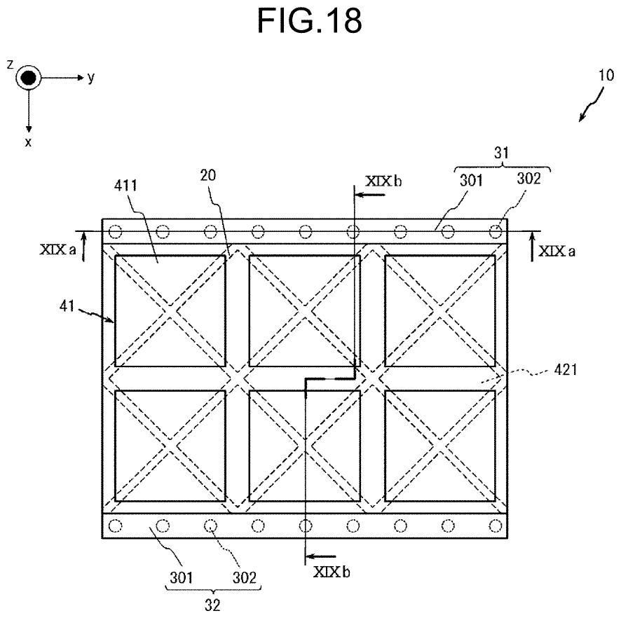

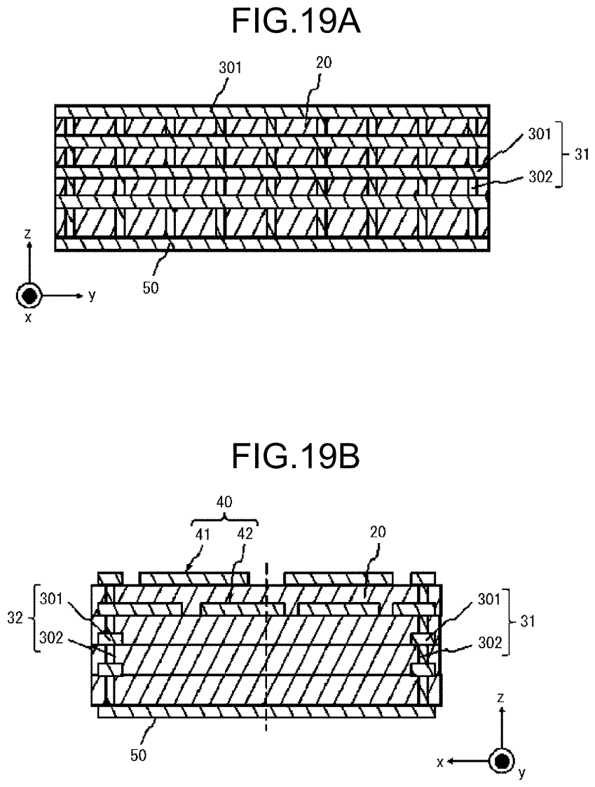

FIGS. 1 to 17 are diagrams each illustrating the resonator 10 as an example. The configuration of the resonator 10 is not limited to the structures illustrated in FIGS. 1 to 17. FIG. 18 is a diagram illustrating the resonator 10 including the pair conductors 30 having another configuration. FIG. 19A is a cross-sectional view taken along line XIXa-XIXa illustrated in FIG. 18. FIG. 19B is a cross-sectional view taken along line XIXb-XIXb illustrated in FIG. 18.

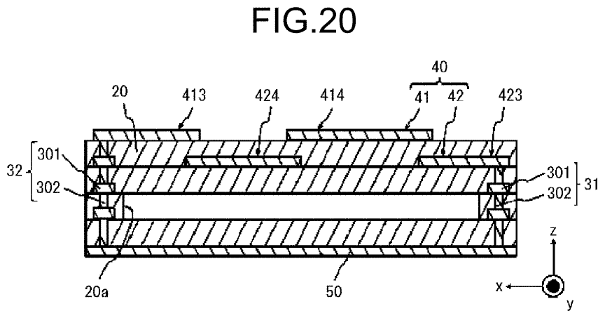

FIGS. 1 to 19B are diagrams each illustrating the base 20 as an example. The configuration of the base 20 is not limited to the configurations illustrated in FIGS. 1 to 19B. The base 20 can internally include a cavity 20a, as illustrated in FIG. 20. The cavity 20a is located between the third conductor 40 and the fourth conductor 50 in the z-direction. A dielectric constant of the cavity 20a is lower than a dielectric constant of the base 20. The base 20 including the cavity 20a can reduce an electromagnetic distance between the third conductor 40 and the fourth conductor 50.

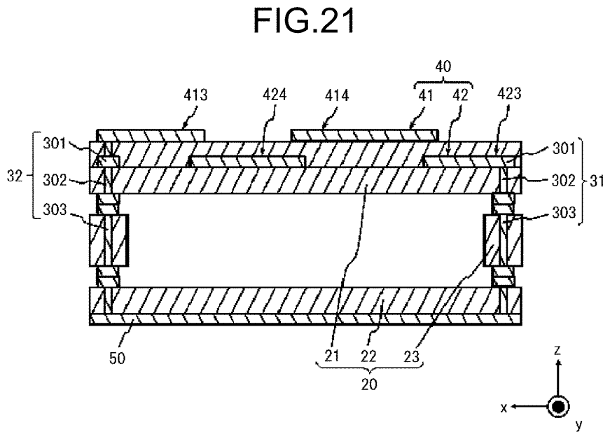

The base 20 can include a plurality of members, as illustrated in FIG. 21. The base 20 can include a first base 21, a second base 22, and a connector 23. The first base 21 and the second base 22 can be mechanically connected via the connector 23. The connector 23 can internally include a sixth conductor 303. The sixth conductor 303 is electrically connected to a fifth conductive layer 301 or a fifth conductor 302. The sixth conductor 303 is formed as the first conductor 31 or the second conductor 32 together with the fifth conductive layer 301 and the fifth conductor 302.

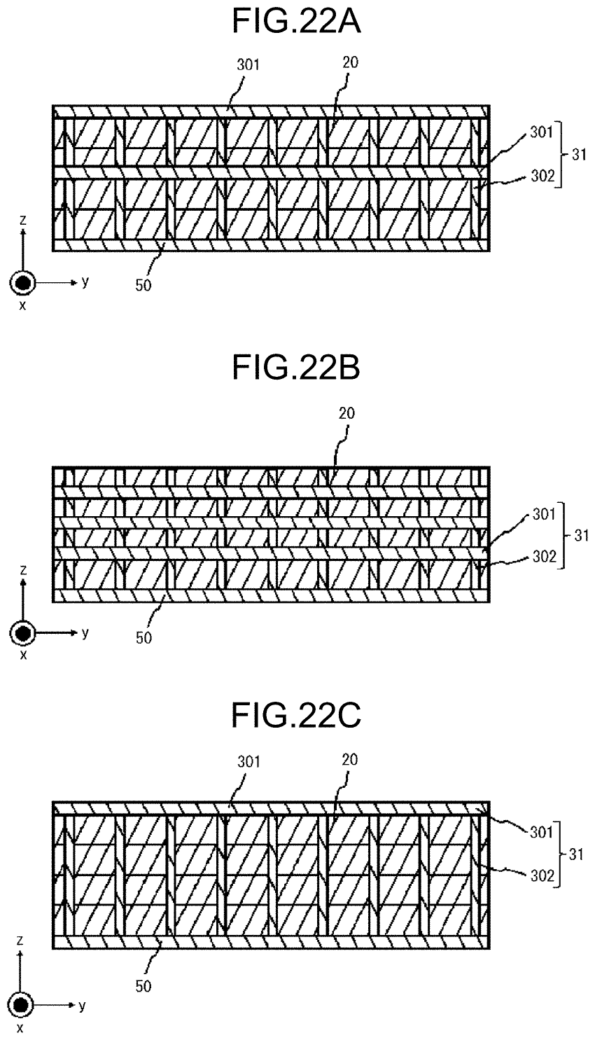

FIGS. 1 to 21 are diagrams each illustrating the pair conductors 30 as an example. The configuration of the pair conductors 30 is not limited to the configurations illustrated in FIGS. 1 to 21. FIGS. 22A to 28 are diagrams illustrating resonators 10 which includes other pair conductors 30 having other configurations. FIGS. 22A to 22C are cross-sectional views corresponding to FIG. 19A. As illustrated in FIG. 22A, the number of the fifth conductive layers 301 can be changed as appropriate. As illustrated in FIG. 22B, the fifth conductive layer 301 may not be located on the base 20. As illustrated in FIG. 22C, the fifth conductive layer 301 may not be located within the base 20.

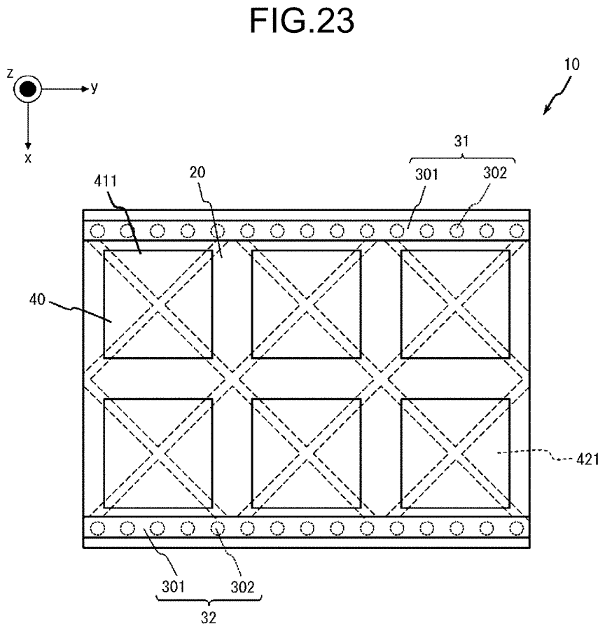

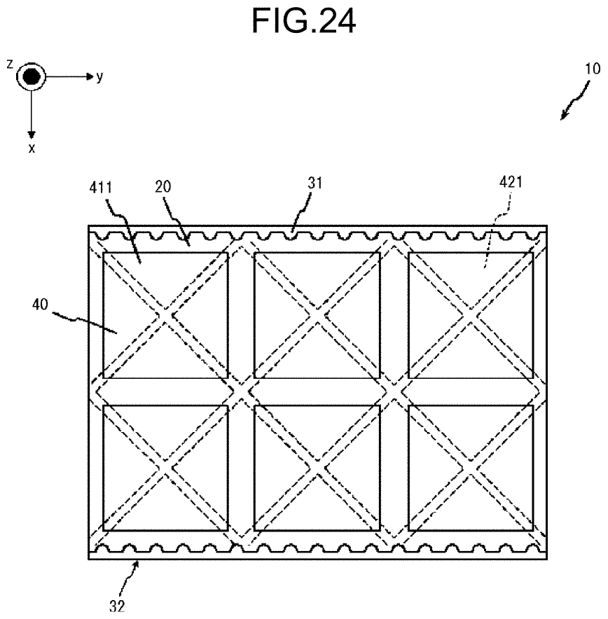

FIG. 23 is a plan view corresponding to FIG. 18. As illustrated in FIG. 23, in the resonator 10, the fifth conductor 302 can be separated from the boundary of the unit resonator 40X. FIG. 24 is a plan view corresponding to FIG. 18. As illustrated in FIG. 24, two pair conductors 30 each can include protrusions that protrude toward the other of the pair conductors 30. Such a resonator 10 can be formed, for example, by applying metal paste to the base 20 having recesses and curing the metal paste.

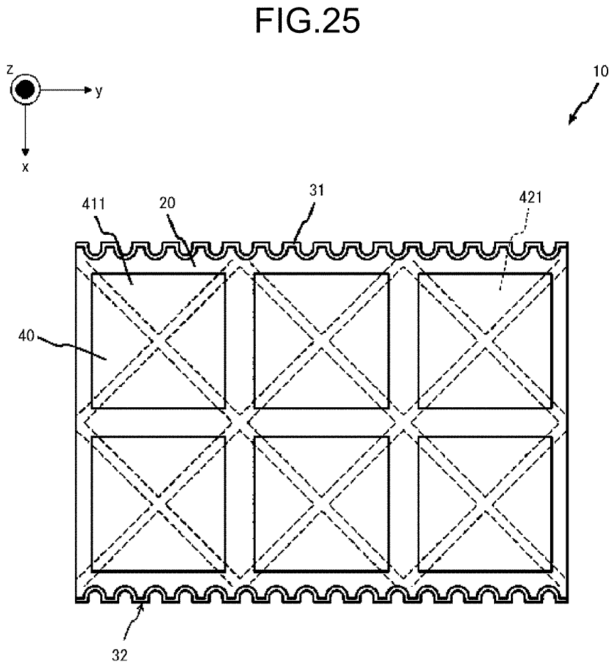

FIG. 25 is a plan view corresponding to FIG. 18. As illustrated in FIG. 25, the base 20 can have recesses. As illustrated in FIG. 25, the pair conductors 30 each have recesses that are recessed inward in the x-direction from an outer surface. As illustrated in FIG. 25, the pair conductors 30 each extend along a surface of the base 20. Such a resonator 10 can be formed, for example, by spraying a fine metal material onto the base 20 having recesses.

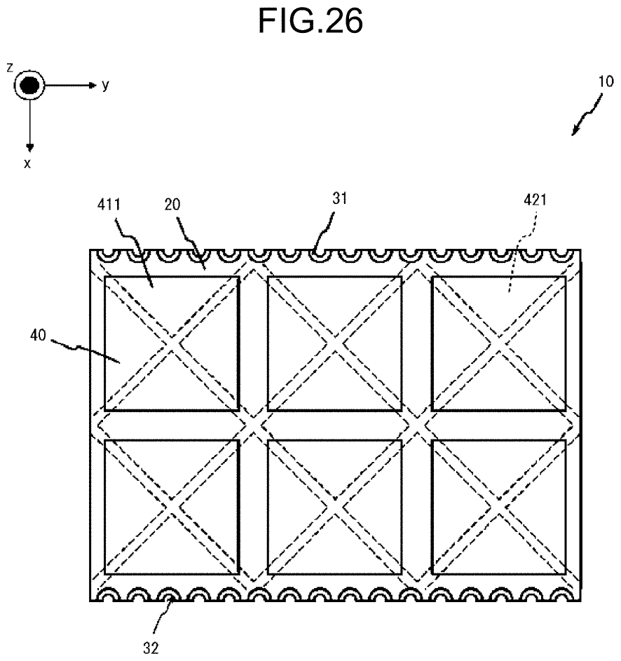

FIG. 26 is a plan view corresponding to FIG. 18. As illustrated in FIG. 26, the base 20 can have recesses. As illustrated in FIG. 26, the pair conductors 30 each have recesses that are recessed inward in the x-direction from an outer surface. As illustrated in FIG. 26, the pair conductors 30 each extend along the recesses of the base 20. Such a resonator 10 can be manufactured, for example, by dividing a mother substrate along an array of through-hole conductors. Such pair conductors 30 can be referred to as an end surface through-hole or the like.

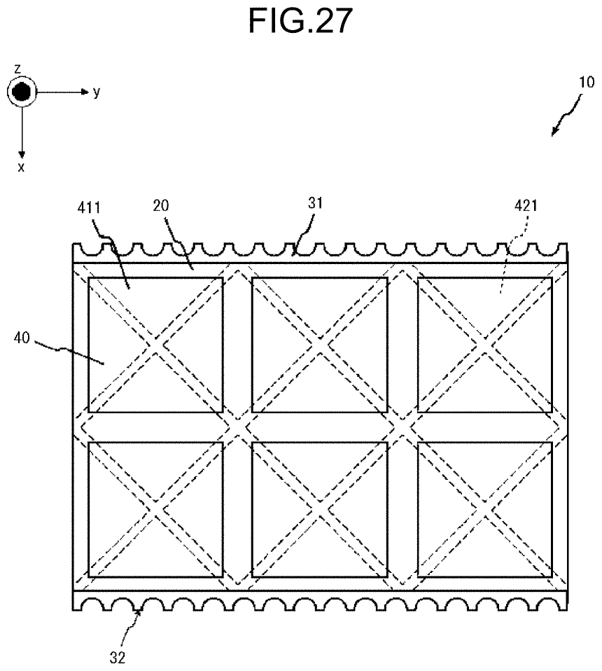

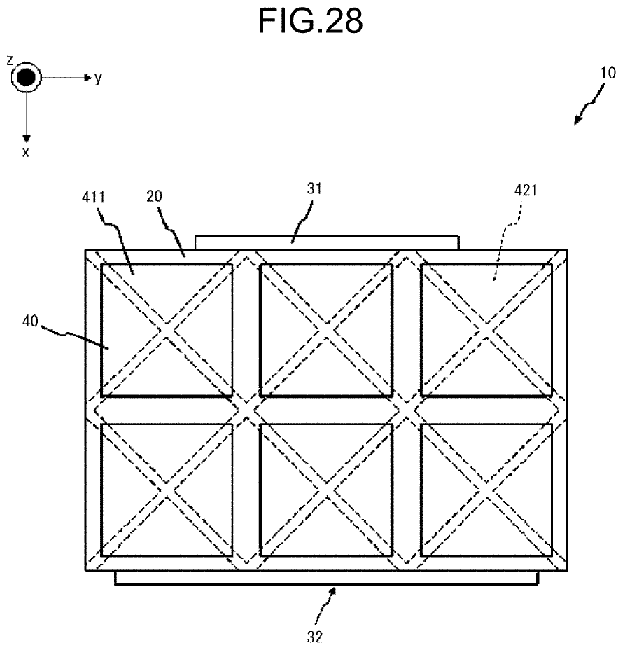

FIG. 27 is a plan view corresponding to FIG. 18.

As illustrated in FIG. 27, the base 20 can have recesses. As illustrated in FIG. 27, the pair conductors 30 each have recesses that are recessed inward in the x-direction from an outer surface. Such a resonator 10 can be manufactured, for example, by dividing a mother substrate along an array of through-hole conductors. Such pair conductors 30 can be referred to as an end surface through-hole or the like.

FIG. 28 is a plan view corresponding to FIG. 18. As illustrated in FIG. 28, pair conductors 30 each may have a smaller length in the x-direction than the base 20. The configuration of the pair conductors 30 is not limited to these configurations. Two pair conductors 30 can have different configurations. For example, one of the pair conductors 30 may include the fifth conductive layer 301 and the fifth conductor 302, and the other of the pair conductors 30 may include an end surface through-hole.

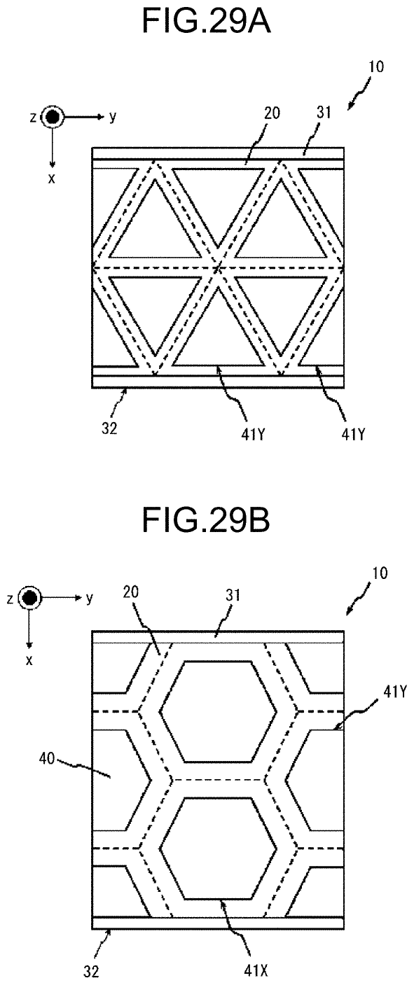

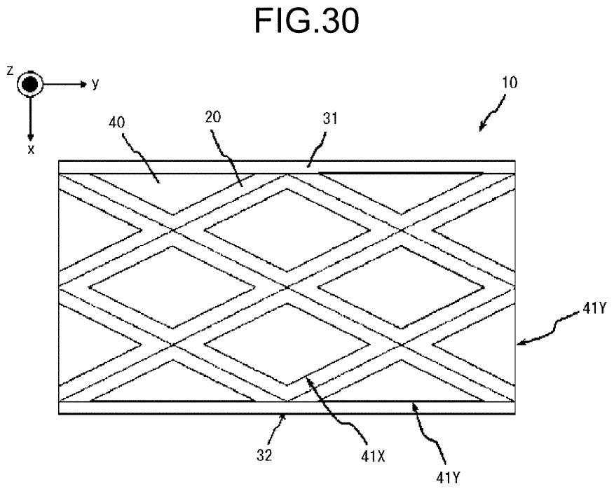

FIGS. 1 to 28 are diagrams each illustrating the third conductor 40 as an example. The configuration of the third conductor 40 is not limited to the configurations illustrated in FIGS. 1 to 28. The unit resonator 40X, the first unit resonator 41X, and the second unit resonator 42X are not limited to the square shape. The unit resonator 40X, the first unit resonator 41X, and the second unit resonator 42X can be referred to as the unit resonator 40X and the like. For example, the unit resonators 40X and the like may have a triangular shape as illustrated in FIG. 29A and may have a hexagonal shape as illustrated in FIG. 29B. As illustrated in FIG. 30, each side of the unit resonator 40X and the like can extend in a direction different from the x-direction and the y-direction. In the third conductor 40, the second conductive layer 42 can be located on the base 20 and the first conductive layer 41 can be located within the base 20. In the third conductor 40, the second conductive layer 42 can be located farther from the fourth conductor 50 than the first conductive layer 41.

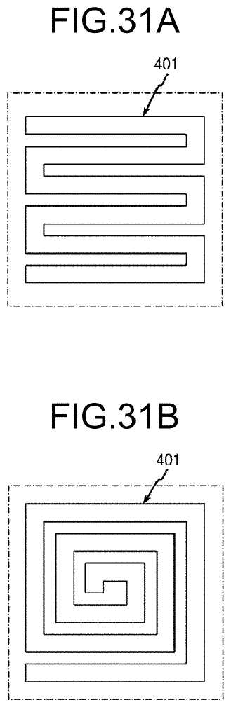

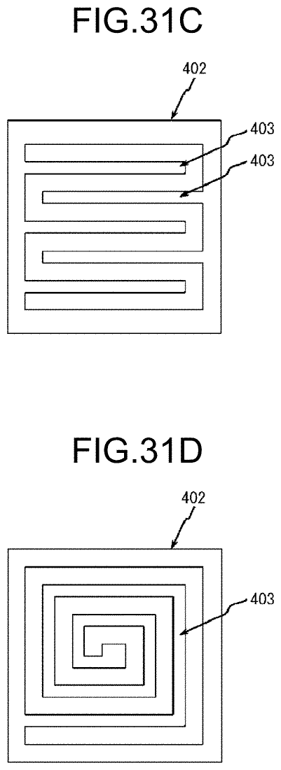

FIGS. 1 to 30 are diagrams each illustrating the third conductor 40 as an example. The configuration of the third conductor 40 is not limited to the configurations illustrated in FIGS. 1 to 30. The resonator including the third conductor 40 may be a linear resonator 401. FIG. 31A illustrates a meander-line resonator 401. FIG. 31B illustrates a spiral resonator 401. The resonator including the third conductor 40 may be a slot resonator 402. The slot resonator 402 can have one or a plurality of seventh conductors 403 in an opening. The seventh conductors 403 in the opening has one end that is opened and the other end that is electrically connected to a conductor defining the opening. In a unit slot illustrated in FIG. 31C, five seventh conductors 403 are located in an opening. In the unit slot, the seventh conductors 403 form a shape corresponding to a meander line. In a unit slot illustrated in FIG. 31D, one seventh conductor 403 is located in an opening. In the unit slot, the seventh conductor 403 forms a shape corresponding to a spiral.

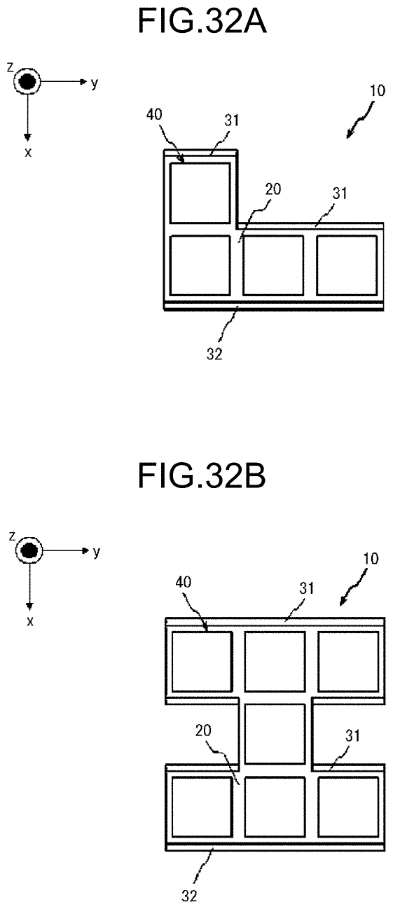

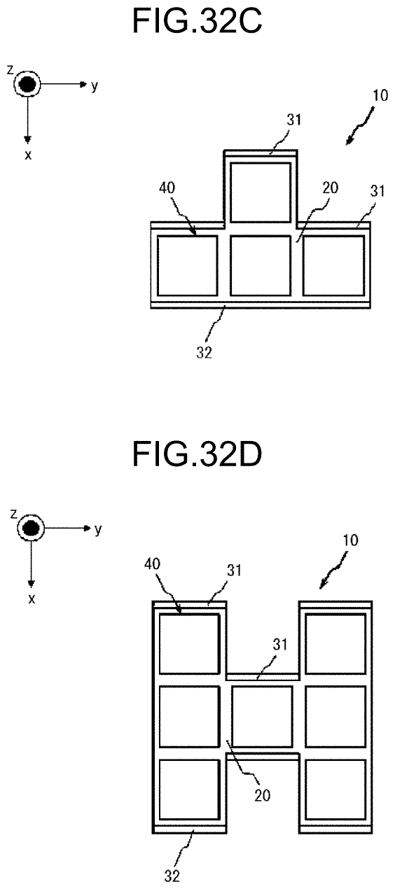

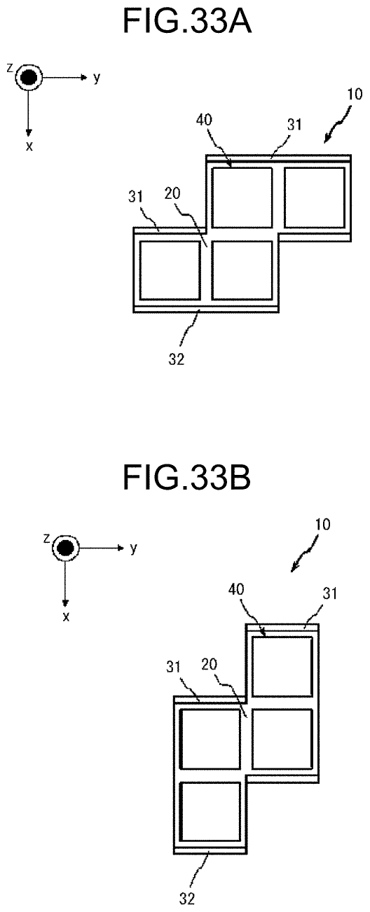

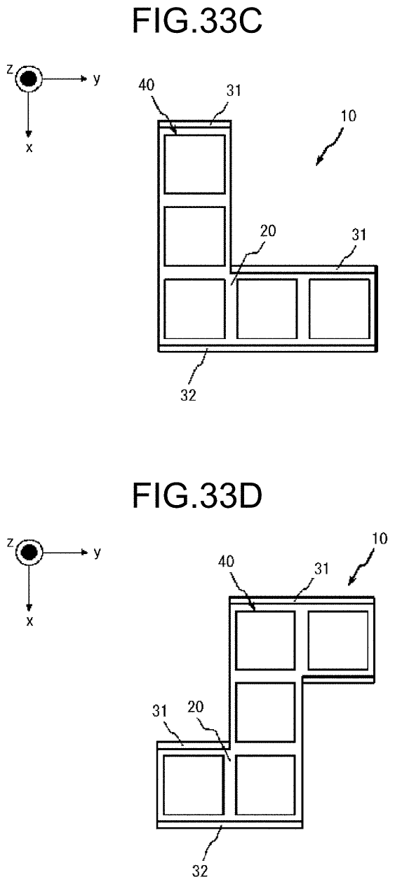

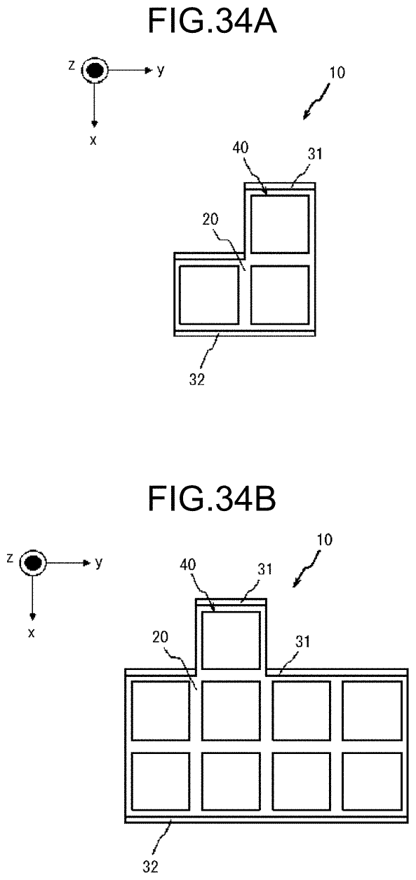

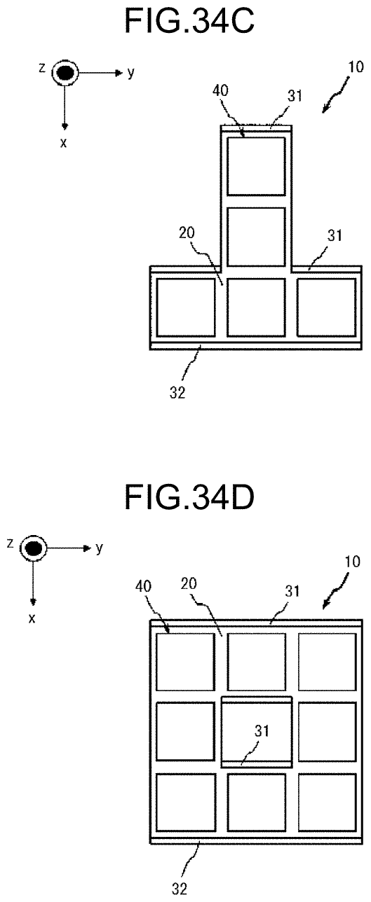

FIGS. 1 to 31D are diagrams each illustrating a configuration of the resonator 10 as an example. The configuration of the resonator 10 is not limited to the configurations illustrated in FIGS. 1 to 31D. For example, the resonator 10 can include three or more pair conductors 30. For example, one of the pair conductors 30 can face two pair conductors 30 in the x-direction. The two pair conductors 30 have different distances from the one of the pair conductors 30. For example, the resonator 10 can include two pairs of pair conductors 30. In the two pairs of pair conductors 30, the distances between the respective pairs and the lengths of the respective pairs are different. The resonator 10 can include five or more first conductors. The resonator 10 includes the unit structure 10X that can be aligned with another unit structure 10X in the y-direction. The unit structure 10X of the resonator 10 can be aligned with another unit structure 10X in the x-direction without through the pair conductors 30. FIGS. 32A to 34D are diagrams illustrating examples of the resonators 10. In the resonators 10 illustrated in FIGS. 32A to 34D, the unit resonator 40X of the unit structure 10X is represented as a square, but the unit resonator 40X is not limited to this shape.

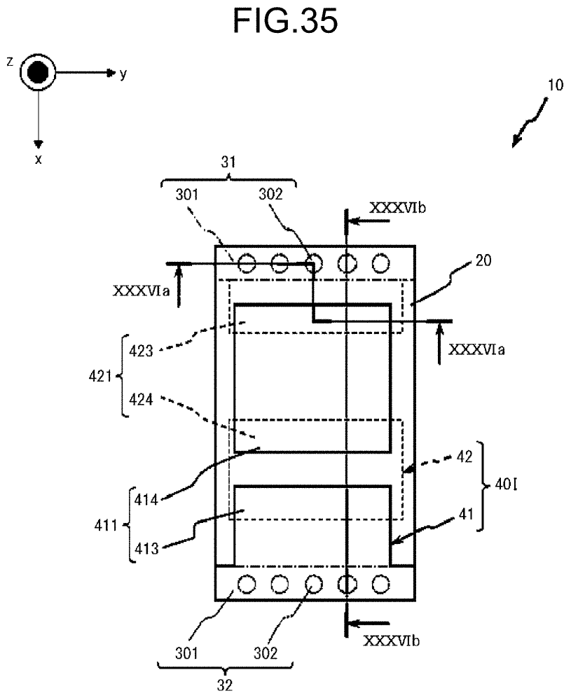

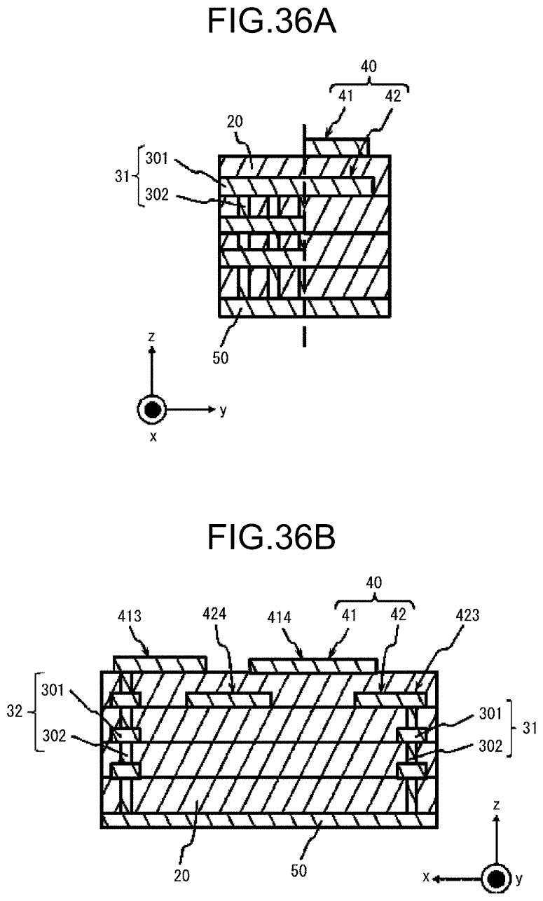

FIGS. 1 to 34D are diagrams each illustrating a configuration of the resonator 10 as an example. The configuration of the resonator 10 are not limited to the configurations illustrated in FIGS. 1 to 34D. FIG. 35 is a plan view of the xy plane, as viewed in the z-direction. FIG. 36A is a cross-sectional view taken along line XXXVIa-XXXVIa illustrated in FIG. 35 FIG. 36B is a cross-sectional view taken along line XXXVIb-XXXVIb illustrated in FIG. 35.

In the resonator 10 illustrated in FIGS. 35 to 36B, the first conductive layer 41 includes half of a patch resonator as the first unit resonator 41X. The second conductive layer 42 includes half of a patch resonator as the second unit resonator 42X. The unit resonator 40X includes one first divisional resonator 41Y and one second divisional resonator 42Y. The unit structure 10X includes the unit resonator 40X, part of the base 20 overlapping the unit resonator 40X in the z-direction, and part of the fourth conductor 50. In the resonator 10 illustrated in FIG. 35, three unit resonators 40X are arranged in the x-direction. The first unit conductor 411 and the second unit conductor 421 included in the three unit resonators 40X form one current path 401.

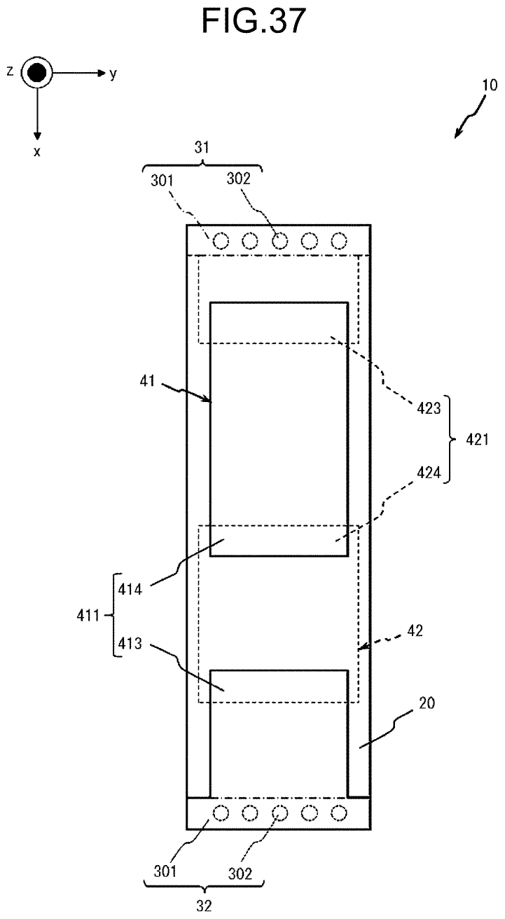

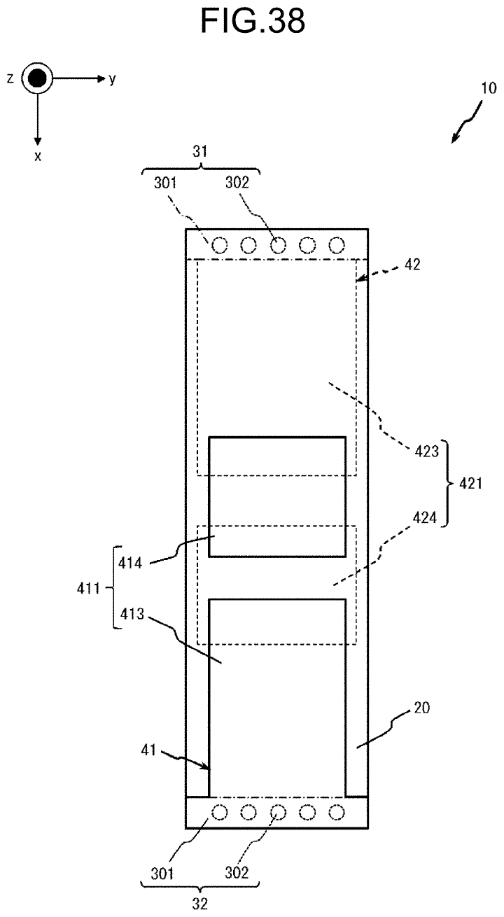

FIG. 37 illustrates another example of the resonator 10 illustrated in FIG. 35. The resonator 10 illustrated in FIG. 37 has a length larger in the x-direction than the resonator 10 illustrated in FIG. 35. The size of the resonator 10 is not limited to the resonator 10 illustrated in FIG. 37 and can be changed as appropriate. In the resonator 10 of FIG. 37, the first connecting conductor 413 has a length in the x-direction that is different from the first floating conductor 414. In the resonator 10 of FIG. 37, the length of the first connecting conductor 413 in the x-direction is smaller than that of the first floating conductor 414. FIG. 38 illustrates another example of the resonator 10 illustrated in FIG. 35. In the resonator 10 illustrated in FIG. 38, the third conductor 40 has different lengths in the x-direction. In the resonator 10 of FIG. 38, the length of the first connecting conductor 413 in the x-direction is larger than that of the first floating conductor 414.

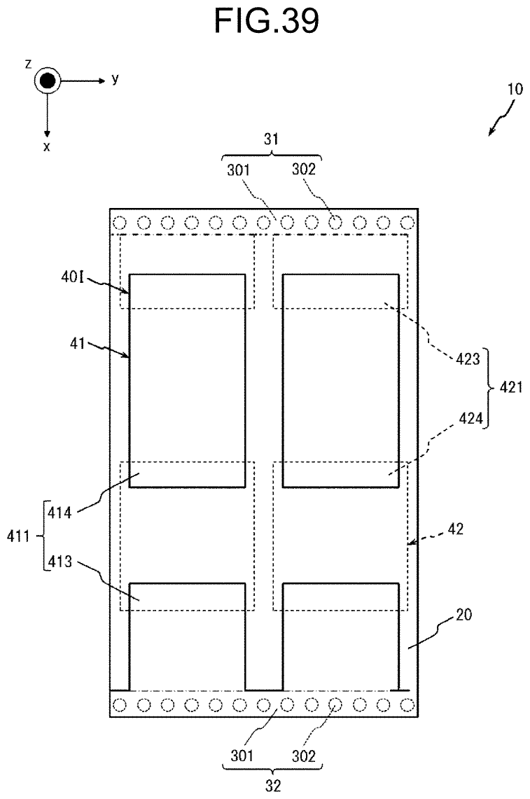

FIG. 39 illustrates another example of the resonator 10. FIG. 39 illustrates another example of the resonator 10 illustrated in FIG. 37. In the plurality of embodiments, in the resonator 10, a plurality of first unit conductors 411 and second unit conductors 421 arranged in the x-direction are capacitively coupled. In the resonator 10, two current paths 401 can be arranged in y-directions in which no current flows from one side to the other side.

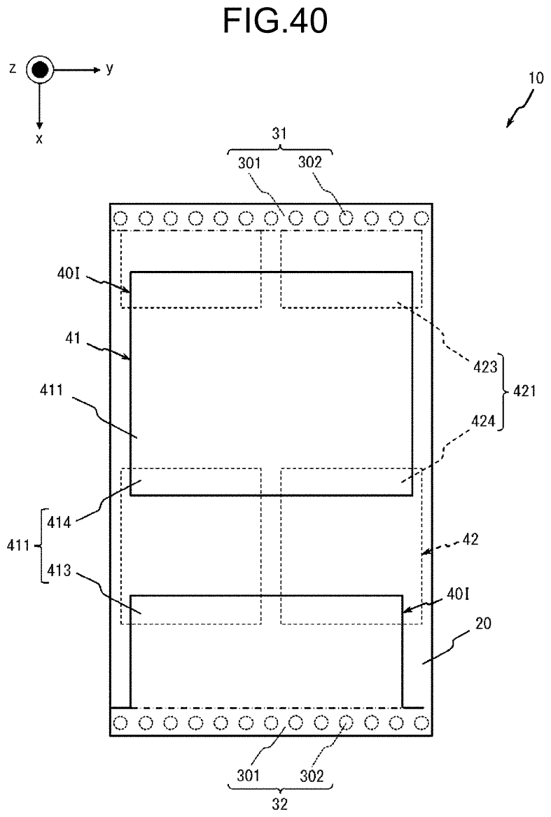

FIG. 40 illustrates another example of the resonator 10. FIG. 40 illustrates another example of the resonator 10 illustrated in FIG. 39. In the plurality of embodiments, the resonator 10 can be configured such that the number of conductive members connected to the first conductor 31 and the number of conductive members connected to the second conductor 32 are different in number. In the resonator 10 of FIG. 40, one first connecting conductor 413 is capacitively coupled to two second floating conductors 424. In the resonator 10 of FIG. 40, the two second connecting conductors 423 are capacitively coupled to one first floating conductor 414. In the plurality of embodiments, the number of first unit conductors 411 can be different from the number of second unit conductors 421 capacitively coupled to the first unit conductors 411.

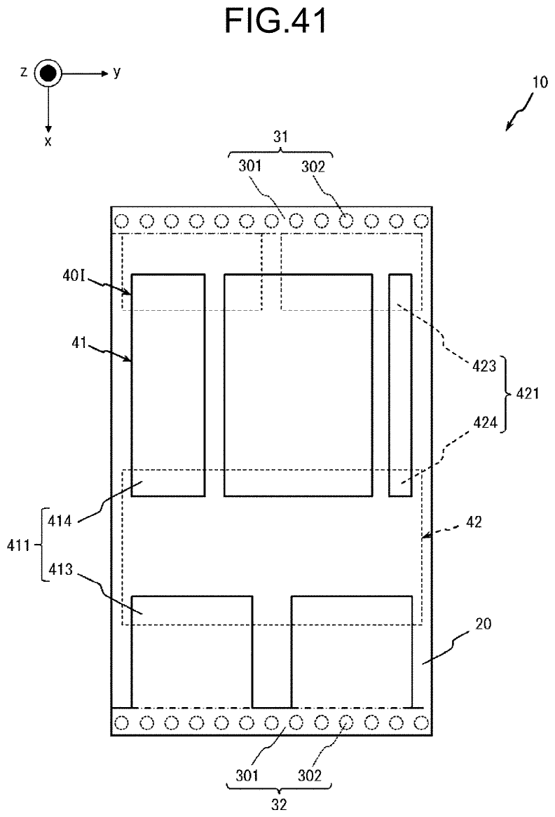

FIG. 41 illustrates another example of the resonator 10 illustrated in FIG. 39. In the plurality of embodiments, the first unit conductor 411 can be configured such that the number of second unit conductors 421 capacitively coupled at a first end in the x-direction and the number of second unit conductors 421 capacitively coupled at a second end in the x-direction are different. In the resonator 10 of FIG. 41, one second floating conductor 424 has a first end in the x-direction to which two first connecting conductors 413 are capacitively coupled and a second end to which three second floating conductors 424 are capacitively coupled. In the plurality of embodiments, a plurality of conductive members arranged in the y-direction can have different lengths in the y-direction. In the resonator 10 of FIG. 41, the three first floating conductors 414 arranged in the y-direction have different lengths in the y-direction.

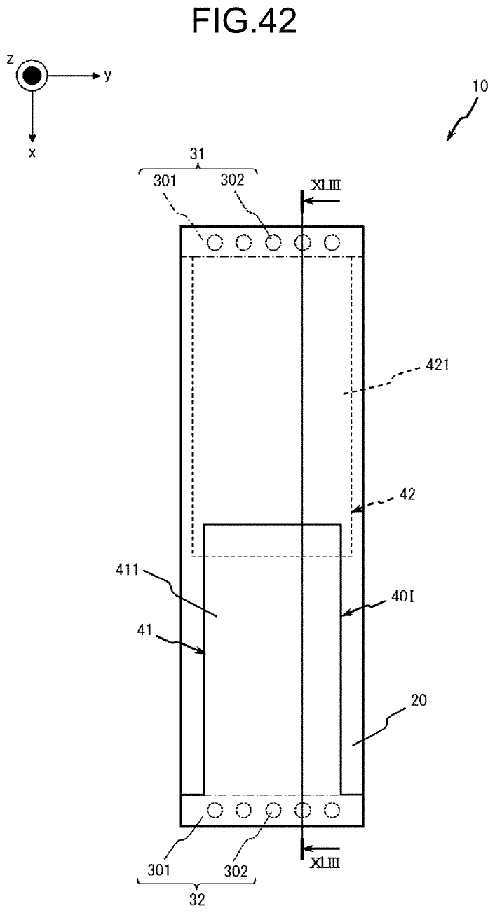

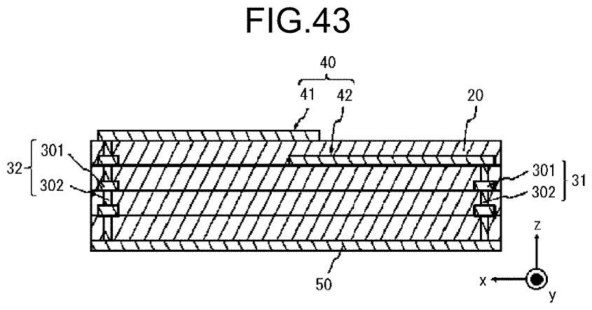

FIG. 42 illustrates another example of the resonator 10. FIG. 43 is a cross-sectional view taken along line XLIII-XLIII illustrated in FIG. 42. In the resonator 10 illustrated in FIGS. 42 and 43, the first conductive layer 41 includes half of a patch resonator as the first unit resonator 41X. The second conductive layer 42 includes half of a patch resonator as the second unit resonator 42X. The unit resonator 40X includes one first divisional resonator 41Y and one second divisional resonator 42Y. The unit structure 10X includes the unit resonator 40X, part of the base 20 that overlaps the unit resonator 40X in the z-direction, and part of the fourth conductor 50. In the resonator 10 illustrated in FIG. 42, one unit resonator 40X extends in the x-direction.

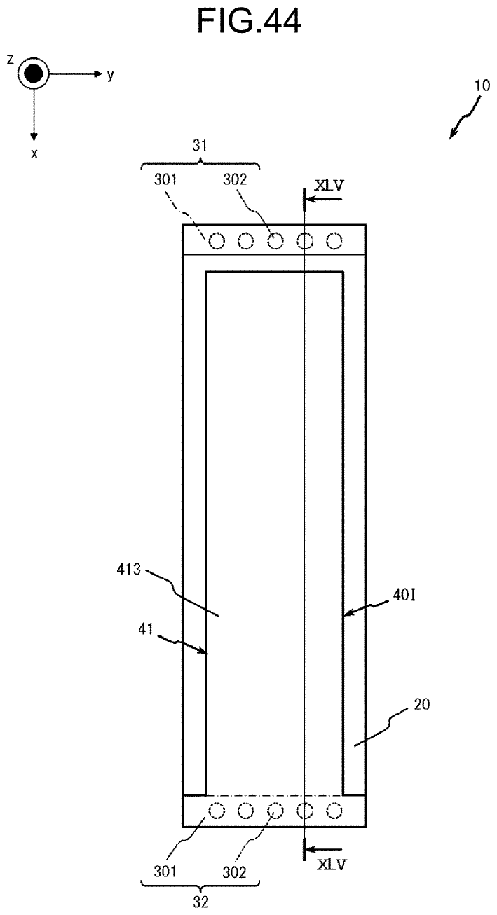

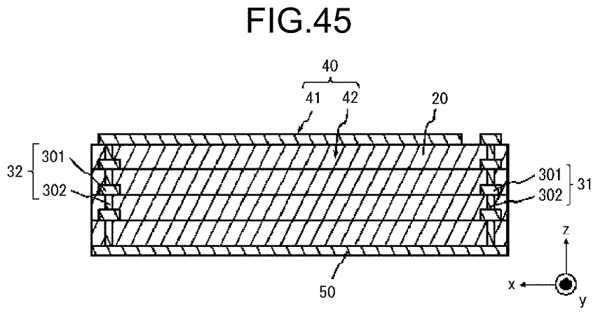

FIG. 44 illustrates another example of the resonator 10. FIG. 45 is a cross-sectional view taken along line XLV-XLV illustrated in FIG. 44 In the resonator 10 illustrated in FIGS. 44 and 45, the third conductor 40 includes only the first connecting conductor 413. The first connecting conductor 413 faces the first conductor 31 in the xy plane. The first connecting conductor 413 is capacitively coupled to the first conductor 31.

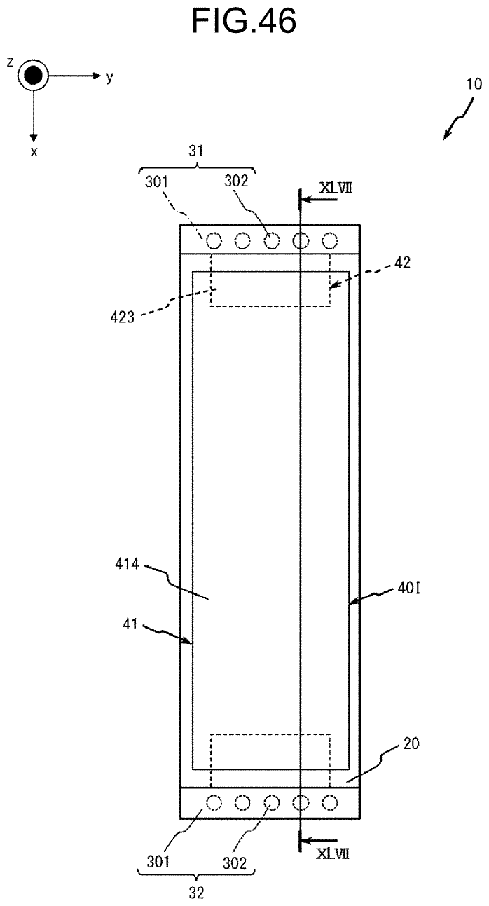

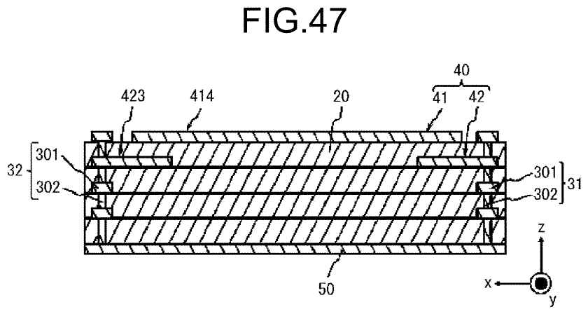

FIG. 46 illustrates another example of the resonator 10. FIG. 47 is a cross-sectional view taken along line XLVII-XLVII illustrated in FIG. 46. In the resonator 10 illustrated in FIGS. 46 and 47, the third conductor 40 includes the first conductive layer 41 and the second conductive layer 42. The first conductive layer 41 includes one first floating conductor 414. The second conductive layer 42 includes two second connecting conductors 423. The first conductive layer 41 faces the pair conductors 30 in the xy plane. The two second connecting conductors 423 overlap the one first floating conductor 414 in the z-direction. The one first floating conductor 414 is capacitively coupled to the two second connecting conductors 423.

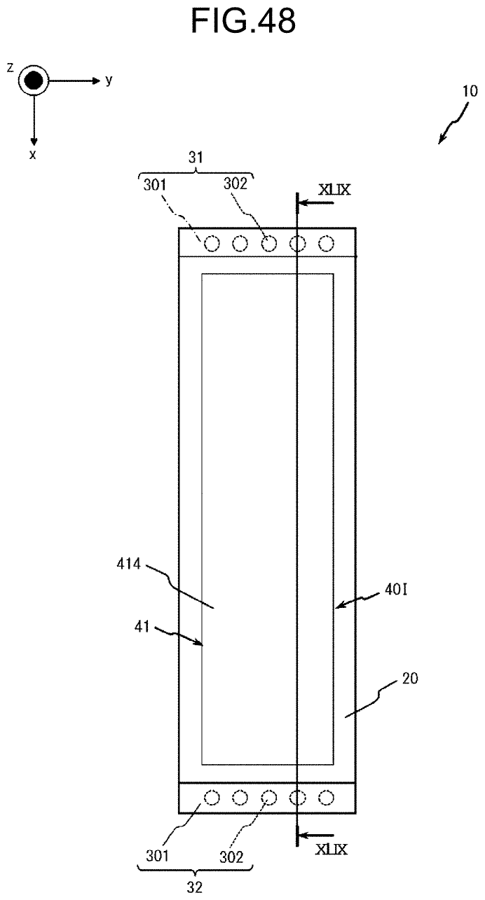

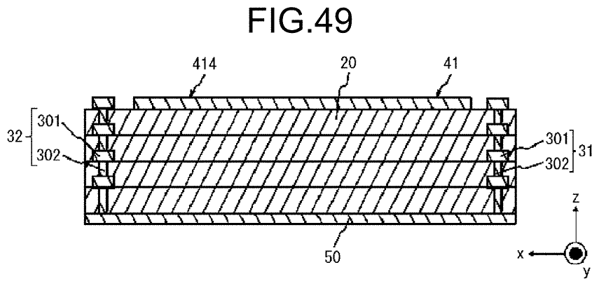

FIG. 48 illustrates another example of the resonator 10. FIG. 49 is a cross-sectional view taken along line XLIX-XLIX illustrated in FIG. 48. In the resonator 10 illustrated in FIGS. 48 and 49, the third conductor 40 includes only the first floating conductor 414. The first floating conductor 414 faces the pair conductors 30 in the xy plane. The first connecting conductor 413 is capacitively coupled to the pair conductors 30.

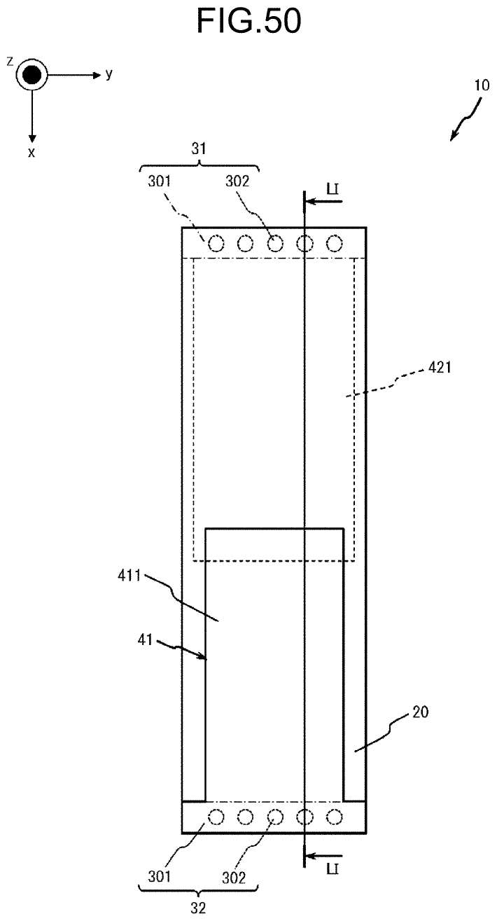

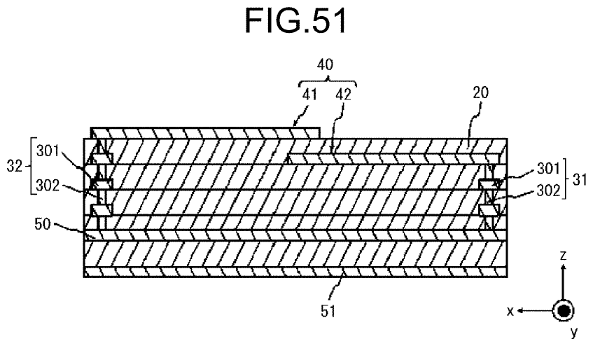

FIG. 50 illustrates another example of the resonator 10. FIG. 51 is a cross-sectional view taken along line LI-LI illustrated in FIG. 50. The resonator 10 illustrated in FIGS. 50 and 51 is different from the resonator 10 illustrated in FIGS. 42 and 43 in the configuration of the fourth conductor 50. The resonator 10 illustrated in FIGS. 50 and 51 includes the fourth conductor 50 and the reference potential layer 51. The reference potential layer 51 is electrically connected to the ground of a device including the resonator 10. The reference potential layer 51 faces the third conductor 40 via the fourth conductor 50. The fourth conductor 50 is located between the third conductor 40 and the reference potential layer 51. The distance between the reference potential layer 51 and the fourth conductor 50 is smaller than the distance between the third conductor 40 and the fourth conductor 50.

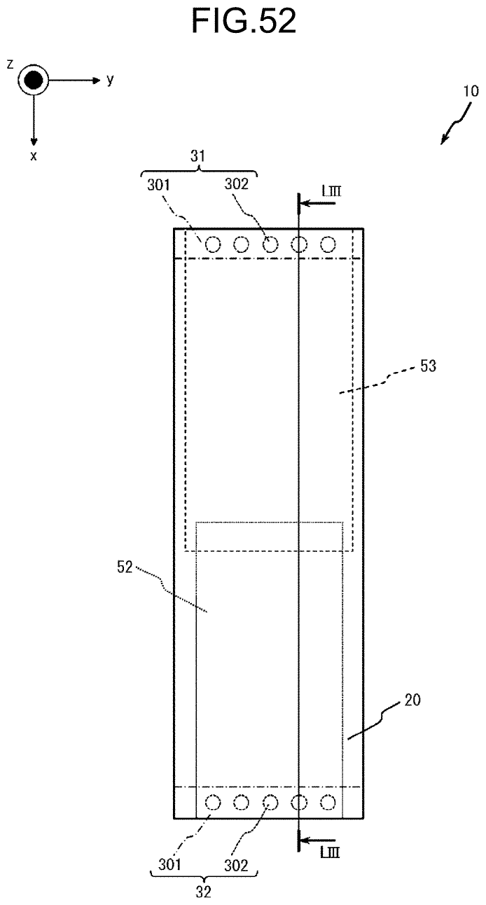

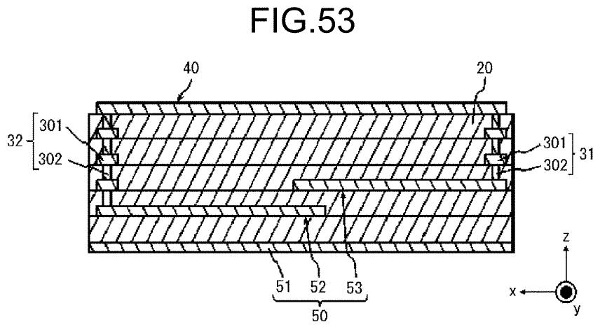

FIG. 52 illustrates another example of the resonator 10. FIG. 53 is a cross-sectional view taken along line LIII-LIII illustrated in FIG. 52. The resonator 10 includes the fourth conductor 50 and the reference potential layer 51. The reference potential layer 51 is electrically connected to the ground of a device including the resonator 10. The fourth conductor 50 includes a resonator. The fourth conductor 50 includes the third conductive layer 52 and the fourth conductive layer 53. The third conductive layer 52 and the fourth conductive layer 53 are capacitively coupled. The third conductive layer 52 and the fourth conductive layer 53 face each other in the z-direction. The distance between the third conductive layer 52 and the fourth conductive layer 53 is smaller than the distance between the fourth conductive layer 53 and the reference potential layer 51. The distance between the third conductive layer 52 and the fourth conductive layer 53 is shorter than the distance between the fourth conductor 50 and the reference potential layer 51. The third conductor 40 is formed into one conductive layer.

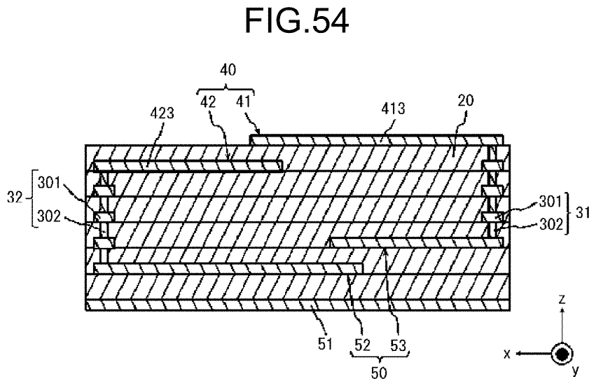

FIG. 54 illustrates another example of the resonator 10 illustrated in FIG. 53. The resonator 10 includes the third conductor 40, the fourth conductor 50, and the reference potential layer 51. The third conductor 40 includes the first conductive layer 41 and the second conductive layer 42. The first conductive layer 41 includes the first connecting conductor 413. The second conductive layer 42 includes the second connecting conductor 423. The first connecting conductor 413 is capacitively coupled to the second connecting conductor 423. The reference potential layer 51 is electrically connected to the ground of a device including the resonator 10. The fourth conductor 50 includes the third conductive layer 52 and the fourth conductive layer 53. The third conductive layer 52 and the fourth conductive layer 53 are capacitively coupled. The third conductive layer 52 and the fourth conductive layer 53 face each other in the z-direction. The distance between the third conductive layer 52 and the fourth conductive layer 53 is smaller than the distance between the fourth conductive layer 53 and the reference potential layer 51. The distance between the third conductive layer 52 and the fourth conductive layer 53 is shorter than the distance between the fourth conductor 50 and the reference potential layer 51.

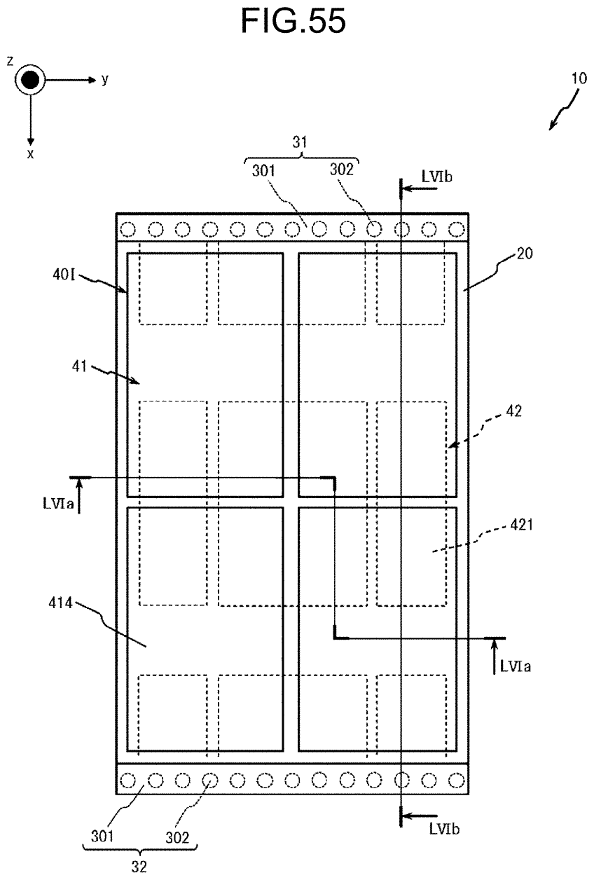

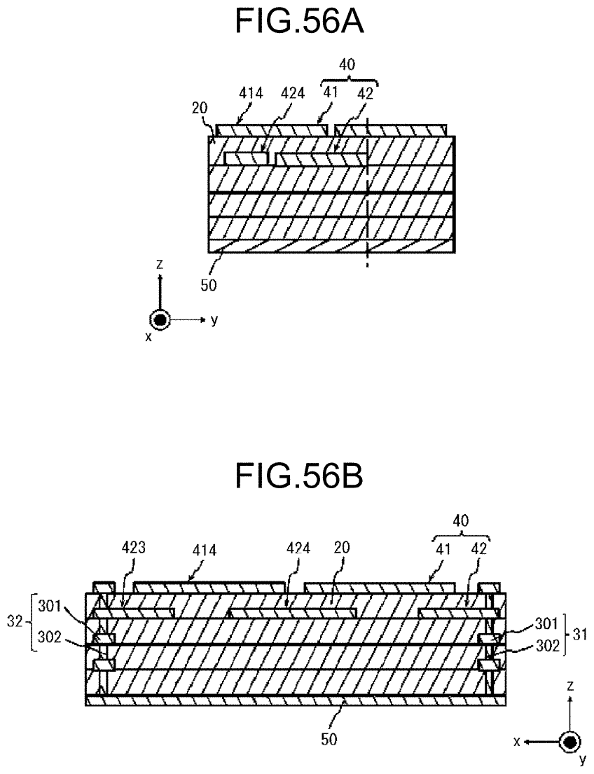

FIG. 55 illustrates another example of the resonator 10. FIG. 56A is a cross-sectional view taken along line LVIa-LVIa illustrated in FIG. 55. FIG. 56B is a cross-sectional view taken along line LVIb-LVIb illustrated in FIG. 55. In the resonator 10 illustrated in FIG. 55, the first conductive layer 41 includes four first floating conductors 414. The first conductive layer 41 illustrated in FIG. 55 does not include the first connecting conductor 413. In the resonator 10 illustrated in FIG. 55, the second conductive layer 42 includes six second connecting conductors 423 and three second floating conductors 424. Two of the second connecting conductors 423 are each capacitively coupled to two of the first floating conductors 414. One of the second floating conductors 424 is capacitively coupled to four first floating conductors 414. Two of the second floating conductors 424 are capacitively coupled to two first floating conductors 414.

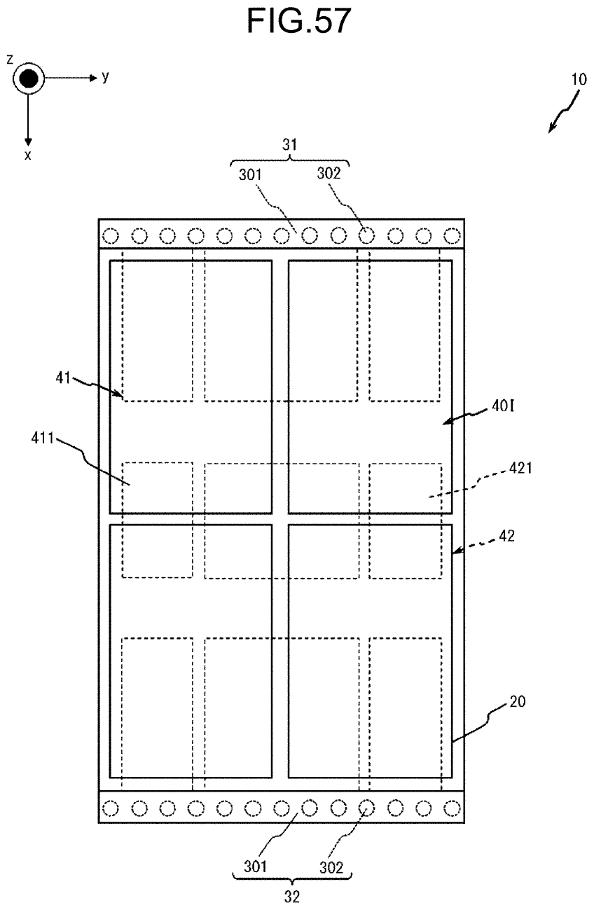

FIG. 57 is a diagram illustrating another example of the resonator illustrated in FIG. 55. The resonator 10 of FIG. 57 is different from the resonator 10 illustrated in FIG. 55 in the size of the second conductive layer 42. In the resonator 10 illustrated in FIG. 57, the length of each second floating conductor 424 in the x-direction is smaller than the length of each second connecting conductor 423 in the x-direction.

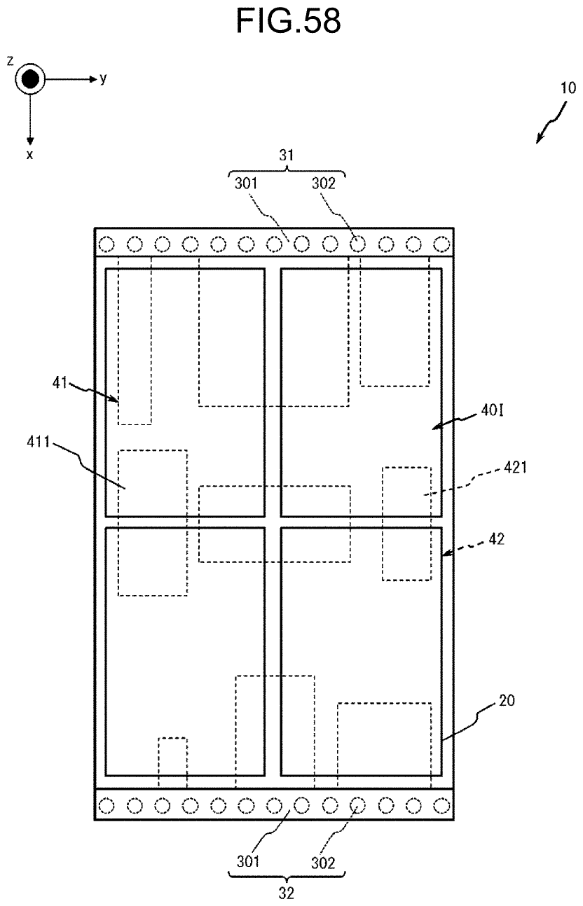

FIG. 58 is a diagram illustrating another example of the resonator illustrated in FIG. 55. The resonator 10 of FIG. 58 is different from the resonator 10 illustrated in FIG. 55 in the size of the second conductive layer 42. In the resonator 10 illustrated in FIG. 58, the plurality of second unit conductors 421 has different first areas. In the resonator 10 illustrated in FIG. 58, the plurality of second unit conductors 421 has different lengths in x-directions. In the resonator 10 illustrated in FIG. 58, the plurality of second unit conductors 421 has different lengths in y-directions. In FIG. 58, the plurality of second unit conductors 421 has, but is not limited to, different first areas, lengths, and widths. In FIG. 58, the plurality of second unit conductors 421 can be different from each other in part of first area, length, and width. The plurality of second unit conductors 421 can match each other in part or all of first area, length, and width. The plurality of second unit conductors 421 can be different from each other in part or all of first area, length, and width. The plurality of second unit conductors 421 can match each other in part or all of first area, length, and width. Part of the plurality of second unit conductors 421 can match each other in part or all of first area, length, and width.

In the resonator 10 illustrated in FIG. 58, the plurality of second connecting conductors 423 arranged in the y-direction has different first areas. In the resonator 10 illustrated in FIG. 58, the plurality of second connecting conductors 423 arranged in the y-direction has different lengths in x-directions. In the resonator 10 illustrated in FIG. 58, the plurality of second connecting conductors 423 arranged in the y-direction has different lengths in the y-direction. In FIG. 58, the plurality of second connecting conductors 423 has, but is not limited to, different first areas, lengths, and widths. In FIG. 58, the plurality of second connecting conductors 423 can be different from each other in part of first area, length, and width. The plurality of second connecting conductors 423 can match each other in part or all of first area, length, and width. The plurality of second connecting conductors 423 can be different from each other in part or all of first area, length, and width. The plurality of second connecting conductors 423 can match each other in part or all of first area, length, and width. Part of the plurality of second connecting conductors 423 can match each other in part or all of first area, length, and width.

In the resonator 10 illustrated in FIG. 58, a plurality of second floating conductors 424 arranged in the y-direction has different first areas. In the resonator 10 illustrated in FIG. 58, the plurality of second floating conductors 424 arranged in the y-direction has different lengths in x-directions. In the resonator 10 illustrated in FIG. 58, the plurality of second floating conductors 424 arranged in the y-direction has different lengths in the y-direction. In FIG. 58, the plurality of second floating conductors 424 has, but is not limited to, different first areas, lengths, and widths. In FIG. 58, the plurality of second floating conductors 424 can be different from each other in part of first area, length, and width. The plurality of second floating conductors 424 can match each other in part or all of first area, length, and width. The plurality of second floating conductors 424 can be different from each other in part or all of first area, length, and width. The plurality of second floating conductors 424 can match each other in part or all of first area, length, and width. Part of the plurality of second floating conductors 424 can match each other in part or all of first area, length, and width.

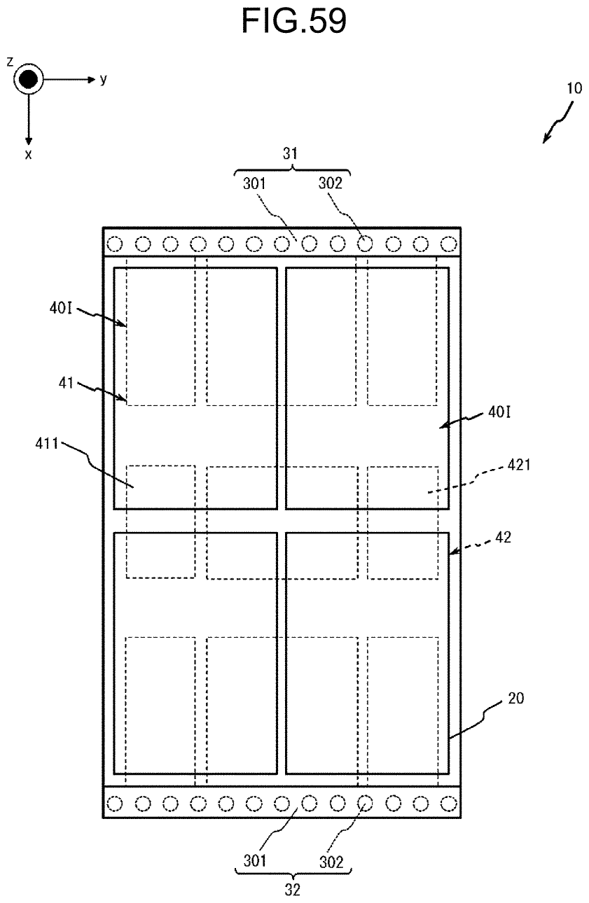

FIG. 59 is a diagram illustrating another example of the resonator 10 illustrated in FIG. 57. The resonator 10 of FIG. 59 is different from the resonator 10 illustrated in FIG. 57 in distance between first unit conductors 411 in the y-direction. In the resonator 10 of FIG. 59, a distance between first unit conductors 411 in the y-direction is smaller than a distance between first unit conductors 411 in the x-direction. In the resonator 10, since the pair conductors 30 can function as the electric walls, current flows in the x-direction. In the resonator 10, current flowing through the third conductor 40 in the y-direction can be ignored. The distance between the first unit conductors 411 in the y-direction can be reduced relative to the distance between the first unit conductors 411 in the x-direction. The distance between the first unit conductors 411 in the y-direction can be reduced to increase the areas of the first unit conductors 411.

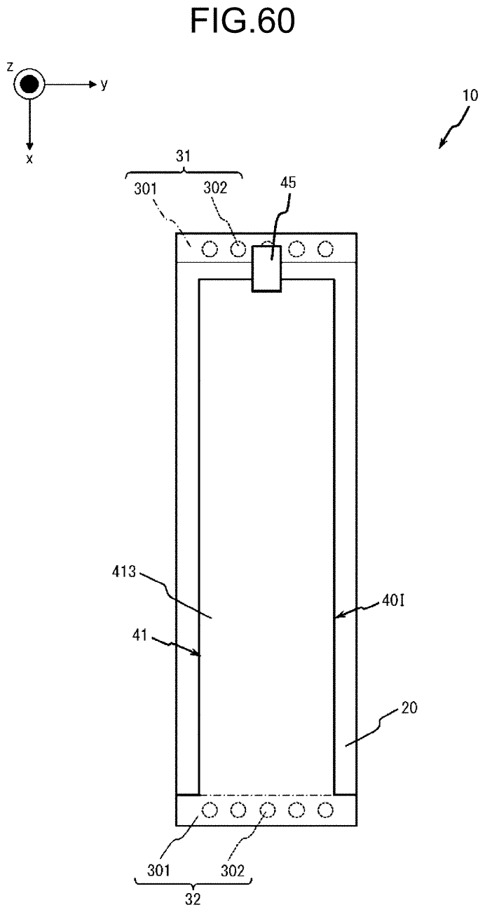

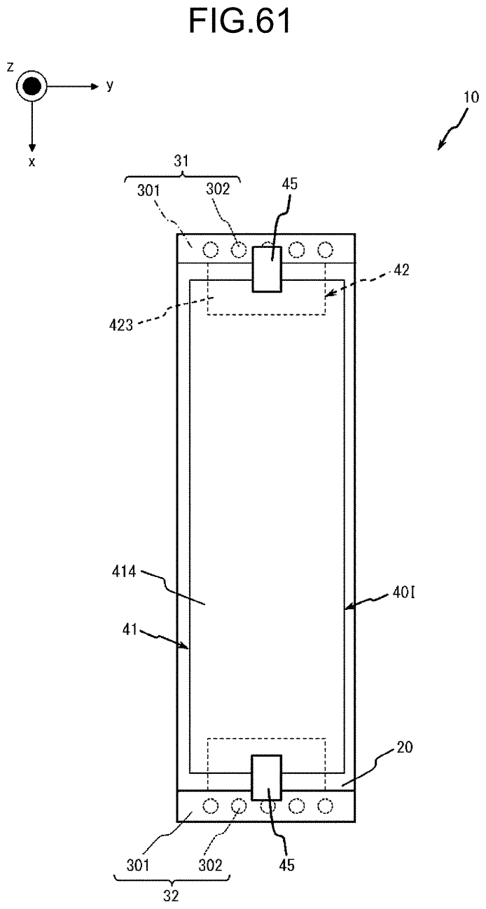

FIGS. 60 to 62 are diagrams illustrating other examples of the resonators 10. These resonators 10 have the impedance element 45. A unit conductor to which the impedance element 45 is connected is not limited to the examples illustrated in FIGS. 60 to 62. Part of the impedance elements 45 illustrated in FIGS. 60 to 62 can be omitted. The impedance element 45 can have capacitance characteristics. The impedance element 45 can have inductance characteristics. The impedance element 45 can be a mechanical or electrical variable element. The impedance element 45 can connect two different conductors located in one layer.

An antenna has at least one of a function of radiating electromagnetic waves and a function of receiving electromagnetic waves. An antenna according to the present disclosure includes, but is not limited to, a first antenna 60 and a second antenna 70.

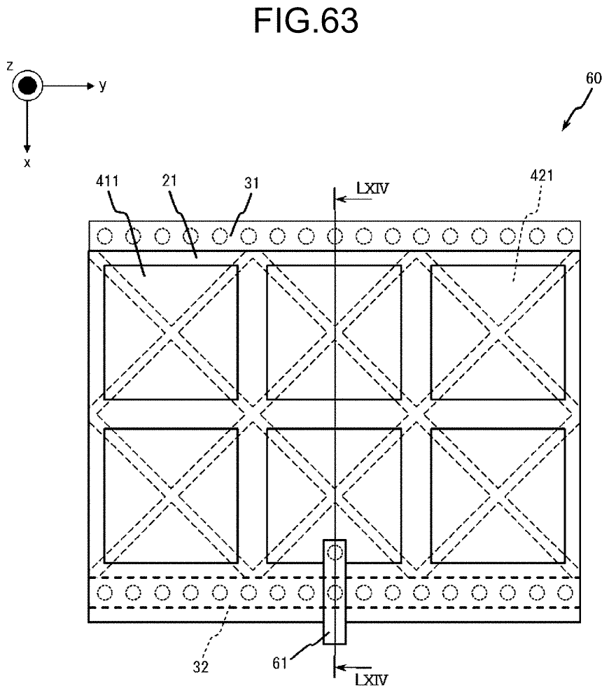

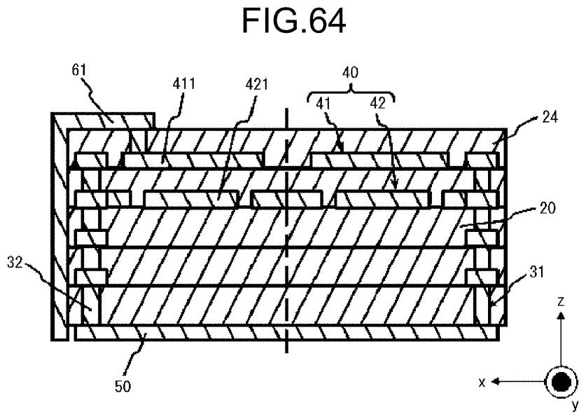

The first antenna 60 includes the base 20, the pair conductors 30, the third conductor 40, the fourth conductor 50, and a first feeding line 61. In an example, the first antenna 60 includes a third base 24 on the base 20. The third base 24 can have a different composition from the composition of the base 20. The third base 24 can be located above the third conductor 40. FIGS. 63 to 76 are diagrams each illustrating the first antenna 60 as an example of the plurality of embodiments.

The first feeding line 61 supplies power to at least one of resonators arranged periodically as artificial magnetic walls. In a case where power is fed to a plurality of resonators, the first antenna 60 can include a plurality of first feeding lines. The first feeding line 61 can be electromagnetically connected to any of the resonators arranged periodically as the artificial magnetic walls. The first feeding line 61 can be electromagnetically connected to any of a pair of conductors that appear as electric walls from the resonators arranged periodically as the artificial magnetic walls.

The first feeding line 61 supplies power to at least one of the first conductor 31, the second conductor 32, and the third conductor 40. In a case where power is fed to a plurality of portions of the first conductor 31, second conductor 32, and third conductor 40, the first antenna 60 can include a plurality of first feeding lines. The first feeding line 61 can be electromagnetically connected to any of the first conductor 31, second conductor 32, and third conductor 40. In a case where the first antenna 60 includes the reference potential layer 51 in addition to the fourth conductor 50, the first feeding line 61 can be electromagnetically connected to any of the first conductor 31, second conductor 32, third conductor 40, and fourth conductor 50. The first feeding line 61 is electrically connected to any of the fifth conductive layer 301 or the fifth conductor 302 of the pair conductors 30. The first feeding line 61 can be partially integrated with the fifth conductive layer 301.

The first feeding line 61 can be electromagnetically connected to the third conductor 40. For example, the first feeding line 61 is electromagnetically connected to one of first unit resonators 41X. For example, the first feeding line 61 is electromagnetically connected to one of second unit resonators 42X. The first feeding line 61 is electromagnetically connected to a unit conductor of the third conductor 40 at a point different from the center in the x-direction. In an embodiment, the first feeding line 61 supplies power to at least one resonator included in the third conductor 40. In an embodiment, the first feeding line 61 supplies power from at least one resonator included in the third conductor 40 to the outside. At least part of the first feeding line 61 can be located within the base 20. The first feeding line 61 can be exposed to the outside from any of two zx surfaces, two yz surfaces, and two xy surfaces of the base 20.

The first feeding line 61 can make contact with the third conductor 40 in a forward direction and reverse direction of the z-direction. The fourth conductor 50 can be omitted around the first feeding line 61. The first feeding line 61 can be electromagnetically connected to the third conductor 40 through the opening of the fourth conductor 50. The first conductive layer 41 can be omitted around the first feeding line 61. The first feeding line 61 can be connected to the second conductive layer 42 through the opening of the first conductive layer 41. The first feeding line 61 can make contact with the third conductor 40 along the xy plane. The pair conductors 30 can be omitted around the first feeding line 61. The first feeding line 61 can be connected to the third conductor 40 through the openings of the pair conductors 30. The first feeding line 61 is connected to a unit conductor of the third conductor 40, apart from the center of the unit conductor.

FIG. 63 is a plan view of the first antenna 60 in the xy plane, as viewed in the z-direction. FIG. 64 is a cross-sectional view taken along line LXIV-LXIV illustrated in FIG. 63. The first antenna 60 illustrated in FIGS. 63 and 64 includes the third base 24 above the third conductor 40. The third base 24 has an opening above the first conductive layer 41. The first feeding line 61 is electrically connected to the first conductive layer 41 via the opening of the third base 24.

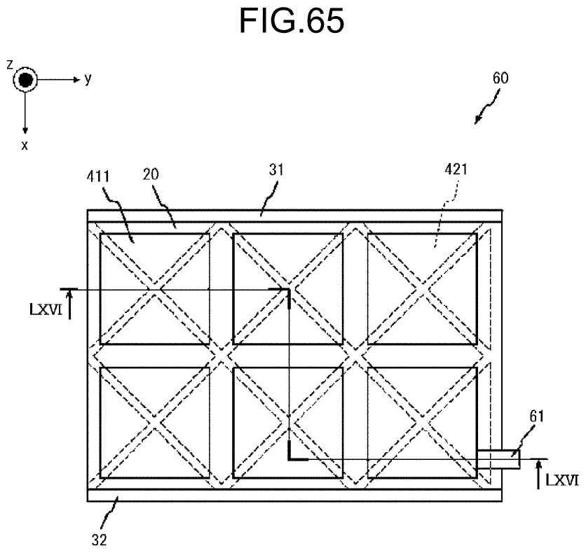

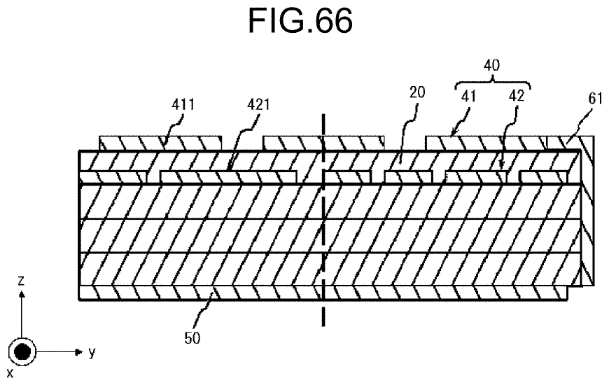

FIG. 65 is a plan view of the first antenna 60 in the xy plane, as viewed in the z-direction. FIG. 66 is a cross-sectional view taken along line LXVI-LXVI illustrated in FIG. 65. In the first antenna 60 illustrated in FIGS. 65 and 66, the first feeding line 61 is partially located on the base 20. The first feeding line 61 can be connected to the third conductor 40 in the xy plane. The first feeding line 61 can be connected to the first conductive layer 41 in the xy plane. In an embodiment, the first feeding line 61 can be connected to the second conductive layer 42 in the xy plane.

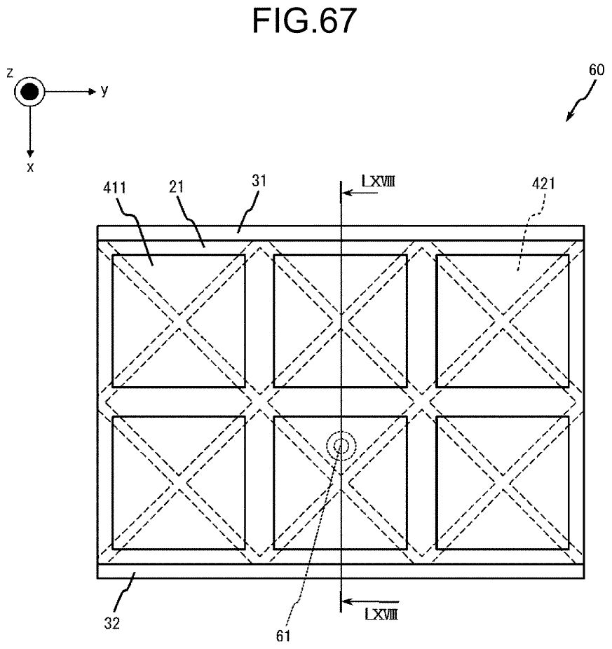

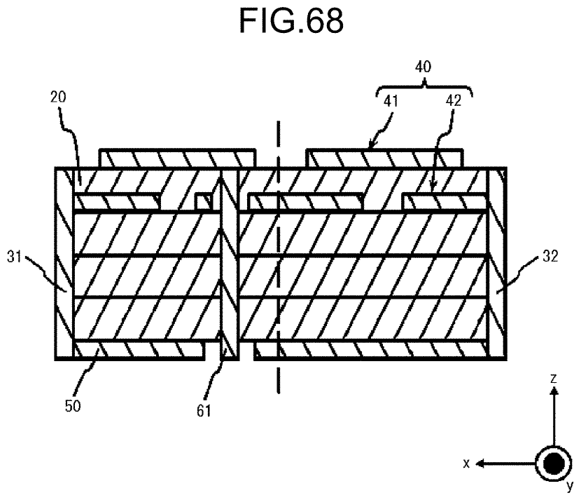

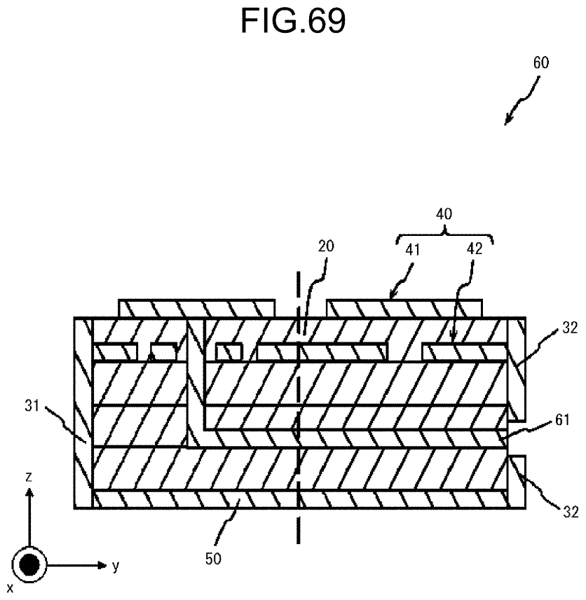

FIG. 67 is a plan view of the first antenna 60 in the xy plane, as viewed in the z-direction. FIG. 68 is a cross-sectional view taken along line LXVIII-LXVIII illustrated in FIG. 67. In the first antenna 60 illustrated in FIGS. 67 and 68, the first feeding line 61 is located within the base 20. The first feeding line 61 can be connected to the third conductor 40 in a reverse direction of the z-direction. The fourth conductor 50 can have an opening. The fourth conductor 50 can have an opening at a position where the fourth conductor 50 overlaps the third conductor 40 in the z-direction. The first feeding line 61 can be exposed to the outside of the base 20 through the opening.

FIG. 69 is a cross-sectional view of the first antenna 60 as viewed in the yz plane in the x-direction. The pair conductors 30 can have an opening. The first feeding line 61 can be exposed to the outside of the base 20 through the opening.

An electromagnetic wave radiated by the first antenna 60 has a polarization component in the x-direction that is larger than that in the y-direction, in the first plane. The polarization component in the x-direction has less attenuation than a horizontal polarization component when a metal plate approaches the fourth conductor 50 in the z-direction. The first antenna 60 can maintain radiation efficiency when a metal plate approaches from outside.

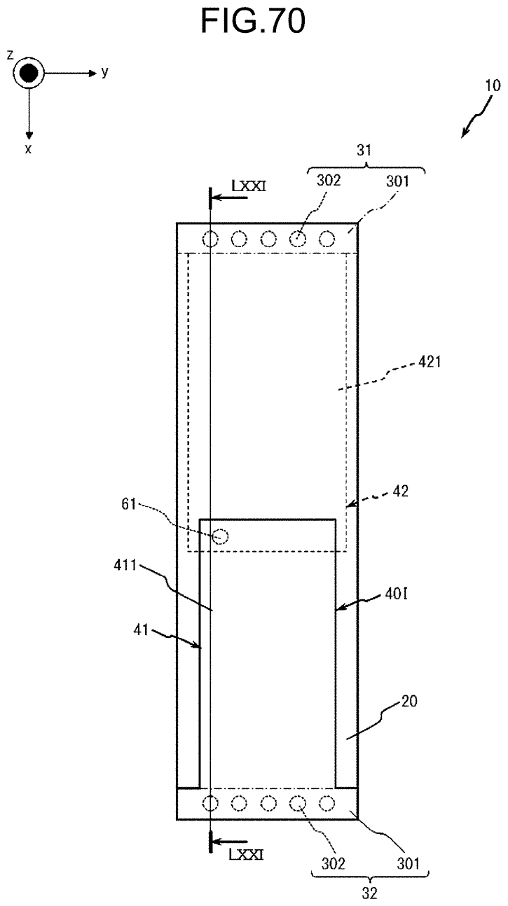

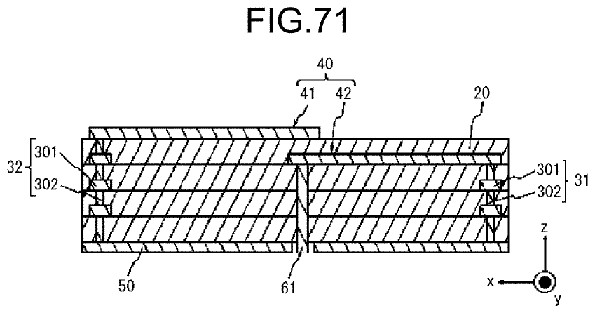

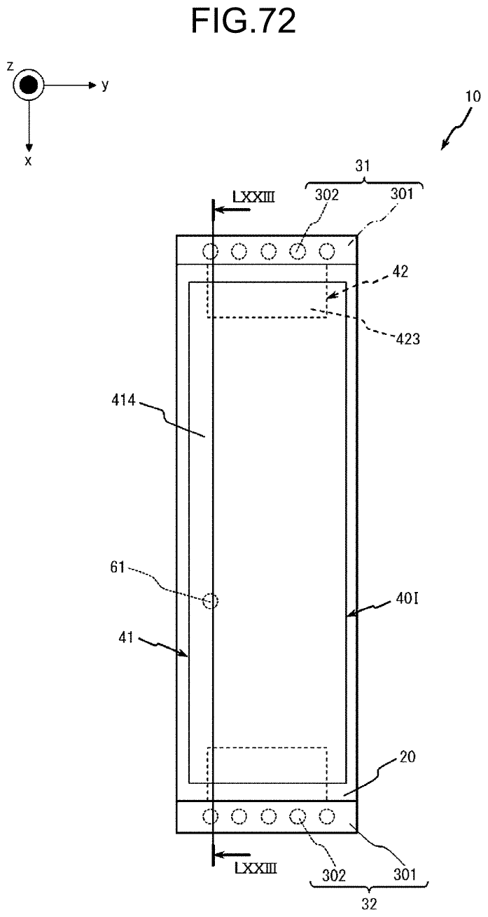

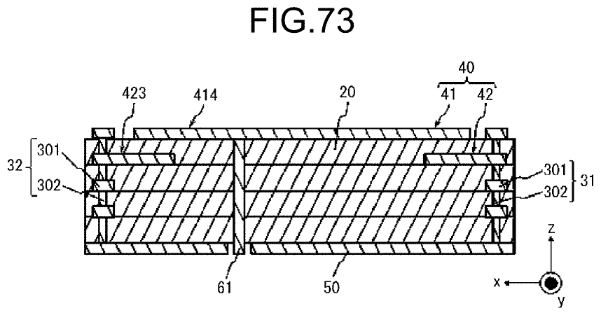

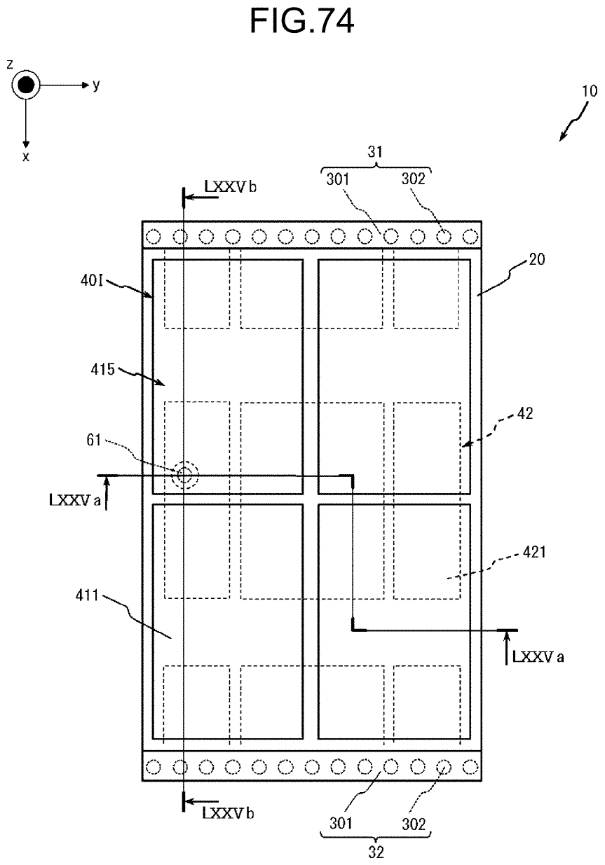

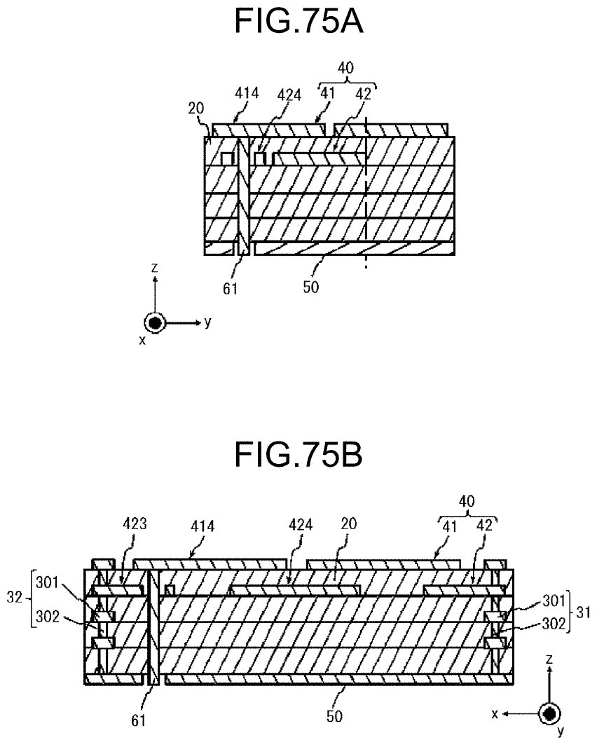

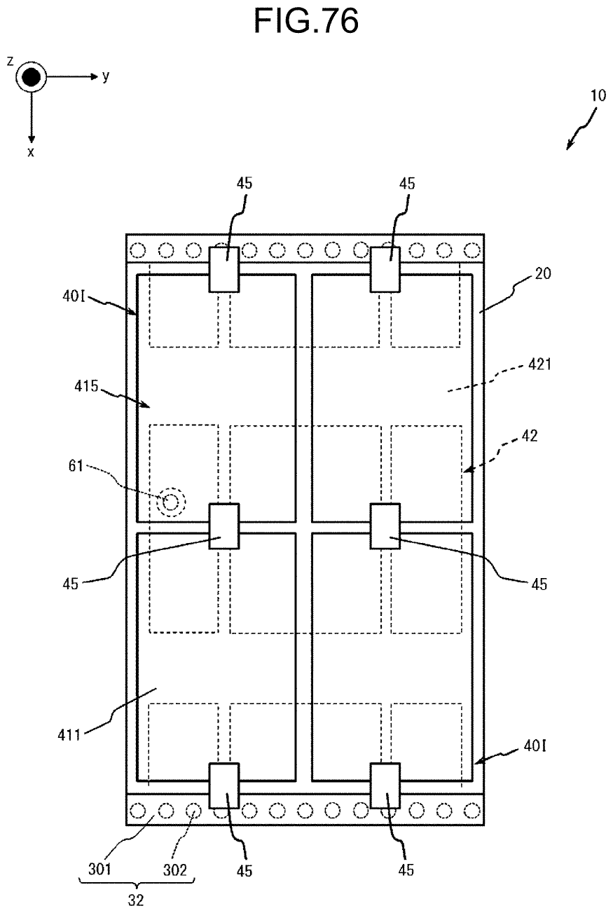

FIG. 70 illustrates another example of the first antenna 60. FIG. 71 is a cross-sectional view taken along line LXXI-LXXI illustrated in FIG. 70. FIG. 72 illustrates another example of the first antenna 60. FIG. 73 is a cross-sectional view taken along line LXXIII-LXXIII illustrated in FIG. 72. FIG. 74 illustrates another example of the first antenna 60. FIG. 75A is a cross-sectional view taken along line LXXVa-LXXVa illustrated in FIG. 74. FIG. 75B is a cross-sectional view taken along line LXXVb-LXXVb illustrated in FIG. 74. FIG. 76 illustrates another example of the first antenna 60. The first antenna 60 illustrated in FIG. 76 has an impedance element 45.

The operating frequency of the first antenna 60 can be changed by the impedance element 45. The first antenna 60 includes a first feeding conductor 415 that is connected to the first feeding line 61 and the first unit conductor 411 that is not connected to the first feeding line 61. Impedance matching changes when the impedance element 45 is connected to the first feeding conductor 415 and another conductive member. In the first antenna 60, the impedance matching can be adjusted by connecting the first feeding conductor 415 and another conductive member by the impedance element 45. In the first antenna 60, the impedance element 45 can be inserted between the first feeding conductor 415 and the other conductive member to adjust the impedance matching. In the first antenna 60, the impedance element 45 can be inserted between two first unit conductors 411 that are not connected to the first feeding line 61 to adjust the operating frequency. In the first antenna 60, the impedance element 45 can be inserted between the first unit conductor 411 that is not connected to the first feeding line 61 and any of the pair conductors 30 to adjust the operating frequency.

The second antenna 70 includes the base 20, the pair conductors 30, the third conductor 40, the fourth conductor 50, a second feeding layer 71, and a second feeding line 72. In an example, the third conductor 40 is located within the base 20. In an example, the second antenna 70 includes the third base 24 above the base 20. The third base 24 can have a different composition from the composition of the base 20. The third base 24 can be located above the third conductor 40. The third base 24 can be located above the second feeding layer 71.

The second feeding layer 71 is spaced above the third conductor 40. The base 20 or the third base 24 can be located between the second feeding layer 71 and the third conductor 40. The second feeding layer 71 includes a line resonator, patch resonator, and slot resonator. The second feeding layer 71 can be referred to as an antenna element. In an example, the second feeding layer 71 can be electromagnetically coupled to the third conductor 40. The second feeding layer 71 has a resonant frequency that changes from a single resonant frequency due to the electromagnetic coupling to the third conductor 40. In an example, the second feeding layer 71 receives power transmitted from the second feeding line 72 and resonates with the third conductor 40. In an example, the second feeding layer 71 receives power transmitted from the second feeding line 72 and resonates with the third conductor 40 and the third conductor.

The second feeding line 72 is electrically connected to the second feeding layer 71. In an embodiment, the second feeding line 72 transmits power to the second feeding layer 71. In an embodiment, the second feeding line 72 transmits power from the second feeding layer 71 to the outside.

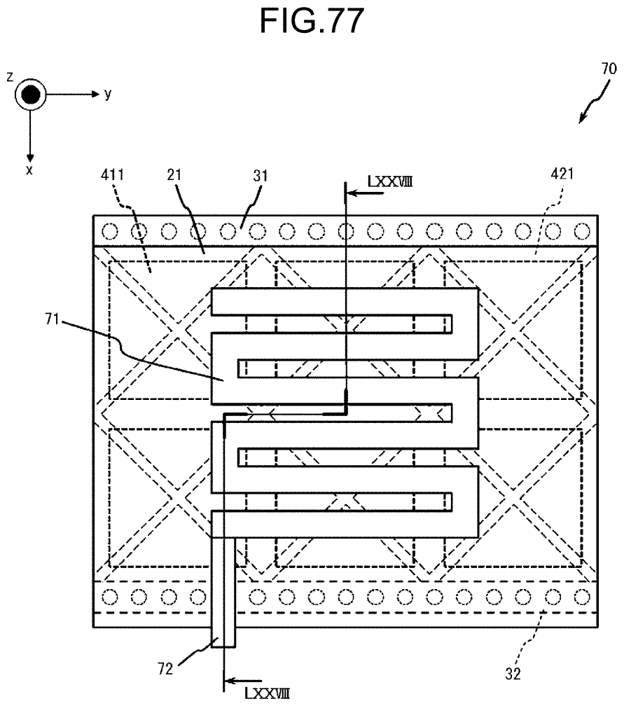

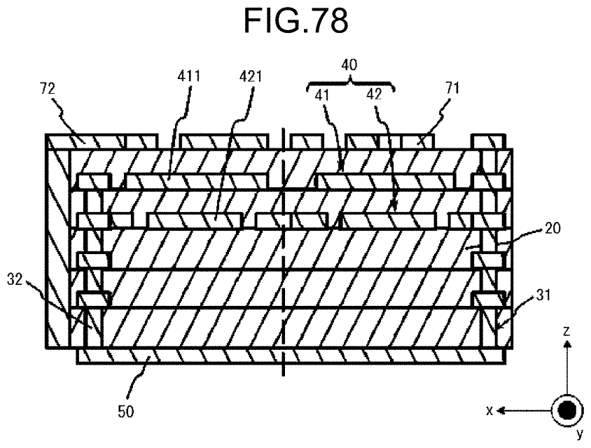

FIG. 77 is a plan view of the second antenna 70 in the xy plane, as viewed in the z-direction. FIG. 78 is a cross-sectional view taken along line LXXVIII-LXXVIII illustrated in FIG. 77. In the second antenna 70 illustrated in FIGS. 77 and 78, the third conductor 40 is located within the base 20. The second feeding layer 71 is located above the base 20. The second feeding layer 71 is located so as to overlap a unit structure 10X in the z-direction. The second feeding line 72 is located on the base 20. The second feeding line 72 is electromagnetically connected to the second feeding layer 71 in the xy plane.

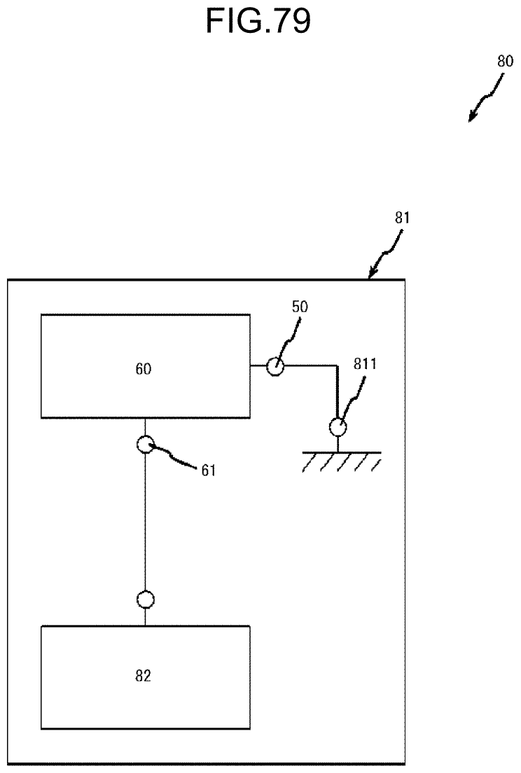

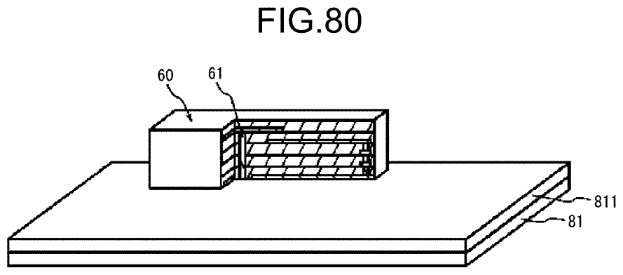

A wireless communication module according to the present disclosure includes a wireless communication module 80 as an example of the plurality of embodiments. FIG. 79 is a block structural diagram of the wireless communication module 80. FIG. 80 is a schematic configuration diagram of the wireless communication module 80. The wireless communication module 80 includes the first antenna 60, a circuit board 81, and an RF module 82. The wireless communication module 80 can include the second antenna 70 instead of the first antenna 60.

The first antenna 60 is located on the circuit board 81. The first antenna 60 includes the first feeding line 61 that is electromagnetically connected to the RF module 82 via the circuit board 81. The first antenna 60 includes the fourth conductor 50 that is electromagnetically connected to a ground conductor 811 of the circuit board 81.

The ground conductor 811 can extend in the xy plane. The ground conductor 811 has a larger area than the fourth conductor 50, in the xy plane. The ground conductor 811 has a larger length than the fourth conductor 50, in the y-direction. The ground conductor 811 has a larger length than the fourth conductor 50, in the x-direction. The first antenna 60 can be located closer to an end side relative to the center of the ground conductor 811, in the y-direction. The center of the first antenna 60 may not coincide with the center of the ground conductor 811 in the xy plane. The center of the first antenna 60 may not coincide with the centers of a first conductive layer 41 and second conductive layer 42. A point at which the first feeding line 61 is connected to the third conductor 40 may not coincide with the center of the ground conductor 811 in the xy plane.

In the first antenna 60, first current and second current flow in a loop via the pair conductors 30. The first antenna 60 is located on the end side in the y-direction relative to the center of the ground conductor 811, and thus, the second current flowing through the ground conductor 811 becomes asymmetric. When the flow of the second current through the ground conductor 811 becomes asymmetric, the polarization component of a radiation wave in the x-direction is increased, in an antenna structure including the first antenna 60 and the ground conductor 811. The increased polarization component of the radiation wave in the x-direction can improve the total radiation efficiency of the radiation wave.

The RF module 82 can control power supplied to the first antenna 60. The RF module 82 modulates a baseband signal and supplies the baseband signal to the first antenna 60. The RF module 82 can modulate an electric signal received by the first antenna 60 into a baseband signal.

A change in the resonant frequency of the first antenna 60 is small due to a conductor of the circuit board 81 side. The first antenna 60 of the wireless communication module 80 can reduce the influence from an external environment.

The first antenna 60 can be integrated with the circuit board 81. When the first antenna 60 and the circuit board 81 are integrally configured, the fourth conductor 50 and the ground conductor 811 are integrally configured.

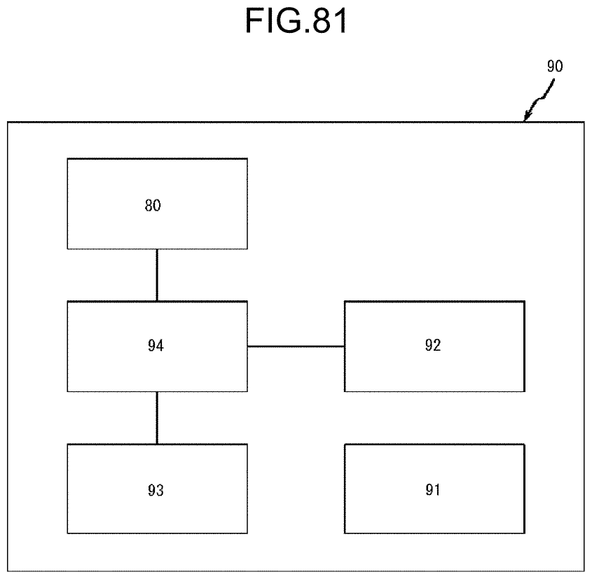

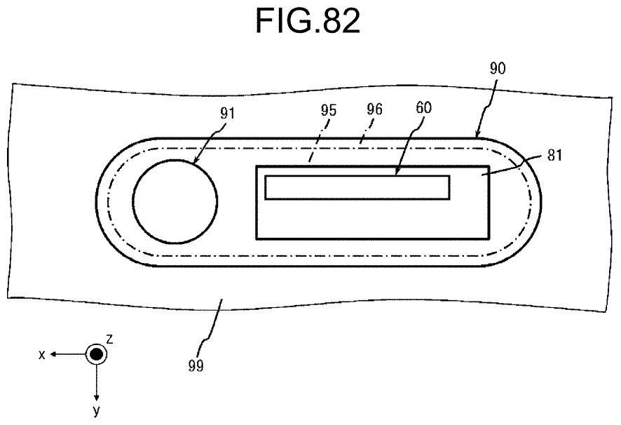

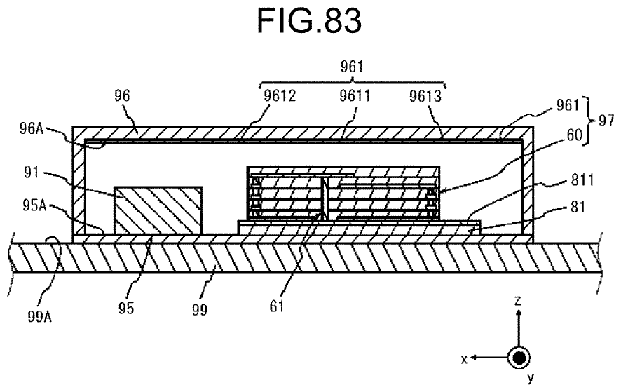

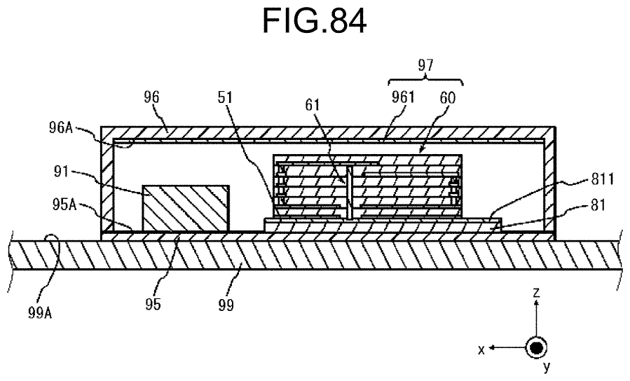

A wireless communication device according to the present disclosure includes a wireless communication device 90 as an example of the plurality of embodiments. FIG. 81 is a block structural diagram of the wireless communication device 90. FIG. 82 is a plan view of the wireless communication device 90. Part of the configuration of the wireless communication device 90 illustrated in FIG. 82 is omitted. FIG. 83 is a cross-sectional view of the wireless communication device 90. Part of the configuration of the wireless communication device 90 illustrated in FIG. 83 is omitted. The wireless communication device 90 includes the wireless communication module 80, a battery 91, a sensor 92, a memory 93, a controller 94, a first case 95, and a second case 96. The wireless communication module 80 of the wireless communication device 90 includes the first antenna 60 but can include the second antenna 70. FIG. 84 illustrates one of other embodiments of the wireless communication device 90. The first antenna 60 of the wireless communication device 90 can include the reference potential layer 51.

The battery 91 supplies power to the wireless communication module 80. The battery 91 can supply power to at least one of the sensor 92, memory 93, and controller 94. The battery 91 can include at least one of a primary battery and a secondary battery. A negative electrode of the battery 91 is electrically connected to a ground terminal of a circuit board 81. The negative electrode of the battery 91 is electrically connected to a fourth conductor 50 of the first antenna 60.

The sensor 92 may include, for example, a speed sensor, vibration sensor, acceleration sensor, gyro-sensor, rotation angle sensor, angular velocity sensor, geomagnetic sensor, magnet sensor, temperature sensor, humidity sensor, atmospheric pressure sensor, optical sensor, illuminance sensor, UV sensor, gas sensor, gas concentration sensor, atmosphere sensor, level sensor, odor sensor, pressure sensor, air pressure sensor, contact sensor, wind sensor, infrared sensor, human sensor, displacement sensor, image sensor, weight sensor, smoke sensor, leak sensor, vital sensor, battery remaining amount sensor, ultrasonic sensor, a global positioning system (GPS) signal receiving device, or the like.

The memory 93 can include, for example, a semiconductor memory or the like. The memory 93 can function as a work memory for the controller 94. The memory 93 can be included in the controller 94. The memory 93 stores a program in which processing contents for achieving each function of the wireless communication device 90 is described, information used for processing in the wireless communication device 90, and the like.

The controller 94 can include, for example, a processor. The controller 94 may include one or more processors. The processor may include a general-purpose processor that is used for loading a specific program to execute a specific function and a dedicated processor that is dedicated to specific processing. The dedicated processor may include an application specific IC. The application specific IC is also referred to as ASIC. The processor may include a programmable logic device. The programmable logic device is also referred to as PLD. The PLD may include a field-programmable gate array (FPGA). The controller 94 may include any of an SoC (System-on-a-Chip) and an SiP (System In a Package) that are configured such that one or more processors cooperating with each other. The controller 94 may store a variety of information, a program for operating each component module of the wireless communication device 90, or the like in the memory 93.

The controller 94 generates a transmission signal to be transmitted from the wireless communication device 90. The controller 94 may obtain measurement data, for example, from the sensor 92. The controller 94 may generate a transmission signal according to the measurement data. The controller 94 can transmit a baseband signal to the RF module 82 of the wireless communication module 80.

The first case 95 and the second case 96 protect other devices of the wireless communication device 90. The first case 95 can extend in the xy plane. The first case 95 supports other devices. The first case 95 can support the wireless communication module 80. The wireless communication module 80 is located on an upper surface 95A of the first case 95. The first case 95 can support the battery 91. The battery 91 is located on the upper surface 95A of the first case 95. In an example of the plurality of embodiments, the wireless communication module 80 and the battery 91 are arranged in the x-direction on the upper surface 95A of the first case 95. The first conductor 31 is located between the battery 91 and the third conductor 40. The battery 91 is located behind the pair conductors 30 when viewed from the third conductor 40.

The second case 96 can cover other devices. The second case 96 includes an under surface 96A located in the z-direction from the first antenna 60. The under surface 96A extends along the xy plane. The under surface 96A is not limited to a flat shape but can include irregularities. The second case 96 can have an eighth conductor 961. The eighth conductor 961 is located at least within, on the outer side, or on the inner side of the second case 96. The eighth conductor 961 is located at least on an upper surface or lateral side surface of the second case 96.

The eighth conductor 961 faces the first antenna 60. The eighth conductor 961 includes a first body 9611 that faces the first antenna 60 in the z-direction. The eighth conductor 961 can include, in addition to the first body 9611, at least one of a second body that faces the first antenna 60 in the x-direction and a third body that faces the first antenna in the y-direction. The eighth conductor 961 partially faces the battery 91.

The eighth conductor 961 can include a first extra-body 9612 that extends outward from the first conductor 31 in the x-direction. The eighth conductor 961 can include a second extra-body 9613 that extends outward from the second conductor 32 in the x-direction. The first extra-body 9612 can be electrically connected to the first body 9611. The second extra-body 9613 can be electrically connected to the first body 9611. The first extra-body 9612 of the eighth conductor 961 faces the battery 91 in the z-direction. The eighth conductor 961 can be capacitively coupled to the battery 91. The eighth conductor 961 can have capacitance between the eighth conductor 961 and the battery 91.

The eighth conductor 961 is separated from the third conductor 40 of the first antenna 60. The eighth conductor 961 is not electrically connected to each conductor of the first antenna 60. The eighth conductor 961 can be separated from the first antenna 60. The eighth conductor 961 can be electromagnetically coupled to any conductor of the first antenna 60. The first body 9611 of the eighth conductor 961 can be electromagnetically coupled to the first antenna 60. The first body 9611 can overlap the third conductor 40 in plan view in the z-direction. Since the first body 9611 overlaps the third conductor 40, propagation due to electromagnetic coupling can be increased. The eighth conductor 961 can have a mutual inductance, due to electromagnetic coupling with the third conductor 40.

The eighth conductor 961 extends in the x-direction. The eighth conductor 961 extends along the xy plane. The length of the eighth conductor 961 is larger than the length of the first antenna 60 in the x-direction. The length of the eighth conductor 961 in the x-direction is larger than the length of the first antenna 60 in the x-direction. The length of the eighth conductor 961 can be larger than that of ½ of the operating wavelength λ of the wireless communication device 90. The eighth conductor 961 can include a portion extending along the y-direction. The eighth conductor 961 can bend in the xy plane. The eighth conductor 961 can include a portion extending in the z-direction. The eighth conductor 961 can bend from the xy plane to the yz plane or the zx plane.

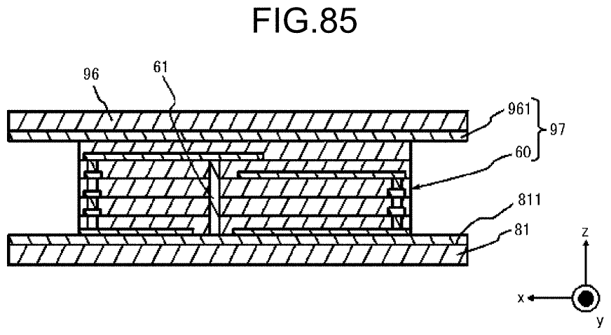

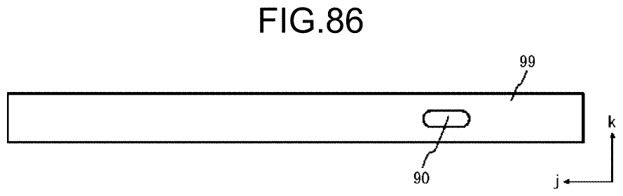

In the wireless communication device 90 including the eighth conductor 961, the first antenna 60 and the eighth conductor 961 can be electromagnetically coupled to function as a third antenna 97. The third antenna 97 may have an operating frequency f_{c} that is different from the resonant frequency of the first antenna 60 alone. The operating frequency f_{c} of the third antenna 97 may be closer to the resonant frequency of the first antenna 60 than the resonant frequency of the eighth conductor 961 alone. The operating frequency f_{c} of the third antenna 97 can be within the resonant frequency band of the first antenna 60. The operating frequency f_{c} of the third antenna 97 can be outside the resonant frequency band of the eighth conductor 961 alone. FIG. 85 illustrates another embodiment of the third antenna 97. The eighth conductor 961 can be configured integrally with the first antenna 60. In FIG. 85, part of the configuration of the wireless communication device 90 is omitted. In the example of FIG. 85, the second case 96 may not include the eighth conductor 961.

In the wireless communication device 90, the eighth conductor 961 is capacitively coupled to the third conductor 40. The eighth conductor 961 is electromagnetically coupled to the fourth conductor 50. The third antenna 97 includes the first extra-body 9612 and the second extra-body 9613 of the eighth conductor in the air, and thus, a gain is improved as compared with the first antenna 60.

The wireless communication device 90 can be located on various objects. The wireless communication device 90 can be located on an electrical conductive body 99. FIG. 86 is a plan view illustrating an embodiment of the wireless communication device 90. The electrical conductive body 99 is a conductor that transmits electricity. The material of the electrical conductive body 99 can include a metal, highly-doped semiconductor, conductive plastic, and liquid containing ions. The electrical conductive body 99 can include a non-conductive layer that does not transmit electricity on the surface. A portion that transmits electricity and the non-conductive layer can contain a common element. For example, the electrical conductive body 99 including aluminum can include the non-conductive layer of aluminum oxide on the surface. The portion that transmits electricity and the non-conductive layer can include different elements.

The shape of the electrical conductive body 99 is not limited to a flat plate shape but can include a three-dimensional shape such as a box shape. The three-dimensional shape of the electrical conductive body 99 includes a rectangular parallelepiped shape or a cylindrical shape. The three-dimensional shape can include a shape partially depressed, a shape partially penetrated, and a shape partially protruded. For example, the electrical conductive body 99 can be formed into a torus shape.

The electrical conductive body 99 includes an upper surface 99A on which the wireless communication device 90 can be placed. The upper surface 99A can extend over the entire surface of the electrical conductive body 99. The upper surface 99A can be part of the electrical conductive body 99. The upper surface 99A can have a larger area than the wireless communication device 90. The wireless communication device 90 can be placed on the upper surface 99A of the electrical conductive body 99. The upper surface 99A can have a smaller area than the wireless communication device 90. The wireless communication device 90 can be partially placed on the upper surface 99A of the electrical conductive body 99. The wireless communication device 90 can be placed on the upper surface 99A of the electrical conductive body 99 in various orientations. The wireless communication device 90 can have any orientation. The wireless communication device 90 can be appropriately secured on the upper surface 99A of the electrical conductive body 99 with a fastener. The fastener includes a fastener that uses a surface for securing, such as double-sided tape and adhesive. The fastener includes a fastener that uses a point for securing, such as a screw and a nail.

The upper surface 99A of the electrical conductive body 99 can include a portion extending in a j-direction. In the portion extending in the j-direction, a length extending in the j-direction is larger than a length extending in the k-direction. The j-direction and the k-direction are orthogonal to each other. The j-direction is a direction in which the electrical conductive body 99 extends long. The k-direction is a direction in which the electrical conductive body 99 has a length smaller than that in the j-direction. The wireless communication device 90 can be placed on the upper surface 99A such that the x-direction is along the j-direction. The wireless communication device 90 can be placed on the upper surface 99A of the electrical conductive body 99 so as to be aligned in the x-direction in which the first conductor 31 and the second conductor 32 are arranged. When the wireless communication device 90 is located on the electrical conductive body 99, the first antenna 60 can be electromagnetically coupled to the electrical conductive body 99. In the fourth conductor 50 of the first antenna 60, second current flows in the x-direction. In the electrical conductive body 99 electromagnetically coupled to the first antenna 60, the second current induces current. When the x-direction of the first antenna 60 and the j-direction of the electrical conductive body 99 are aligned, current flowing in the j-direction becomes large in the electrical conductive body 99. When the x-direction of the first antenna 60 and the j-direction of the electrical conductive body 99 are aligned, radiation due to the induced current becomes large in the electrical conductive body 99. The angle between the x-direction and the j-direction can be 45 degrees or less.

The ground conductor 811 of the wireless communication device 90 is separated from the electrical conductive body 99. The ground conductor 811 is separated from the electrical conductive body 99. The wireless communication device 90 can be placed on the upper surface 99A such that the direction along a long side of the upper surface 99A is aligned in the x-direction in which the first conductor 31 and the second conductor 32 are arranged. The upper surface 99A can include a diamond-shaped surface and a circular surface in addition to a rectangular surface. The electrical conductive body 99 can include a diamond-shaped surface. This diamond-shaped surface can be the upper surface 99A on which the wireless communication device 90 is placed. The wireless communication device 90 can be placed on the upper surface 99A such that a direction along a long diagonal of the upper surface 99A is aligned in the x-direction in which the first conductor 31 and the second conductor 32 are arranged. The upper surface 99A is not limited to a flat shape. The upper surface 99A can include irregularities. The upper surface 99A can include a curved surface. The curved surface includes a ruled surface. The curved surface includes a cylinder.

The electrical conductive body 99 extends in the xy plane. In the electrical conductive body 99, a length in the x-direction can be larger than a length in the y-direction. In the electrical conductive body 99, the length in the y-direction can be smaller than that one half of a wavelength λ_{c} at the operating frequency f_{c} of the third antenna 97. The wireless communication device 90 can be located on the electrical conductive body 99. The electrical conductive body 99 is located apart from the fourth conductor 50 in the z-direction. In the electrical conductive body 99, the length in the x-direction is larger than that of the fourth conductor 50. In the electrical conductive body 99, an area in the xy plane is larger than that of the fourth conductor 50. The electrical conductive body 99 is located apart from the ground conductor 811 in the z-direction. In the electrical conductive body 99, the length in the x-direction is larger than that of the ground conductor 811. In the electrical conductive body 99, an area in the xy plane is larger than that of the ground conductor 811.

The wireless communication device 90 can be placed on the electrical conductive body 99 in an orientation aligned with the x-direction in which the first conductor 31 and the second conductor 32 are arranged, in a direction in which the electrical conductive body 99 extends long. In other words, the wireless communication device 90 can be placed on the electrical conductive body 99, in an orientation in which a direction in which the current of the first antenna 60 flows is aligned with a direction in which the electrical conductive body 99 extends long, in the xy plane.

The first antenna 60 has a small change in resonant frequency due to the conductor of the circuit board 81 side. The first antenna 60 of the wireless communication device 90 can reduce the influence from an external environment.

In the wireless communication device 90, the ground conductor 811 is capacitively coupled to the electrical conductive body 99. The wireless communication device 90 includes the portion of the electrical conductive body 99 extending outward from the third antenna 97, and thus, a gain is improved as compared with the first antenna 60.

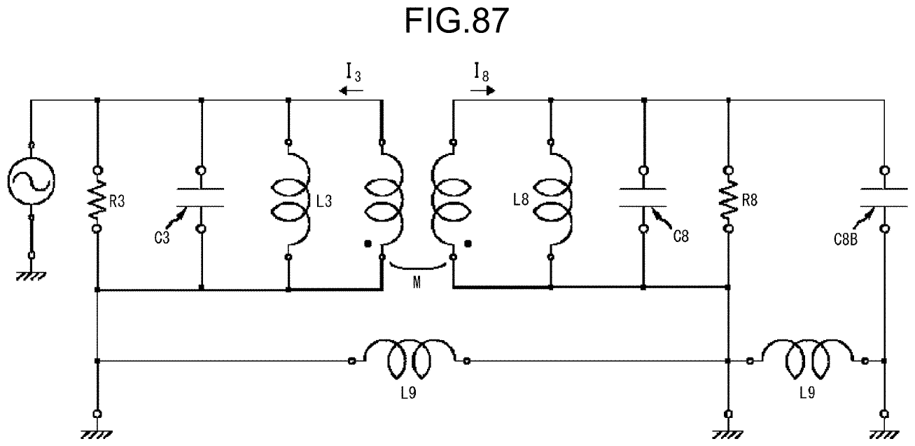

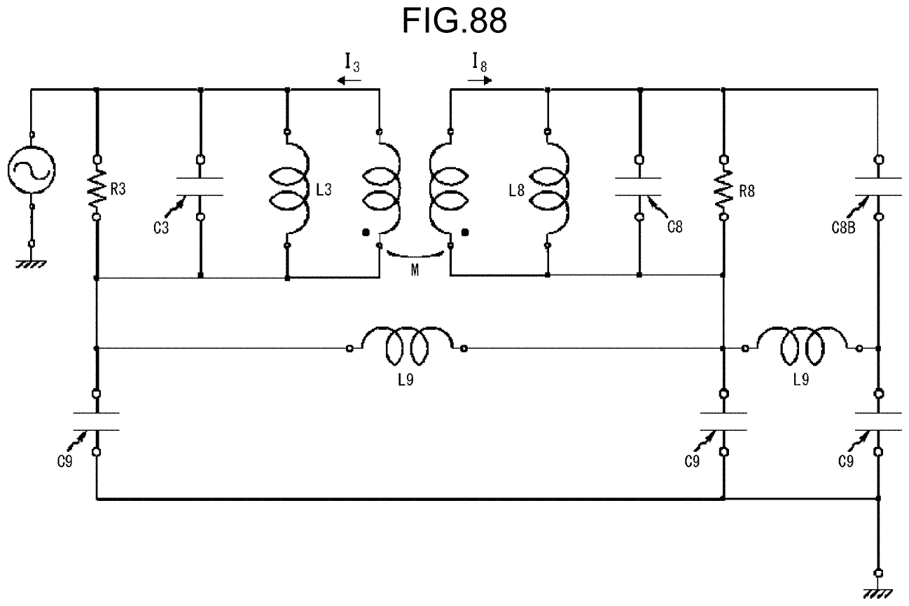

The wireless communication device 90 can have different resonance circuits for use in the air and for use on the electrical conductive body 99. FIG. 87 illustrates a schematic circuit of a resonance structure for use in the air. FIG. 88 illustrates a schematic circuit of a resonance structure for use on the electrical conductive body 99. L3 is the inductance of the resonator 10, L8 is the inductance of the eighth conductor 961, L9 is the inductance of the electrical conductive body 99, and M is the mutual inductance between L3 and L8. C3 is the capacitance of the third conductor 40, C4 is the capacitance of the fourth conductor 50, C8 is the capacitance of the eighth conductor 961, C8B is the capacitance between the eighth conductor 961 and the battery 91, and C9 is the capacitance between the electrical conductive body 99 and the ground conuctor 811. R3 is the radiation resistance of the resonator 10 and R8 is the radiation resistance of the eighth conductor 961. The operating frequency of the resonator 10 is lower than the resonant frequency of the eighth conductor. In the wireless communication device 90, the ground conductor 811 functions as a chassis ground in the air. In the wireless communication device 90, the fourth conductor 50 is capacitively coupled to the electrical conductive body 99. In the wireless communication device 90 on the electrical conductive body 99, the electrical conductive body 99 substantially functions as the chassis ground.

In the plurality of embodiments, the wireless communication device 90 includes the eighth conductor 961. The eighth conductor 961 is electromagnetically coupled to the first antenna 60 and capacitively coupled to the fourth conductor 50. The wireless communication device 90 has capacitance C8B increased due to the capacitive coupling, and when the wireless communication device 90 is put on the electrical conductive body 99 from the air, the operating frequency thereof can be increased. The wireless communication device 90 has mutual inductance M increased due to the electromagnetic coupling, and when the wireless communication device 90 is put on the electrical conductive body 99 from the air, the operating frequency can be reduced. In the wireless communication device 90, changing the balance between the capacitance C8B and the mutual inductance M can adjust the change in operating frequency when the wireless communication device 90 is placed on the electrical conductive body 99 from the air. In the wireless communication device 90, changing the balance between the capacitance C8B and the mutual inductance M can reduce the change in operating frequency when the wireless communication device 90 is placed on the electrical conductive body 99 from the air.

The wireless communication device 90 includes the eighth conductor 961 that is electromagnetically coupled to the third conductor 40 and capacitively coupled to the fourth conductor 50. The wireless communication device 90 including the eighth conductor 961 can adjust the change in operating frequency when the wireless communication device 90 is placed on the electrical conductive body 99 from the air. The wireless communication device 90 including such an eighth conductor 961 can reduce the change in operating frequency when the wireless communication device 90 is placed on the electrical conductive body 99 from the air.

Likewise, in the wireless communication device 90 that does not include the eighth conductor 961, the ground conductor 811 functions as the chassis ground in the air. Likewise, in the wireless communication device 90 that does not include the eighth conductor 961, the electrical conductive body 99 functions as a substantial chassis ground, on the electrical conductive body 99. The resonant structure including the resonator 10 can oscillate even if the chassis ground changes. This configuration corresponds to that the resonator 10 including the reference potential layer 51 and the resonator 10 not including the reference potential layer 51 can oscillate.

(Application to Street Lamp)

Street lamps are widely used as outdoor lighting. The street lamps are installed, for example, on roads and in parks. The street lamps often have a structure in which a lighting device is mounted to an end of a pole. The lighting device includes, for example, a light bulb or a light emission diode (LED).

Since the light bulb and LED are consumables, the light bulbs or LEDs used for the street lamps do not emit light at the end of the product life thereof. The luminance of light emitted from LEDs gradually decreases, and the luminance becomes insufficient over time. There is also a possibility that the light bulb or LED may not emit light due to a failure of a power supply that supplies power to the light bulb or LED of the street lamp.

It is not preferable to keep abnormal lighting of the street lamp for a long time. Therefore, it is desirable to regularly check whether the street lamp is lighted normally. However, it is difficult to visit a place where a street lamp is installed with high frequency and visually check the normal lighting of the street lamp.

Therefore, it is desirable to detect the operating state of the street lamp with a sensor and transmit a detection result by wireless communication. For the transmission of a detection result by wireless communication, the antenna according to the present disclosure, for example, the first antenna 60 or the second antenna 70 can be used.

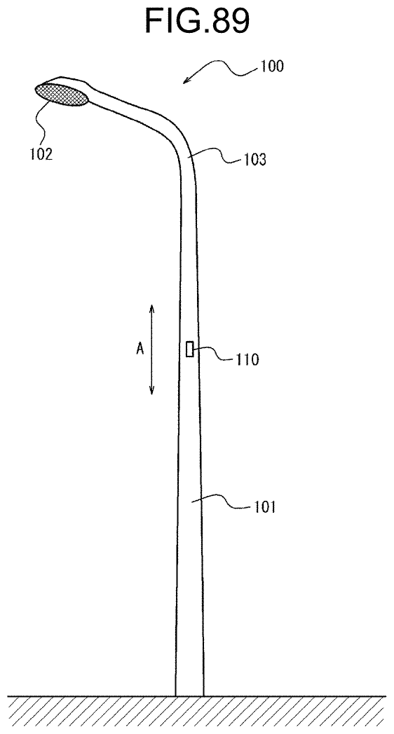

FIG. 89 is a diagram illustrating how a communication module 110 according to an embodiment is mounted to a street lamp 100.

The street lamp 100 includes a pole 101 and a lighting device 102 arranged near the leading end of the pole 101.

The pole 101 is installed on the ground. The pole 101 extends from the ground so as to be substantially perpendicular to the ground and is curved at a bent portion 103. The bent portion 103 is not essential. If there is no bent portion 103, the pole 101 can extend substantially perpendicular to the ground as a whole.

The lighting device 102 is mounted near the leading end of the pole 101. The pole 101 serves as a support that supports the lighting device 102.

The pole 101 is not limited to the shape illustrated in FIG. 89 but may have various shapes. The pole 101 may have a shape having a cross-section shape of, for example, a circle, ellipse or polygon.

The surface of the pole 101 is covered with a conductive material. The conductive material may include a metal, conductive plastic, or the like.

The lighting device 102 is arranged near the leading end of the pole 101. The lighting device 102 is arranged with an emission surface facing in a predetermined direction so as to illuminate a desired area. For example, when the street lamp 100 is installed along a road, the lighting device 102 is arranged on the pole 101 so as to illuminate a road, sidewalk, and the like.

The lighting device 102 includes a light emitting member. The light emitting member may include, for example, an LED, light bulb, or fluorescent lamp. The lighting device 102 can illuminate the desired area by lighting the light emitting member.

The lighting device 102 is turned on when it gets dark, for example, at night, and is turned off when it gets bright, for example, in the daytime. For example, the lighting device 102 may be set to be on during a predetermined time period and to be off during a time period other than the predetermined time period. The predetermined time period may be, for example, a time period from 17:00 to 7:00. The predetermined time period may be different, for example, seasonally depending on daylight hours. The lighting device 102 may be turned on not according to the time period but when the ambient brightness becomes equal to or lower than a predetermined brightness.

The communication module 110 may be mounted to the pole 101 such that the x-direction (first direction) of an antenna included in the communication module 110 is substantially parallel to a direction in which the pole 101 extends. The antenna included in the communication module 110 may include an antenna that has any of the configurations illustrated in FIGS. 63 to 78. The antenna included in the communication module 110 may include, for example, an antenna that has the configuration of the first antenna 60 or second antenna 70. The direction in which the pole 101 extends is, for example, a direction indicated by an arrow A in FIG. 89. The antenna included in the communication module 110 may include a first conductor, a second conductor, a third conductor, a fourth conductor, and a feeding line. The antenna included in the communication module 110 may include the first conductor 31, the second conductor 32, the third conductor 40, the fourth conductor 50, and the first feeding line 61, for example, as in the first antenna 60 illustrated in FIG. 64.

When the communication module 110 is mounted to the pole 101 of the street lamp 100, a place where the communication module 110 is arranged is not particularly limited, but the communication module 110 may be arranged at a height beyond the reach of people on the street. Arrangement of the communication module 110 at such a height beyond the reach of the people on the street can reduce the possibility of damage of the communication module 110 by the people making contact with the communication module 110. The communication module 110 may be arranged at a height facilitating mounting of the communication module 110 to the pole 101. Arrangement of the communication module 110 at such a height facilitating the mounting thereof to the pole 101 can reduce labor hours for mounting the communication module 110 to the pole 101.

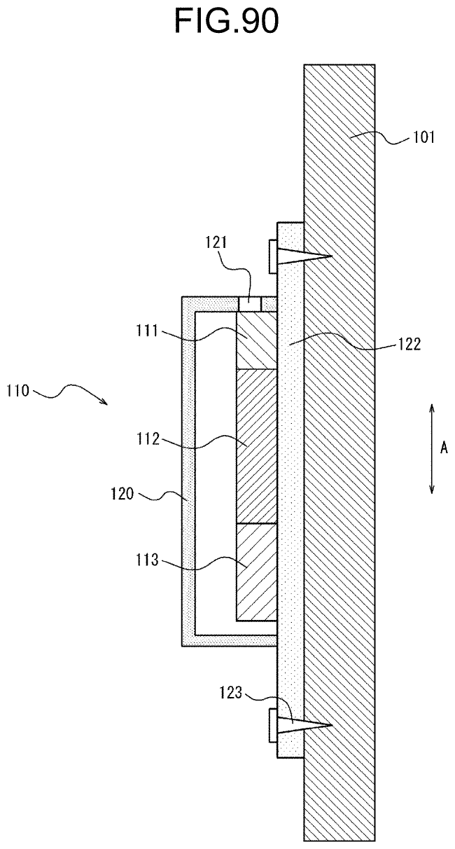

FIG. 90 is an enlarged view illustrating how the communication module 110 according to an embodiment is mounted to the pole 101 of the street lamp 100.

The communication module 110 includes an illuminance sensor 111, an antenna module 112, a battery 113, a case 120, and a board 122.

The illuminance sensor 111, the antenna module 112, and the battery 113 are fixed to the board 122. The illuminance sensor 111, the antenna module 112, and the battery 113 may be fixed to the board 122, for example, with a conductive adhesive.

The board 122 may be formed of a conductive material. The conductive material may include a metal, conductive plastic, or the like.

The board 122 is fixed to the pole 101 of the street lamp 100 with screws 123. Fixing the board 122 with the screws 123 can reduce the possibility that the communication module 110 may fall off the pole 101 even in strong winds such as a typhoon. Means for fixing the board 122 to the pole 101 is not limited to the screws 123. For example, an adhesive, double sided tape, or nail may be used to fix the board 122 to the pole 101.

The case 120 covers the illuminance sensor 111, the antenna module 112, and the battery 113. The case 120 protects the illuminance sensor 111, the antenna module 112, and the battery 113. The case 120 is fixed to the board 122. The case 120 may be fixed to the board 122 with, for example, an adhesive or double-sided tape.

The case 120 is formed of a light blocking material. The case 120 has a translucent hole 121 as an optical member. The case 120 is configured to input light from the lighting device 102 of the street lamp 100 through the translucent hole 121. The translucent hole 121 can define from which direction of the communication module 110 light is input to the illuminance sensor 111.

The translucent hole 121 may be sealed with a transparent member, such as a lens or a transparent resin. Sealing the translucent hole 121 with a transparent member can prevent entrance of dust and the like into the communication module 110 through the translucent hole 121.

The optical member provided in the case 120 is not limited to the translucent hole 121. For example, instead of the translucent hole 121, a translucent slit may be provided in the case 120. The translucent slit also can define from which direction of the communication module 110 light is input to the illuminance sensor 111.

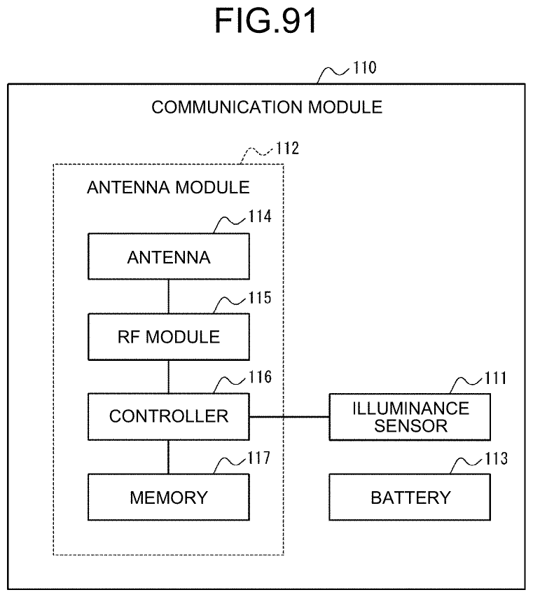

FIG. 91 is a functional block diagram of the communication module 110 according to an embodiment. The communication module 110 includes the illuminance sensor 111, the antenna module 112, and the battery 113. The communication module 110 can wirelessly communicate with information processing equipment via a network. The information processing equipment may include, for example, information processing equipment of a company that manages maintenance of the street lamp 100.

A communication standard between the communication module 110 and the information processing equipment may employ a telecommunication standard. The telecommunication standard may include any of 2nd generation (2G), 3rd generation (3G), 4th generation (4G), Long Term Evolution (LTE), Worldwide Interoperability for Microwave Access (WiMAX), Sigfox, and Personal Handy-phone System (PHS).

As illustrated in FIG. 90, the illuminance sensor 111 receives light input through the translucent hole 121. The illuminance sensor 111 detects illuminance in a direction in which the translucent hole 121 is provided, on the basis of the received light. The illuminance sensor 111 can detect light emitted from the lighting device 102 through the translucent hole 121.

The antenna module 112 includes an antenna 114, an RF module 115, a controller 116, and a memory 117.

The antenna 114 may include an antenna that has any of the configurations illustrated in FIGS. 63 to 78. The antenna 114 may include, for example, an antenna that has the configuration of the first antenna 60 or second antenna 70.

The antenna 114 may be appropriately configured so as to have a size according to a communication standard adopted by the communication module 110.

The antenna 114 may be mounted to the pole 101 via the board 122 such that the x-direction (first direction) is substantially parallel to the direction in which the pole 101 extends.

The antenna 114 may be mounted to the board 122 such that the fourth conductor 50 included in the antenna 114 makes contact with the board 122. For example, in a case where the antenna 114 has the structure illustrated in FIG. 64, the antenna 114 mainly radiates an electromagnetic wave in the positive direction of the z axis illustrated in FIG. 64. The fourth conductor 50 mounted to the board 122 in contact with the board 122 allows the antenna 114 to efficiently radiate an electromagnetic wave to the side opposite to the board 122.

As described above, the board 122 is formed of a conductive material, and the surface of the pole 101 is covered with a conductive material. Therefore, the antenna 114 can be electromagnetically coupled to the pole 101 via the board 122. When current flows through the antenna 114, current is induced on the surface of the pole 101. The x-direction of the antenna 114 is substantially parallel to the direction in which the pole 101 extends, and thus the induced current that flows in the direction in which the pole 101 extends increases on the surface of the pole 101. The induced current that flows in the direction in which the pole 101 extends radiates an electromagnetic wave, thus improving the radiation efficiency of the antenna 114.

The RF module 115 is electromagnetically connected to the feeding line of the antenna 114. The RF module 115 includes a modulation circuit and a demodulation circuit. The RF module 115 modulates a baseband signal acquired from the controller 116 to generate a radio signal and supplies the radio signal to the antenna 114. The RF module 115 demodulates a radio signal acquired from the antenna 114 to generate a baseband signal and supplies the baseband signal to the controller 116.

The controller 116 can include, for example, a processor. Controller 116 may include one or more processors. The processor may include a general-purpose processor that is used for loading a specific program to execute a specific function and a dedicated processor that is dedicated to specific processing. The dedicated processor may include an application specific IC. The application specific IC is also referred to as ASIC. The processor may include a programmable logic device. The programmable logic device is also referred to as PLD. The PLD may include an FPGA. The controller 116 may include any of an SoC and an SiP that are configured such that one or more processors cooperate with each other. The controller 116 may store a variety of information, a program for operating each component module of the communication module 110, or the like in the memory 117.

The controller 116 controls the operations of the entire communication module 110 and each component module of the communication module 110.

The controller 116 acquires measurement data on illuminance from the illuminance sensor 111. The controller 116 generates, as a baseband signal, a transmission signal according to the acquired measurement data. The controller 116 supplies the generated transmission signal to the RF module 115.

The controller 116 may include, in addition to the measurement data on illuminance, data on the time when the illuminance was measured and identification data for identifying the street lamp 100, in the transmission signal.

The controller 116 may include a clock function. The controller 116 may control the illuminance sensor 111 so as to operate periodically. The controller 116 may operate the illuminance sensor 111 at periodic intervals, for example, once a day, once a week, or once a month. The controller 116 may operate the illuminance sensor 111 at night. Operating the illuminance sensor 111 at night makes it possible for the controller 116 to accurately detect that a failure has occurred in the street lamp 100 if the street lamp 100 is off.

Upon acquiring measurement data from the illuminance sensor 111, the controller 116 may cause the RF module 115 to operate to transmit, as a radio signal, a transmission signal corresponding to the measurement data to the antenna 114.

The controller 116 may not operate the RF module 115 each time measurement data is acquired from the illuminance sensor 111. The controller 116 may cause, for example, the illuminance sensor 111 to operate in a first predetermined cycle, causing the RF module 115 to operate in a second predetermined cycle that is longer than the first predetermined cycle. The first predetermined cycle can be, for example, one day. The second predetermined cycle can be, for example, one week. The controller 116 may temporarily store, in the memory 117, the measurement data acquired from the illuminance sensor 111 in the first predetermined cycle. The controller 116 may generate a transmission signal by collecting measurement data stored in the memory 117 after transmitting the last transmission signal and cause the generated transmission signal to be transmitted to the RF module 115 in the second predetermined cycle.

In this way, the controller 116 causes the illuminance sensor 111 and the RF module 115 to operate for a short period of time in a predetermined cycle, thus reducing power supplied from the battery 113 to the illuminance sensor 111 and the RF module 115 can be reduced. Therefore, the communication module 110 can make the battery 113 last longer.

The controller 116 may set timing at which the RF module 115 is operated to the time that is randomly shifted from a fixed basic cycle. For example, when the fixed cycle is one week, the controller 116 may cause the RF module 115 to operate at timing shifted by several minutes to several hours every time. For example, the controller 116 may generate a random number to calculate the amount of time to be shifted from the fixed cycle based on the random number.

In this way, the controller 116 causes the RF module 115 to operate at the time randomly shifted from the fixed basic cycle that serves as a base, thus dispersing a load in communication between the communication module 110 and an information processing equipment of a company that manages the maintenance of the street lamp 100.

The memory 117 can include, for example, a semiconductor memory or the like. The memory 117 can function as a work memory for the controller 116. The memory 117 can be included in the controller 116.

The battery 113 supplies power to the communication module 110. The battery 113 can supply power to at least one of the illuminance sensor 111, the RF module 115, the controller 116, and the memory 117. The battery 113 can include at least one of a primary battery and a secondary battery. The negative electrode of the battery 113 is electrically connected to the board 122. The negative electrode of the battery 113 is electrically connected to the fourth conductor of the antenna 114 via the board 122.

It is not essential for the battery 113 to be included in the communication module 110. When the communication module 110 does not include the battery 113, power may be supplied, for example, to the communication module 110 from a power supply that supplies power to the street lamp 100.

As described above, the communication module 110 according to an embodiment that is mounted to the street lamp 100 includes the antenna 114. The antenna 114 may include an antenna that has any of the configurations illustrated in FIGS. 63 to 78. In other words, the antenna 114 may include the first conductor, the second conductor, the third conductor, the fourth conductor, and the feeding line. The second conductor may face the first conductor in the first direction. The third conductor may be located between the first conductor and the second conductor, apart from the first conductor and the second conductor, and extend in the first direction. The fourth conductor may be connected to the first conductor and the second conductor and extend in the first direction. The feeding line may be electromagnetically connected to the third conductor. Such a configuration reduces the influence of a reflected wave due to a metal conductor on a surface of the street lamp 100, when the electromagnetic wave is transmitted from the antenna 114. The antenna 114 may be mounted to the pole 101 such that the first direction is substantially parallel to the direction in which the pole 101 extends. Thus, the surface of the pole 101 has a large induced current that flows in the direction in which the pole 101 extends. The induced current that flows in the direction in which the pole 101 extends radiates an electromagnetic wave, thus improving the radiation efficiency of the antenna 114.

The configuration according to the present disclosure is not limited only to the embodiments described above but various modifications or alterations can be made. For example, the functions and the like included in the component modules can be rearranged so as not to be logically inconsistent, and a plurality of component modules can be combined into one or divided.

For example, the illuminance sensor 111 may be arranged outside the communication module 110. In this case, the illuminance sensor 111 and the controller 116 may be connected in a wired or wireless manner.

For example, the communication module 110 may be mounted to another pole around the street lamp 100 other than the pole 101 of the street lamp 100. When the surface of the pole therearound is covered with a conductive material, the antenna 114 of the communication module 110 is mounted such that the x-direction of the antenna 114 is substantially parallel to the direction in which the pole extends, thus improving the radiation efficiency of the antenna 114.

For example, the communication module 110 may be mounted not only to the street lamp 100 but also to a pole of an indoor lamp.

(Application to Road-to-Vehicle Communication)

Road-to-vehicle communication is widely used for traffic safety and traffic congestion relief. In the road-to-vehicle communication, a communication module installed near a road wirelessly communicates with a communication module installed in a moving vehicle such as a car.

In the road-to-vehicle communication, as the antenna used for the communication module installed near a road, an antenna according to the present disclosure, for example, the first antenna 60 or the second antenna 70 can be used.

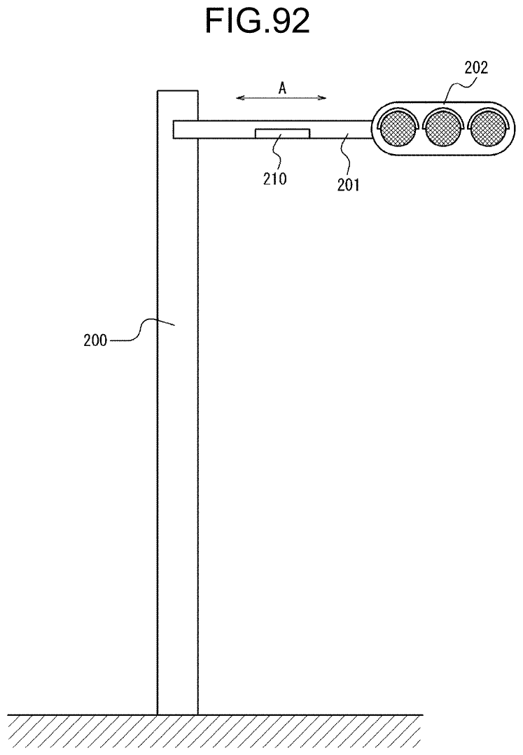

FIG. 92 is a diagram illustrating how a communication module 210 according to an embodiment is mounted so as to face the ground, to a pole 201 extending in a substantially horizontal direction.

The pole 201 is mounted to a traffic light pole 200 installed near a road. The pole 201 is mounted to the traffic light pole 200 so as to extend in a substantially horizontal direction above the road. The pole 201 supports a traffic light 202.

The surface of the pole 201 is covered with a conductive material. The conductive material may include a metal, conductive plastic, or the like. To the communication module 210, a heater for melting snow can be mounted.

The communication module 210 may be mounted to the pole 201 such that the x-direction (first direction) of an antenna included in the communication module 210 is substantially parallel to the substantially horizontal direction in which the pole 201 extends. The antenna included in the communication module 210 may include an antenna that has any of the configurations illustrated in FIGS. 63 to 78. The antenna included in the communication module 210 may include, for example, an antenna that has the configuration of the first antenna 60 or second antenna 70. The direction in which the pole 201 extends is, for example, a direction indicated by an arrow A in FIG. 92 The antenna included in the communication module 210 may include a first conductor, a second conductor, a third conductor, a fourth conductor, and a feeding line. The antenna included in the communication module 210 may include the first conductor 31, the second conductor 32, the third conductor 40, the fourth conductor 50, and the first feeding line 61, for example, as in the first antenna 60 illustrated in FIG. 64.

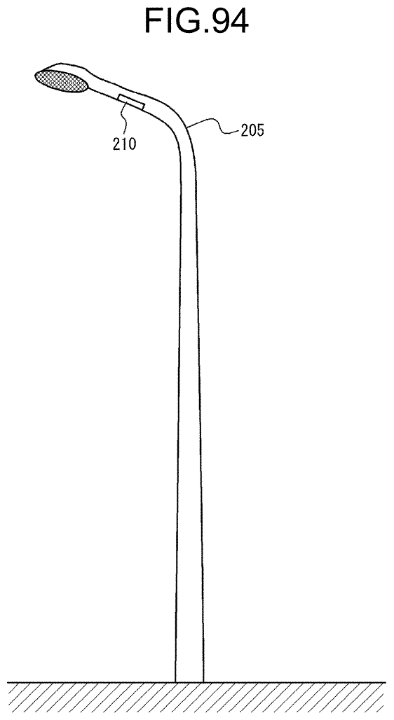

A target to which the communication module 210 is to be installed is not limited to the pole 201 that supports the traffic light 202. For example, as illustrated in FIG. 94, the communication module 210 may be installed at an arm of a pole 205 of a street lamp. The communication module 210 may be installed, for example, at a pole-shaped portion extending in a substantially horizontal direction of a pedestrian bridge. The communication module 210 may be installed, for example, at a pole that extends in a substantially horizontal direction, and that is provided exclusively for installing the communication module 210.

In the present disclosure, the arm of the pole 205 of the street lamp as illustrated in FIG. 94 is also included in the pole extending in a “substantially horizontal direction”. In the present disclosure, the “substantially horizontal direction” includes up to a direction inclined approximately 45 degrees with respect to a horizontal direction.

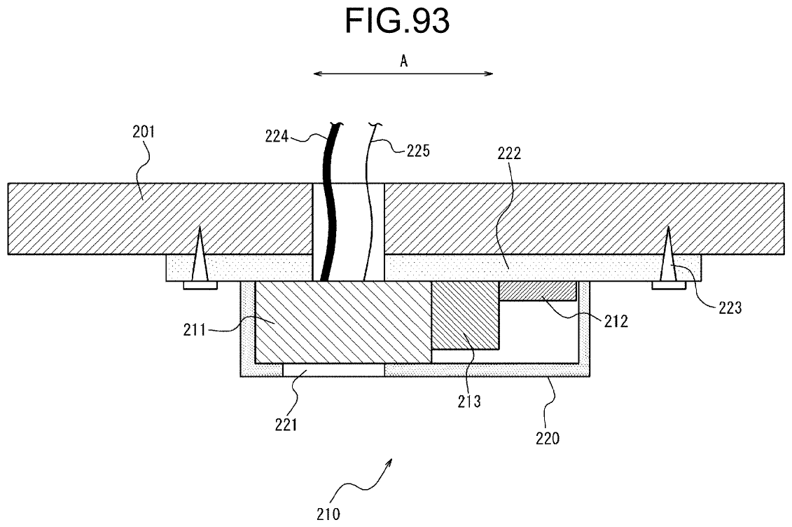

FIG. 93 is an enlarged view illustrating how a communication module 210 according to an embodiment is mounted to the pole 201 extending in a substantially horizontal direction.

The communication module 210 includes a detector 211, an antenna module 212, a controller module 213, a case 220, a board 222, a power cable 224, and a network cable 225.

The detector 211, the antenna module 212, and the controller module 213 are fixed to the board 222. The detector 211, the antenna module 212, and the controller module 213 may be fixed to the board 222, for example, with a conductive adhesive.

The board 222 may be formed of a conductive material. The conductive material may include a metal, conductive plastic, or the like.

The board 222 is fixed to the pole 201 extending in a substantially horizontal direction with screws 223. Fixing the board 222 with the screws 223 can reduce the possibility that the communication module 210 may fall off the pole 201 even in strong winds such as a typhoon. Means for fixing the board 222 to the pole 201 is not limited to the screws 223. For example, an adhesive, double sided tape, or nail may be used to fix the board 222 to the pole 201.

The case 220 covers the detector 211, the antenna module 212, and the controller module 213. The case 220 protects the detector 211, the antenna module 212, and the controller module 213. The case 220 is fixed to the board 222. The case 220 may be fixed to the board 222 with, for example, an adhesive or double-sided tape.

The case 220 may have a hole 221. The hole 221 may be sealed with a transparent resin or the like. The detector 211 of the communication module 210 can acquire peripheral information through the hole 221. For example, in a case where the detector 211 uses a camera, the detector 211 can image an environmental situation through the hole 221.

The power cable 224 is configured to be connected to a power line or the like passing through a hollow portion of the pole 201 so as to receive power supplied from the power line. The power cable 224 can supply power to at least one of the detector 211, the antenna module 212, and the controller module 213. Supply of power with the power cable 224 can continuously supply power for a long period of time, for example, even if the detector 211 employs a camera with high power consumption.

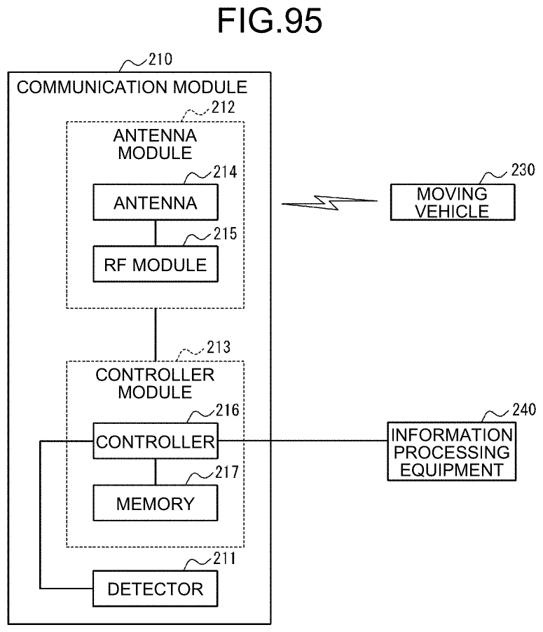

The network cable 225 is connected to a communication line or the like passing through the hollow portion of the pole 201. The controller module 213 can communicate with external information processing equipment 240 (see FIG. 95) and the like via the network cable 225.

FIG. 95 is a functional block diagram of a communication module 210 according to an embodiment. The communication module 210 includes the detector 211, the antenna module 212, and the controller module 213. The communication module 210 can directly wirelessly communicate with a moving vehicle 230 moving under the pole 201 by using the antenna module 212. The communication module 210 can communicate with the information processing equipment 240 via the network cable 225 illustrated in FIG. 93

The moving vehicle 230 is a vehicle that moves under the pole 201 to which the communication module 210 is mounted. The “vehicle” according to the present disclosure includes, but is not limited to, an automobile, a railroad vehicle, an industrial vehicle, and a vehicle for daily life. For example, the vehicle may include an airplane that is traveling on a runway. The vehicle may include, but is not limited to, an automobile, a truck, a bus, a motorcycle, a trolley bus, or the like and may include another vehicle on a road. A track vehicle includes, but is not limited to, a locomotive, a freight car, a passenger car, a streetcar, a guideway train, a ropeway, a cable car, a linear motor car, or a monorail and may include another vehicle that travels along a track. The industrial vehicle includes industrial vehicles for agriculture or construction. The industrial vehicle includes, but is not limited to, a forklift or a golf cart. The industrial vehicle for agriculture includes, but is not limited to, a tractor, a tiller, a transplanter, a binder, a combine, or a lawnmower. The industrial vehicle for construction includes, but is not limited to, a bulldozer, a scraper, an excavator, a crane car, a dump truck, or a road roller. The vehicle for daily life includes, but is not limited to, a bicycle, a wheelchair, a stroller, a wheelbarrow, or a two wheeled, self-balancing electric vehicle. A vehicle engine includes, but is not limited to, an internal combustion engine that includes a diesel engine, a gasoline engine, or a hydrogen engine, or an electrical engine that includes a motor. The vehicle includes a vehicle that is driven manually. The vehicle classifications are not limited to the above. For example, the automobile may include an industrial vehicle that is configured to be driven on a road, and the same vehicle may be included in a plurality of classifications.

The communication module 210 can be used, for example, for radio wave beacon for transmitting a Vehicle Information and Communication System (VICS) (registered trademark) information to the moving vehicle 230. The communication module 210 can be provided near a toll gate, for example, for electronic toll collection (ETC). The communication module 210 can be provided on an expressway, for example, for intelligent transport systems (ITS) spot. The communication module 210 can be provided, for example, on a highway or general road for transmission of information necessary for autonomous driving.

The information processing equipment 240 may be managed by a company that operates an ITS business.

The detector 211 acquires peripheral information around the pole 201 to which the communication module 210 is mounted. The detector 211 may include, for example, a camera, a radar, or various sensors. The various sensors may include, for example, an illuminance sensor, a geomagnetic sensor, a temperature sensor, a humidity sensor, an atmospheric pressure sensor, and the like. In a case where the detector 211 uses a camera, the detector 211 can image vehicles and the like moving under the pole 201 to which the communication module 210 is mounted.

The antenna module 212 includes an antenna 214 and an RF module 215. The controller module 213 includes a controller 216 and a memory 217.

The antenna 214 may include an antenna that has any of the configurations illustrated in FIGS. 63 to 78. The antenna 214 may include, for example, an antenna that has the configuration of the first antenna 60 or second antenna 70.

The antenna 214 may be appropriately configured so as to have a size according to a communication standard adopted for communication between the communication module 210 and the moving vehicle 230.

The antenna 214 may be mounted to the pole 201 via the board 222 such that the x-direction (first direction) is substantially parallel to the substantially horizontal direction in which the pole 201 extends.

The antenna 214 may be mounted to the board 222 such that the fourth conductor 50 included in the antenna 214 makes contact with the board 222. For example, in a case where the antenna 214 has the structure illustrated in FIG. 64, the antenna 214 mainly radiates an electromagnetic wave in the positive direction of the z axis illustrated in

FIG. 64. The fourth conductor 50 mounted to the board 222 in contact with the board 222 allows the antenna 214 to efficiently radiate an electromagnetic wave to the side opposite to the board 222, that is, from the pole 201 extending in a substantially horizontal direction toward the ground.

As described above, the board 222 is formed of the conductive material, and the surface of the pole 201 is covered with the conductive material. Therefore, the antenna 214 can be electromagnetically coupled to the pole 201 via the board 222. When current flows through the antenna 214, current is induced on the surface of the pole 201. The x-direction of the antenna 214 is substantially parallel to the direction in which the pole 201 extends, and thus the induced current that flows in the direction in which the pole 201 extends increases on the surface of the pole 201. The induced current that flows in the direction in which the pole 201 extends radiates an electromagnetic wave, thus improving the radiation efficiency of the antenna 214.

The RF module 215 is electromagnetically connected to the feeding line of the antenna 214. The RF module 215 includes a modulation circuit and a demodulation circuit. The RF module 215 modulates a baseband signal acquired from the controller 216 to generate a radio signal and supplies the radio signal to the antenna 214. The RF module 215 demodulates a radio signal acquired from the antenna 214 to generate a baseband signal and supplies the baseband signal to the controller 216.

The controller 216 can include, for example, a processor. The controller 216 may include one or more processors. The processor may include a general-purpose processor that is used for loading a specific program to execute a specific function and a dedicated processor that is dedicated to specific processing. The dedicated processor may include an application specific IC. The application specific IC is also referred to as ASIC. The processor may include a programmable logic device. The programmable logic device is also referred to as a PLD. The PLD may include an FPGA. The controller 216 may include any of an SoC and an SiP that are configured such that one or more processors cooperating with each other. The controller 216 may store a variety of information, a program for operating each component module of the communication module 210, or the like in the memory 217.

The controller 216 controls the operations of the entire communication module 210 and each component module of the communication module 210.

The controller 216 acquires, from the detector 211, peripheral information around the pole 201 to which the communication module 210 is mounted. Hereinafter, the “peripheral information around the pole 201 to which the communication module 210 is mounted” is also simply referred to as “peripheral information”.

The controller 216 generates as a baseband signal, transmission information based on the acquired peripheral information. For example, in a case where the detector 211 uses a camera, the controller 216 may perform image analysis processing on an image captured by the detector 211 to generate the transmission information. The controller 216 may cause the RF module 215 to convert the generated transmission information from the baseband signal to a radio signal. The controller 216 may cause the antenna 214 to directly transmit the radio signal to the moving vehicle 230. The controller 216 may transmit the generated transmission information to the information processing equipment 240 via the network cable 225 illustrated in FIG. 93. In a case where the detector 211 uses a camera, the detector 211 can image, for example, a license plate of an automobile on a road and transmit the captured image to the information processing equipment 240.

The controller 216 may include, in the transmission information, time data upon measurement of the peripheral information and identification data for identifying the pole 201, in addition to data based on the peripheral information.

The controller 216 acquires traffic information or the like from the information processing equipment 240. The controller 216 generates transmission information on the basis of the traffic information or the like acquired from the information processing equipment 240. The controller 216 may cause the RF module 215 to convert the generated transmission information into a radio signal. The controller 216 may cause the antenna 214 to directly transmit the radio signal to the moving vehicle 230.

The memory 217 can include, for example, a semiconductor memory or the like. The memory 217 can function as a work memory for the controller 216. The memory 217 can be included in the controller 216.

As described above, the communication module 210 according to an embodiment that is mounted to the pole 201 extending in a substantially horizontal direction includes the antenna 214. The antenna 214 may include an antenna that has any of the configurations illustrated in FIGS. 63 to 78. In other words, the antenna 214 may include the first conductor, the second conductor, the third conductor, the fourth conductor, and the feeding line. The second conductor may face the first conductor in the first direction. The third conductor may be located between the first conductor and the second conductor, apart from the first conductor and the second conductor, and extend in the first direction. The fourth conductor may be connected to the first conductor and the second conductor and extend in the first direction. The feeding line may be electromagnetically connected to the third conductor. Such a configuration reduces the influence of a reflected wave due to a metal conductor on a surface of the pole 201, when the electromagnetic wave is transmitted from the antenna 214. The antenna 214 may be mounted to the pole 201 such that the first direction is substantially parallel to the substantially horizontal direction in which the pole 201 extends. Thus, the surface of the pole 201 has a large induced current that flows in the direction in which the pole 201 extends. The induced current that flows in the direction in which the pole 201 extends radiates an electromagnetic wave, thus improving the radiation efficiency of the antenna 214.

(Modification of Application to Road-To-Vehicle Communication)

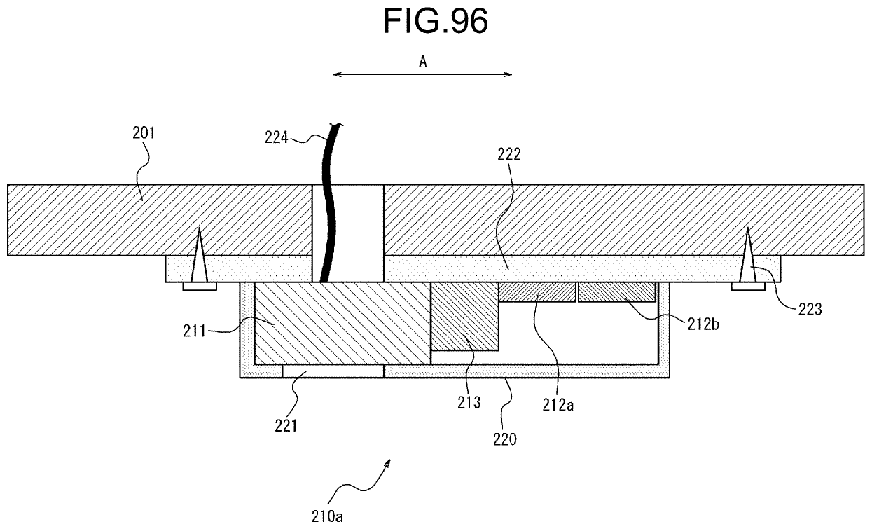

FIG. 96 is an enlarged view illustrating how a communication module 210a according to a modification is mounted to the pole 201 extending in a substantially horizontal direction.

The communication module 210a includes a detector 211, a first antenna module 212a, a second antenna module 212b, a controller module 213, a case 220, a board 222, and a power cable 224.

The communication module 210a according to the modification is different from the communication module 210 illustrated in FIG. 93 in that the second antenna module 212b is included and the network cable 225 illustrated in FIG. 93 is not included. The communication module 210a illustrated in FIG. 96 is only an example and can include the network cable 225. The first antenna module 212a included in the communication module 210a according to the modification corresponds to the antenna module 212 illustrated in FIG. 93

Regarding the communication module 210a according to the modification, a difference from the communication module 210 illustrated in FIGS. 93 and 95 will be mainly described, and description of common contents will be appropriately omitted.

The detector 211, the first antenna module 212a, the second antenna module 212b, and the controller module 213 are fixed to the board 222. The detector 211, the first antenna module 212a, the second antenna module 212b, and the controller module 213 may be fixed to the board 222, for example, with a conductive adhesive.

The second antenna module 212b may be arranged near the first antenna module 212a as illustrated in FIG. 96.

The case 220 covers the detector 211, the first antenna module 212a, the second antenna module 212b, and the controller module 213. The case 220 protects the detector 211, the first antenna module 212a, the second antenna module 212b, and the controller module 213.

The power cable 224 is configured to be connected to a power line or the like passing through a hollow portion of the pole 201 so as to receive power supplied from the power line. The power cable 224 supplies power to at least one of the detector 211, the first antenna module 212a, the second antenna module 212b, and the controller module 213.

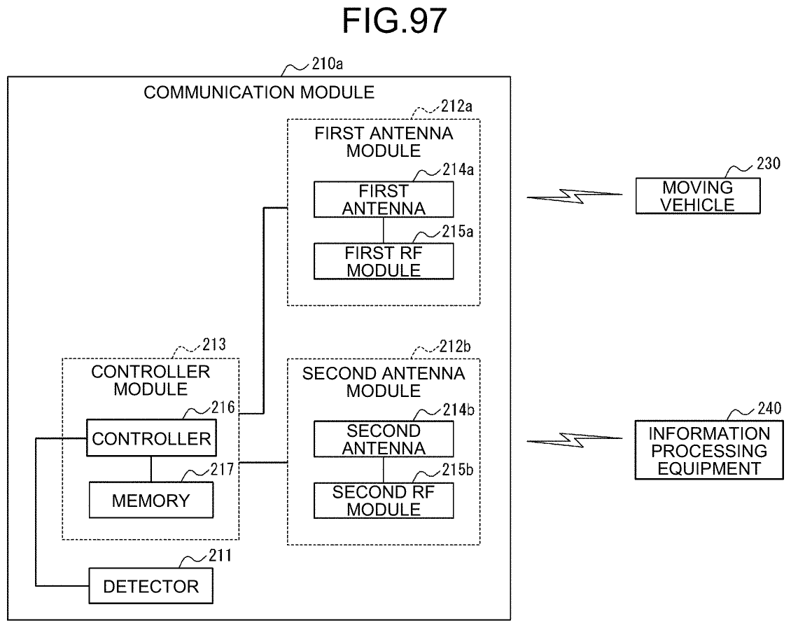

FIG. 97 is a functional block diagram of the communication module 210a according to the modification. The communication module 210a includes the detector 211, the first antenna module 212a, the second antenna module 212b, and the controller module 213. The communication module 210a can directly wirelessly communicate with the moving vehicle 230 through the first antenna module 212a. The communication module 210a can communicate with the information processing equipment 240 via wireless communication by the second antenna module 212b. Communication between the second antenna module 212b and the information processing equipment 240 may include wired communication.

The first antenna module 212a includes a first antenna 214a and a first RF module 215a. The second antenna module 212b includes a second antenna 214b and a second RF module 215b.

The first antenna 214a and the second antenna 214b may each include an antenna that has any of the configurations illustrated in FIGS. 63 to 78. The first antenna 214a and the second antenna 214b may each include, for example, an antenna that has the configuration of the first antenna 60 or second antenna 70.

The first antenna 214a may be appropriately configured so as to have a size according to a communication standard of wireless communication using the first antenna 214a. The second antenna 214b may be appropriately configured so as to have a size according to a communication standard of wireless communication using the second antenna 214b.

Each of the first antenna 214a and the second antenna 214b may be mounted to the pole 201 via the board 222 such that the x-direction (first direction) is substantially parallel to the substantially horizontal direction in which the pole 201 extends.

Each of the first antenna 214a and the second antenna 214b may be mounted to the board 222 such that the fourth conductor 50 included in each of the first antenna 214a and the second antenna 214b makes contact with the board 222. For example, in a case where the first antenna 214a and the second antenna 214b each have the structure illustrated in FIG. 64, each of the first antenna 214a and the second antenna 214b mainly radiates an electromagnetic wave in the positive direction of the z-axis illustrated in FIG. 64. The fourth conductor 50 mounted to the board 222 in contact with the board 222 allows each of the first antenna 214a and the second antenna 214b to efficiently radiate an electromagnetic wave to the side opposite to the board 222.

As described above, the board 222 is formed of the conductive material, and the surface of the pole 201 is covered with the conductive material. Therefore, the first antenna 214a and the second antenna 214b can be electromagnetically coupled to the pole 201 via the board 222. When current flows through the first antenna 214a and the second antenna 214b, current is induced on the surface of the pole 201. The x-direction of each of the first antenna 214a and the second antenna 214b is substantially parallel to the direction in which the pole 201 extends, and thus the induced current flowing in the direction in which the pole 201 extends increases on the surface of the pole 201. The induced current that flows in the direction in which the pole 201 extends radiates an electromagnetic wave, thus improving the radiation efficiency of the first antenna 214a and the second antenna 214b.

The first RF module 215a is electromagnetically connected to the feeding line of the first antenna 214a. The second RF module 215b is electromagnetically connected to the feeding line of the second antenna 214b. The functions of the first RF module 215a and the second RF module 215b are similar to the function of the RF module 215 illustrated in FIG. 95.

The controller 216 generates as a baseband signal, transmission information based on the acquired peripheral information. For example, in a case where the detector 211 uses a camera, the controller 216 may perform image analysis processing on an image captured by the detector 211 to generate the transmission information.

The controller 216 may cause the first RF module 215a to convert the generated transmission information from the baseband signal to a radio signal. The controller 216 may cause the first antenna 214a to directly transmit the radio signal to the moving vehicle 230.

The controller 216 may cause the second RF module 215b to convert the generated transmission information from the baseband signal to a radio signal. The controller 216 may cause the second antenna 214b to transmit the radio signal to the information processing equipment 240.

The controller 216 acquires traffic information or the like from the information processing equipment 240 via the second antenna 214b. The controller 216 generates transmission information on the basis of the traffic information or the like acquired from the information processing equipment 240. The controller 216 may cause the first RF module 215a to convert the generated transmission information to a radio signal. The controller 216 may cause the first antenna 214a to directly transmit the radio signal to the moving vehicle 230.

As described above, the communication module 210a according to the modification can communicate with the information processing equipment 240 via wireless communication using the second antenna 214b. Therefore, the communication module 210a according to the modification can omit the connection with the network cable 225 as illustrated in FIG. 93.

The configuration according to the present disclosure is not limited only to the embodiments described above but various modifications or alterations can be made. For example, the functions and the like included in the component modules can be rearranged so as not to be logically inconsistent, and a plurality of component modules can be combined into one or divided.

For example, the detector 211 may be located outside the communication module 210 or communication module 210a. In this case, the detector 211 and the controller 216 may be connected in a wired or wireless manner.

For example, in FIG. 96, the second antenna module 212b is arranged near the first antenna module 212a, but the second antenna module 212b may be arranged apart from the first antenna module 212a.

For example, in the configuration illustrated in FIG. 97, the antenna module that wirelessly communicates with the information processing equipment 240 is only the second antenna modules 212b, but a plurality of antenna modules may wirelessly communicate with the information processing equipment 240. This makes it possible to support a plurality of communication standards.

The drawings schematically illustrate the configurations according to the present disclosure. The dimensional proportions and the like in the drawings do not necessarily the same as those of actual products.

In the present disclosure, descriptions such as “first”, “second”, and “third” are examples of identifiers for distinguishing the configuration. The configurations distinguished by the description such as “first” and “second” in the present disclosure can exchange the numbers in the configurations. For example, the first frequency and the second frequency are interchangeable in identifier, that is, between “first” and “second”. The interchange of identifiers is performed simultaneously. Even after exchanging the identifiers, the configurations are distinguished. The identifiers may be omitted. The configurations in which the identifiers are omitted are distinguished by codes. For example, the first conductor 31 can be represented as a conductor 31. In the present disclosure, the description of the identifiers, such as “first” and “second”, should not be used for the interpretation of the order of the configurations, the basis for the presence of a lower-numbered identifier, and the basis for the presence of a higher-numbered identifier. The present disclosure includes a configuration in which the second conductive layer 42 has the second unit slot 422 but the first conductive layer 41 does not have the first unit slot.

1-11. (canceled)

12. An antenna that is mounted so as to face the ground, to a pole extending in a substantially horizontal direction, the antenna comprising:
a first conductor;
a second conductor that faces the first conductor in a first direction;
a third conductor that is located between the first conductor and the second conductor, apart from the first conductor and the second conductor, and extends in the first direction;
a fourth conductor that is connected to the first conductor and the second conductor and extends in the first direction; and
a feeding line that is electromagnetically connected to the third conductor,
wherein the antenna is mounted to the pole such that the first direction is substantially parallel to the substantially horizontal direction in which the pole extends.

13. The antenna according to claim 12, wherein the pole is a pole that supports a traffic light.

14. A communication module comprising:
an antenna that is mounted so as to face the ground, to a pole extending in a substantially horizontal direction; and
a detector that acquires information around the pole, the antenna including:
a first conductor;
a second conductor that faces the first conductor in a first direction;
a third conductor that is located between the first conductor and the second conductor, apart from the first conductor and the second conductor, and extends in the first direction;
a fourth conductor that is connected to the first conductor and the second conductor and extends in the first direction; and
a feeding line that is electromagnetically connected to the third conductor,
wherein the antenna is mounted to the pole such that the first direction is substantially parallel to the substantially horizontal direction in which the pole extends, and
information acquired by the detector is transmitted to a moving vehicle moving under the pole by using the antenna.

15. The communication module according to claim 14, further comprising a network cable that is used to communicate with external information processing equipment.

16. The communication module according to claim 14, further comprising, with the antenna as a first antenna, a second antenna that is mounted to the pole near the first antenna.

17. The communication module according to claim 16, wherein
the second antenna has a configuration identical to a configuration of the first antenna,
the second antenna is mounted to the pole such that the first direction is substantially parallel to the substantially horizontal direction in which the pole extends.

18. The communication module according to claim 16, wherein the second antenna is used to communicate with external information processing equipment.

19. The communication module according to claim 14, further comprising a power cable capable of supplying power to the detector.

20. The communication module according to claim 14, wherein the pole is a pole that supports a traffic light.

21. A street lamp comprising:
a pole; and
an antenna that is mounted to the pole,
the antenna including:
a first conductor;
a second conductor that faces the first conductor in a first direction;
a third conductor that is located between the first conductor and the second conductor, apart from the first conductor and the second conductor, and extends in the first direction;
a fourth conductor that is connected to the first conductor and the second conductor and extends in the first direction; and
a feeding line that is electromagnetically connected to the third conductor,
wherein the antenna is mounted to the pole such that the first direction is substantially parallel to a direction in which the pole extends.
